(19) United States
(12) Patent Application Publication
(10) Pub. No.: US 2026/0287854 A1
(43) Pub. Date: Sep. 24, 2026

(54) OPTICAL SYSTEM AND CAMERA MODULE

(71) Applicant: LG INNOTEK CO., LTD., Seoul (KR)

(72) Inventor: Ju Yong SHIM, Seoul (KR)

(73) Assignee: LG INNOTEK CO., LTD., Seoul (KR)

(21) Appl. No.: 19/469,888

(22) PCT Filed: Mar. 27, 2024
(86) PCT No.: PCT/KR2024/003830

§ 371 Date: Sep. 26, 2025

(30) Foreign Application Priority Data
Mar. 28, 2023 (KR) 10-2023-0040688
Jun. 19, 2023 (KR) 10-2023-0078478

(51) Int. Cl. G02B 13/00; G02B 1/04; G02B 3/00; G02B 9/12; G02B 9/34; G03B 9/02; G03B 30/00

(52) U.S. Cl. CPC G02B 13/0035; G02B 1/041; G02B 9/12; G02B 9/34; G02B 13/004; G03B 9/02; G03B 30/00; G02B 2003/0093

(57) ABSTRACT

An optical system disclosed in an embodiment of the invention includes first to third lenses having powers aligned along an optical axis from an object toward an image sensor; and an aperture stop disposed between the first lens and the second lens, wherein the power of the first lens is negative and the power of the second lens is positive, the first lens is a spherical lens and is made of glass material, the second lens and the third lens are aspherical lenses, the second lens includes a meniscus shape convex on the optical axis toward the image sensor, and a refractive index of the first lens may be greater than 1.6 and less than 1.9.

### TECHNICAL FIELD

An embodiment relates to an optical system and a camera module including the same.

### BACKGROUND ART

Typically, manned or unmanned vehicles includes at least one sensing device, such as LiDAR, a camera, radar, a laser sensor, or an ultrasonic sensor, to perceive their surroundings in real time. Recently, with the rapid development of AI-based image analysis technology, autonomous driving—a technology that utilizes only cameras, radar, and ultrasonic sensors instead of expensive LiDAR—is attracting significant attention. For example, an autopilot system for autonomous driving utilizes at least eight cameras to capture 360-degree images up to 250 meters away and performs driving control through real-time image analysis. However, the performance requirements of the multiple cameras installed in autonomous vehicles vary depending on their installation location and surveillance direction. For example, an autopilot system typically includes at least three front cameras to comprehensively monitor both near-range and far-range situations. Specifically, a wide-angle camera with a maximum range of 60 meters, a main camera with a maximum range of 150 meters, and a telephoto camera with a maximum range of 250 meters are installed.

However, since automotive cameras are inevitably continuously exposed to harsh conditions such as vibration, moisture, high temperatures, and extreme cold, the refractive index of each lens that makes up the optical system may change depending on temperature changes, or the distance or position of the lenses may change slightly due to vibration, which may result in the actual optical performance being lower than the designed optical performance. Cameras installed in autonomous vehicles, in particular, require more stable optical performance, as even the slightest performance degradation can lead to accidents. Furthermore, telephoto cameras typically have a very large overall length relative to the focal length of their optical systems, which can limit vehicle design freedom when installed in vehicles.

In order to obtain an image from a camera, a most important factor is an imaging lens for imaging an image. Recently, interest in high performance such as high resolution and high resolution is increasing, and research is underway on optical systems that includes multiple lenses to achieve these goals. However, the optical system's characteristics can change when the camera is exposed to harsh environments inside a vehicle, such as high or low temperatures, moisture, and high humidity. In this case, the camera has the problem of difficulty in uniformly achieving excellent optical and aberration characteristics. Therefore, a new optical system and camera capable of resolving the above-described problems are required.

### DISCLOSURE

### Technical Problem

An embodiment provides an optical system and camera module with improved optical characteristics. The embodiment provides an optical system and camera module with superior optical performance in low- to high-temperature environments. The embodiment provides an optical system and camera module capable of preventing or minimizing changes in optical characteristics. The embodiment may be applied to a lidar camera applied inside or outside a vehicle.

### Technical Solution

An optical system according to an embodiment of the invention comprises first to third lenses aligned along an optical axis from an object toward an image sensor and having power; and an aperture stop disposed between the first lens and the second lens, wherein the power of the first lens is negative and the power of the second lens is positive, the first lens is a spherical lens made of glass, the second lens and the third lens are aspherical lenses, the second lens includes a meniscus shape convex on the optical axis toward the image sensor, and a refractive index of the first lens may be greater than 1.6 and less than 1.9.

According to an embodiment of the invention, a maximum effective length of the third lens may be greater than a maximum effective length of the second lens and less than a maximum effective length of the first lens. An effective diameter of an object-side surface of the third lens may be greater than an effective diameter of an object-side surface of the second lens and less than an effective diameter of an object-side surface of the first lens. The refractive indices of the second and third lenses may be greater than 1.6 and less than 1.9. A distance from the sensor-side surface of the first lens to the aperture stop in the optical axis direction may be greater than a distance from the object-side surface of the second lens to the aperture stop in the optical axis direction.

According to an embodiment of the invention, an effective diameter of the aperture stop may be smaller than the effective diameter of the sensor-side surface of the first lens and the effective diameter of the object-side surface of the second lens. The third lens may have a biconvex shape on the optical axis, and the sensor-side surface of the third lens may have a radius of curvature smaller than the radius of curvature of the object-side surface of the third lens.

According to an embodiment of the invention, the center thickness of the third lens may be greater than the center thickness of the second lens. The object-side surface of the first lens may be convex on the optical axis, and the effective diameter of the object-side surface of the first lens may be more than twice the effective diameter of the sensor-side surface of the first lens. The distance in the optical axis direction between the sensor-side surface of the first lens and the object-side surface of the second lens may be greater than the distance in the optical axis direction between the sensor-side surface of the second lens and the object-side surface of the third lens. The second lens and the third lens may be made of glass.

According to an embodiment of the invention, an optical axis distance from a center of the object-side surface of the first lens to the surface of the image sensor is TTL, and an optical axis distance from a center of the sensor-side surface of the third lens to the surface of the image sensor is BFL, and the following mathematical formula may satisfy: 3<TTL/BFL<8. The optical axis distance from the center of the object-side surface of the first lens to the surface of the image sensor is TTL, and half of the diagonal length of the image sensor is ImgH, and the following mathematical formula may satisfy: 6<TTL/ImgH<9.

An optical system according to an embodiment of the invention includes first to fourth lenses aligned along an optical axis from an object toward an image sensor; and an aperture stop disposed between the second lens and the third lens, wherein a power of the first lens has a negative value, the first lens and the fourth lens are aspherical lenses, the third lens is a spherical lens, a distance between the first lens and the second lens is such that a center distance is greater than an edge distance, and the fourth lens may include a convex object-side surface and a convex sensor-side surface on the optical axis.

According to an embodiment of the invention, the third lens may include a convex object-side surface and a convex sensor-side surface on the optical axis, the first lens may include a concave object-side surface and a concave sensor-side surface on the optical axis, and the object-side surface of the first lens may have a critical point between the center and the edge. The power of each of the second to fourth lenses may have a positive value, and the center thickness of the fourth lens may be greater than the center thickness of each of the first to third lenses. The second and third lenses are made of glass, the first lens and the fourth lens are made of plastic, and the aperture stop may be disposed closer to the second lens than to the third lens.

### Advantageous Effects

An optical system and camera module according to an embodiment may have improved optical characteristics. Specifically, in the optical system according to an embodiment, a plurality of lenses may have set thicknesses, powers, and distances from adjacent lenses. Accordingly, the optical system and camera module according to an embodiment may have improved MTF characteristics, aberration control characteristics, resolution characteristics, etc. within a set field of view range, and may have excellent optical performance in the periphery of the field of view.

An optical system and camera module according to an embodiment may have excellent optical performance within a temperature range within a moving object, such as a vehicle. Specifically, the plurality of lenses included in the optical system may have set materials, powers, and refractive indices. Accordingly, even when the focal length of each lens changes due to changes in refractive index due to temperature changes, the lenses can compensate for each other. The optical system can effectively distribute power within a temperature range within a moving object, and can prevent or minimize changes in optical characteristics within the temperature range. Therefore, the optical system and camera module according to an embodiment may maintain improved optical characteristics across a variety of temperature ranges.

The optical system and camera module according to the embodiment may satisfy the set field of view through a combination of aspherical lenses and spherical lenses and can implement excellent optical characteristics. As a result, the optical system can provide a slimmer vehicle camera module. Accordingly, the optical system and camera module may be provided in various applications and devices, and may have excellent optical characteristics even in harsh temperature environments, such as when exposed to the exterior of a vehicle or when inside a vehicle at high temperatures in the summer. The embodiment can improve the reliability of a vehicle interior or exterior camera or a lidar camera.

### DESCRIPTION OF DRAWINGS

FIG. 1 is a side cross-sectional view of an optical system and a camera module including the same according to a first embodiment.

FIG. 2 is a side cross-sectional view illustrating the relationship between the n-th and n−1th lenses of FIG. 1.

FIG. 3 is a table showing lens characteristics of the optical system of FIG. 1.

FIG. 4 is a table showing aspherical coefficients of lenses in the optical system of FIG. 1.

FIG. 5 is a table showing the thickness of each lens and the distance between adjacent lenses in the optical system of FIG. 1.

FIG. 6 is a diagram showing the Sag values from the center to the edge of the lens surfaces of each lens in the optical system of FIG. 1.

FIG. 7 is a modified example of an optical system according to an embodiment of the invention.

FIG. 8 is a graph showing data on the diffraction MTF (Modulation Transfer Function) of the optical systems of FIGS. 1 and 7.

FIG. 9 is a graph showing data on the aberration characteristics of the optical systems of FIGS. 1 and 7.

FIG. 10 is a side cross-sectional view of an optical system according to a second embodiment and a camera module including the same.

FIG. 11 is a table showing lens characteristics of the optical system of FIG. 10.

FIG. 12 is a table showing aspherical coefficients of lenses in the optical system of FIG. 10.

FIG. 13 is a table showing the thickness of each lens and the distance between adjacent lenses in the optical system of FIG. 10.

FIG. 14 is a diagram showing the Sag value from the center to the edge of the lens surfaces of each lens in the optical system of FIG. 10.

FIG. 15 is a graph showing data on the diffraction MTF of the optical system of FIG. 10.

FIG. 16 is a graph showing data on the aberration characteristics of the optical system of FIG. 10.

FIG. 17 is a side cross-sectional view of an optical system according to a third embodiment and a camera module including the same.

FIG. 18 is a table showing lens characteristics of the optical system of FIG. 17.

FIG. 19 is a table showing the aspherical coefficients of the lenses in the optical system of FIG. 17.

FIG. 20 is a table showing the thickness of each lens and the distance between adjacent lenses in the optical system of FIG. 17.

FIG. 21 is a diagram showing the Sag values from the center to the edge of the lens surfaces of each lens in the optical system of FIG. 17.

FIG. 22 is a graph showing data on the diffraction MTF of the optical system of FIG. 17.

FIG. 23 is a graph showing data on the aberration characteristics of the optical system of FIG. 17.

FIG. 24 is a table showing data on relative illumination (RI) according to the height of the image sensor of the optical system according to the first to third embodiments.

FIG. 25 is a side cross-sectional view of the optical system according to the first embodiment and a camera module including the same.

FIG. 26 is a side cross-sectional view illustrating the relationship between the n-th and n−1th lenses of FIG. 25.

FIG. 27 is a table showing the lens characteristics of the optical system of FIG. 25.

FIG. 28 is a table showing the aspherical coefficients of aspherical lenses in the optical system of FIG. 25.

FIG. 29 is a table showing the thicknesses of each lens from the center to the edge and the distance between adjacent lenses in the optical system of FIG. 25.

FIG. 30 is a table showing the Sag values (sagittal heights) of the lenses from the center to the edge of the lenses of FIG. 25.

FIG. 31 is a graph showing data on the diffraction MTF of the optical system of FIG. 25.

FIG. 32 is a graph showing data on the aberration characteristics of the optical system of FIG. 25.

FIG. 33 is a side cross-sectional view of an optical system according to a second embodiment and a camera module including the same.

FIG. 34 is a side cross-sectional view illustrating the relationship between the n-th and n−1th lenses of FIG. 33.

FIG. 35 is a table showing the lens characteristics of the optical system of FIG. 33.

FIG. 36 is a table showing the aspherical coefficients of aspherical lenses in the optical system of FIG. 33.

FIG. 37 is a table showing the thicknesses of each lens from the center to the edge and the distance between adjacent lenses in the optical system of FIG. 33.

FIG. 38 is a table showing the Sag values from the center to the edge of the lenses of FIG. 25.

FIG. 39 is a graph showing data on the diffraction MTF of the optical system of FIG. 33.

FIG. 40 is a graph showing data on the aberration characteristics of the optical system of FIG. 33.

FIG. 41 is a table showing data on relative illumination (RI) according to the height of the image sensor of the optical system according to the fourth and fifth embodiments.

FIG. 42 is an example of a vehicle having an optical system according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, “sensor-side surface” may refer to a surface of the lens facing the imaging surface (image sensor) with respect to the optical axis, and “light source-side surface” may refer a surface of a lens facing the light source with respect to the optical axis. A convex surface of the lens may mean that the lens surface on the optical axis has a convex shape, and a concave surface of the lens may mean that the lens surface on the optical axis has a concave shape. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The effective diameter on the lens surface may have a measurement error of up to +0.4 mm depending on the measurement method. The paraxial region refers to a very narrow region near the optical axis, and is a region in which a distance at which a light ray falls from the optical axis OA is almost zero. Hereinafter, the optical axis may include the center of each lens or a very narrow area near the optical axis.

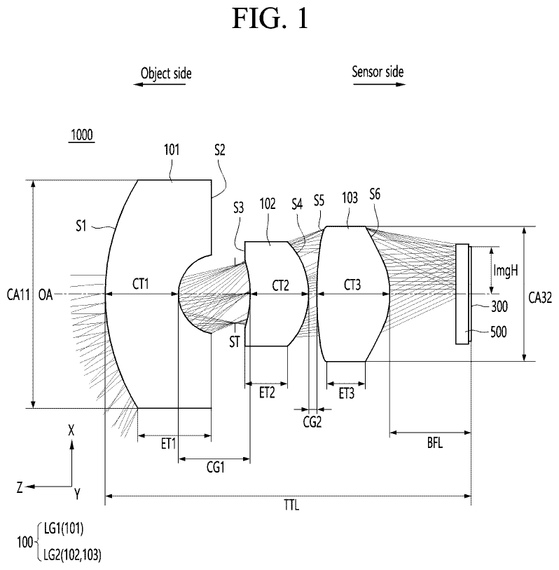

FIGS. 1, 10, and 17 are drawings illustrating optical systems and camera modules including the same according to the first to third embodiments.

Referring to FIGS. 1, 10, and 17, the optical system 1000 according to the first to third embodiments may include a plurality of lens groups LG1 and LG2. Specifically, each of the plurality of lens groups LG1 and LG2 includes at least one lens. The first lens group LG1 and the second lens group LG2 may be sequentially arranged along the optical axis OA from an object toward the image sensor 300. The number of lenses in each of the first lens group LG1 and the second lens group LG2 may be different. The optical axis distance of the first lens group LG1 may be shorter than the optical axis distance of the second lens group LG2. The optical axis distance of the first lens group LG1 is a distance along the optical axis from the first surface S1 to the second surface S2, and the optical axis distance of the second lens group LG2 is a distance along the optical axis from the third surface S3 to the sixth surface S6. The first lens group LG1 may include two or fewer lenses, for example, one lens. The second lens group LG2 may include two or more lenses, for example, two lenses. The optical system 1000 may include n lenses, where the n-th lens may be the lens closest to the image sensor 300, and the n−1th lens may be the lens closest to the n-th lens. “n” is an integer less than or equal to 5, for example, 3.

The optical system 1000 may include a spherical lens and an aspherical lens. The spherical lens has spherical surfaces on the object-side surface and the sensor-side surface on the optical axis OA, and the aspherical lens has aspherical surfaces on the object-side surface and the sensor-side surface on the optical axis OA. Here, the aspherical lens is a lens having a surface whose curvature is not constant depending on the area of the lens surface. The optical system 1000 may include lenses made of glass. As another example, the optical system 1000 may include lenses made of glass and lenses made of plastic. The first lens group LG1 may include at least one lens made of glass. The first lens group LG1 may provide the lens closest to the object as a glass lens. Such glass material exhibits little expansion and contraction change due to external temperature changes, and the surface is not easily scratched, thereby preventing surface damage. The lenses of the first lens group LG1 may have a spherical lens surface.

The second lens group LG2 may include aspherical lenses. The second lens group LG2 may include an object-side lens having an aspherical lens surface and a sensor-side lens having an aspherical lens surface. The lenses having aspherical surfaces in the second lens group LG2 may be made of glass. As another example, at least one of the lenses having aspherical surfaces may be made of plastic, for example, the last lens may be made of plastic. The aspherical lenses in the second lens group LG2 may be made of a glass mold material. The glass mold material lens is a lens that is injection-molded to have an aspherical surface using a glass material. At least one of the lenses in the lens unit 100, 100A, and 100B or a lens having a longest effective length may have different lengths in the first direction X and the second direction Y perpendicular to the optical axis OA. That is, one of the first and second direction lengths of the lens may be shorter than the other direction length. The length of the object-side or sensor-side surface of each lens is the length passing through the center of each lens surface and may be defined as the effective length or effective diameter. The effective length may include the effective diameter.

The optical system 1000 may include at least one spherical lens adjacent to the object and at least one aspherical lens adjacent to the image sensor 300. Within the optical system 1000, the number of spherical lenses is smaller than the number of aspherical lenses, and the effective length is greater than the effective length of the lens adjacent to the image sensor 300, thereby improving assembly with the lens barrel. Here, the n-th lens is the lens closest to the image sensor 300 and may be provided as an aspherical lens to prevent degradation of optical performance. The aspherical lens can prevent spherical aberration within the optical system 1000 and suppress the occurrence of aberration even when the effective length increases, thereby improving the miniaturization and weight reduction of the camera module. The optical system 1000 combines spherical and aspherical lenses, enabling thermal compensation within the lens barrel and suppressing degradation of optical characteristics due to temperature changes. Furthermore, since the optical system 1000 includes at least one aspherical lens, it can suppress the occurrence of various aberrations.

Each lens of the optical system 1000 may have an Abbe number in the range of 20 to 70, and a refractive index in the range of 1.5 to 2.0. The Abbe number and refractive index of each lens can control chromatic dispersion by the lens. Here, the lens with the minimum refractive index may be the first lens 101, 111, and 121 closest to the object, and the lens with the minimum Abbe number may be the first lens 101, 111, and 121. The refractive index of the i-th lens is Ndi, the Abbe number of the i-th lens is Vdi, and the value of Ndi*Vdi may be minimum when i is 1. Also, the value of Ndi*Vdi may be 60 or more when i=2, 3. Within the optical system 1000, the lens 102, 112, and 122 having the minimum effective diameter may satisfy the condition that the value of Ndi*Vdi is 60<(Ndi*Vdi)<115, and * indicates multiplication.

The optical system 1000 may include a lens unit 100, 100A, and 100B having 5 or fewer lenses. Each of the lenses within the lens unit 100, 100A, and 100B may include an effective area and an ineffective area. The effective area may be an area through which light incident on each of the lenses passes. In other words, the effective area may be defined as an effective area or an effective diameter in which the incident light is refracted to implement optical characteristics. The ineffective area may be disposed around the periphery of the effective area and may be defined as a flange portion. The ineffective area may be an area where effective light is not incident on each of the plurality of lenses. In other words, the ineffective area may be an area unrelated to the optical characteristics. Furthermore, an end of the ineffective area may be an area fixed to a lens barrel (not shown) that accommodates the lens.

Within the lens unit 100, 100A, and 100B, the lens surface having the maximum effective length is the object-side surface of the spherical lens and may be disposed closest to the object. Within the lens unit 100, 100A, and 100B, the lens surface having the maximum effective length is the object-side surface of the glass lens and may be disposed closest to the object. The lens surface having the maximum effective length may refract the incident light to the entire area and improve the incident efficiency. Furthermore, the first lens 101, 111, and 121 having the maximum effective length has negative power and can divert the incident light. The first lens 101, 111, and 121 closest to the object may have the largest difference between the effective length of the object-side surface and the effective length of the sensor-side surface among the lenses.

Among the lenses, the lens with the smallest effective length may be disposed between the first lens 101, 111, and 121 closest to the object and the last lens. The second lens 102, 112, and 122, disposed on a sensor side of the first lens 101, 111, and 121, may have the smallest effective length. The second lens 102, 112, and 122 may be an aspherical lens. The second lens 102, 112, and 122 may be made of glass. The second lens 102, 112, and 122 with the smallest effective length may be disposed on the sensor side of the aperture stop ST positioned between the lenses. The last lens 103, 113, and 123 closest to the image sensor 300 may be an aspherical lens. The last lens 103, 113, and 123 may be made of glass. An embodiment of the invention combines spherical and aspherical lenses within the optical system 1000, thereby reducing the weight of the camera module, lowering manufacturing costs, improving various aberration characteristics, and suppressing degradation of optical characteristics due to temperature changes.

Within the optical system 1000, a TTL (Total top length) may be more than 5 times, for example, more than 5 times and less than 10 times, than ImgH. Preferably, the condition may satisfy: 5<TTL/ImgH<10. The TTL is an optical axis distance from the center of the object-side surface of the first lens 101, 111, and 121 to a surface of the image sensor 300. The ImgH is the length from the center of the effective area of the image sensor 300 to the end in the diagonal direction. The ImgH is half of the maximum diagonal length of the effective area of the image sensor 300.

Within the optical system 1000, an effective focal length (EFL) of 10 mm or less and a field of view (FOV) of more than 80 degrees may be provided, and may be provided as a standard optical system in a vehicle camera module. The optical system 1000 may have a wide field of view of 85 degrees or more and a focal length of 10 mm or less, so that a wide area around an electronic device having the optical system 1000 may be photographed. The optical system and camera module according to the embodiment may be applied to a camera module for LiDAR equipped in a vehicle. For example, light transmitted by a transmission module is reflected by an object, and the camera module having the optical system 1000 receives the reflected light. Such a camera module for LiDAR may be selectively applied to devices such as a collision warning avoidance system, a blind spot monitor, lane keeping assistance, lane departure warning, and adaptive cruise control, and can provide functions that assist drivers and make autonomous driving safer and more comfortable.

The optical system 1000 may have a value of TTL/(2*ImgH) greater than 2.5, for example, greater than 2.5 and less than 5. By setting the value of TTL/(2*ImgH) to greater than 2.5, the optical system 1000 may provide a driver assistance optical system. The total number of lenses in the first and second lens groups LG1 and LG2 is 5 or less or 4 or less. Accordingly, the optical system 1000 may provide an image without exaggeration or distortion in the formed image.

The length of the image sensor 300 is the maximum length of the effective area and is the length in the diagonal direction orthogonal to the optical axis OA. The number of lenses within the optical system 1000 having an effective length greater than the diagonal length of the image sensor 300 may be 2 or more, for example, 2. The diagonal length of the image sensor 300 may be shorter than the effective length of a spherical lens. The diagonal length of the image sensor 300 may be shorter than the effective length of the last lens. Here, the effective length of each lens is the average of the effective lengths of the object-side and sensor-side surfaces of each lens. Within the lens unit 100, 100A, and 100B, the lens with the minimum effective length may have an effective length shorter than the diagonal length of the image sensor 300.

Within the lens unit 100, 100A, and 100B, the sensor-side surface of the first lens 101, 111, and 121 may have an effective length greater than the sensor-side surface of the last lens 103, 113, and 123 closest to the image sensor 300. Accordingly, the difference in the center thickness of the two lenses adjacent to the image sensor 300 within the optical system 1000 may be maintained at less than 50%, and the angle of refraction and chromatic dispersion may be controlled by the thickness difference between the lenses of the optical system 1000. Accordingly, the degradation of optical characteristics due to resolution and temperature changes within the optical system 1000 may be compensated for, chromatic aberration control characteristics may be improved, and vignetting characteristics of the optical system 1000 may be improved.

The optical system 1000 may include an aperture stop ST that controls the amount of incident light. The aperture stop ST may be one or two. For example, as illustrated in FIG. 1, the optical system 1000 may include a single aperture stop ST. The aperture stop ST may be disposed between two adjacent lenses and may be a light shield. The aperture stop ST may be disposed between the first lens 101, 111, and 121 and the second lens 102, 112, and 122. The aperture stop ST may be disposed between the ineffective area of the first lens 101, 111, and 121 and the ineffective area of the second lens 102, 112, and 122. The aperture stop ST may be disposed between the sensor-side surface S2 of the first lens 101, 111, and 121 and the object-side surface S3 of the second lens 102, 112, and 122.

The aperture stop ST may be disposed closer to the object-side surface S3 of the second lens 102, 112, and 122 than to the sensor-side surface S2 of the first lens 101, 111, and 121. The optical axis distance between the sensor-side surface S2 of the first lens 101, 111, and 121 and the aperture stop ST may be greater than the optical axis distance between the object-side surface S3 of the second lens 102, 112, and 122 and the aperture stop ST. Accordingly, the amount of light incident on the object-side surface, i.e., the effective area, of the second lens 102, 112, and 122 may be effectively controlled. As another example, the aperture stop ST may be a light-shielding layer coated around the effective area of the object-side surface of the second lens 102, 112, and 122. For example, the peripheral surface of at least one lens selected from among the plurality of lenses may function as an aperture stop. In detail, the flange portion of the object-side surface or the sensor-side surface of one lens selected from among the lenses of the optical system 1000 may function as an internal aperture stop that controls the amount of light. The effective length or effective area of the aperture stop ST may be smaller than the effective length or effective area of the sensor-side surface S2 of the first lens 101, 111, and 121.

The effective length or effective area of the aperture stop ST may be smaller than the effective length or effective area of the object-side surface of the second lens. The effective length of the aperture stop ST is the length of the internal hole, and the effective area is an area of the internal hole.

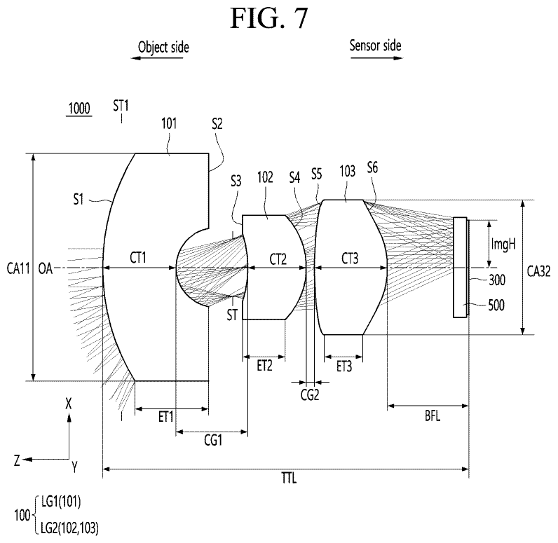

In the optical system 1000 according to the embodiment, in the lens surfaces S1 and S2 disposed between the object and the aperture stop ST, the effective lengths of the lens surfaces S1 and S2 from the object toward the aperture stop ST tend to decrease. In the lens surfaces S3, S4, S5, and S6 disposed between the aperture stop ST and the image sensor 300, the effective lengths of the lens surfaces tend to increase from the aperture stop ST toward the image sensor 300. Here, the average effective length of each lens 102 and 103 tends to increase from the aperture stop ST toward the image sensor 300. As illustrated in FIG. 7, when there are two apertures within the optical system 1000, the system may include an internal aperture stop ST positioned within the lens units 100, 100A, and 100B and an external aperture stop ST1 disposed on the object side of the lens units 100, 100A, and 100B. The external aperture stop ST1 may be disposed on the object-side surface S1 of the first lens 101, 111, and 121.

The center distance between the first lens group LG1 and the second lens group LG2 is a first distance CG1, which may be the distance in the optical axis direction between the sensor-side surface of the first lens group LG1 and the object-side surface of the second lens group LG2. The first distance CG1 may be a center distance between adjacent spherical lenses and aspherical lenses. The first distance CG1 may be greater than a center distance CG2 between adjacent aspherical lenses and aspherical lenses. Accordingly, an increase in the effective diameter of a lens located on the sensor side of the aperture stop ST may be suppressed. That is, an increase in the size of the lenses in a direction perpendicular to the optical axis OA may be suppressed by the first distance CG1. Here, the first lens group LG1 may include lenses located closer to the object side than the aperture stop ST, and the second lens group LG2 may include lenses located closer to the sensor side than the aperture stop ST. The first lens group LG1 and the second lens group LG2 may be divided into an object-side lens group and a sensor-side lens group based on the internal aperture stop ST. The sensor-side surface of the first lens group LG1 may have a concave shape on the optical axis OA, and the object-side surface of the second lens group LG2 may have a convex shape on the optical axis. The sensor-side surface of the first lens group LG1 and the object-side surface of the second lens group LG2 may face each other.

The optical axis distance of the first lens group LG1 is the optical axis distance from the object-side surface S1 to the sensor-side surface S2. In other words, the optical axis distance of the first lens group LG1 is the optical axis distance between the object-side surface S1 and the sensor-side surface S2 of the first lens 101, 111, and 121, and is the center thickness of the first lens 101, 111, and 121. The optical axis distance of the second lens group LG2 is the optical axis distance between the object-side surface S3 of the second lens 102, 112, and 122 closest to the object among the lenses of the second lens group LG2 and the sensor-side surface S6 of the lens 103, 113, and 123 closest to the image sensor 300. The optical axis distance of the second lens group LG2 may be 1.5 times or more than the optical axis distance of the first lens group LG1. The optical axis distance between the last lens and the image sensor 300 is BFL, and the BFL may be larger than the maximum center thickness of the lenses and may be greater than 6.0 mm. The maximum center thickness of the lenses is CT_Max, and may satisfy the condition: 1<BFL/CT_Max<2, and preferably, the condition: 1<BFL/CT_Max<1.5. By satisfying the above conditions, the BFL can provide the last lens with a biconvex shape, and even as the distance between the last lens and the image sensor 300 increases, the last lens 300 can focus the image onto the image sensor 300.

The first lens group LG1 may have negative (−) power, and the second lens group LG2 may have positive (+) power. The lens closest to the object in the first lens group LG1 may have negative (−) power, and the lens closest to the sensor in the second lens group LG2 may have positive (+) power. Accordingly, the first lens group LG1 can refract the incident light in a direction close to the optical axis OA, and the second lens group LG2 can refract the incident light into an effective area of the image sensor 300. When the focal length of the first lens group LG1 is FLG1 and the focal length of the second lens group LG2 is FLG2, the following conditions may be satisfied.

$$\vert FLG 1 \vert < FLG 2 \qquad Condition 1$$

$$BFL < \vert FLG 1 \vert \qquad Condition 2$$

Within the optical system 1000, a number of lenses with negative (−) power may be smaller than a number of lenses with positive (+) power. The number of lenses with negative (−) power within the optical system 1000 may be 45% or less of the total number of lenses, for example, in the range of 23% to 40%. When a camera module includes three or more glass lenses, durability and heat resistance are improved, internal stress generated during the lens manufacturing process may be suppressed, and optical performance degradation may be prevented. Furthermore, the use of glass lenses can improve chromatic aberration at high refractive indices.

The first lens group LG1 refracts light incident through the object toward a direction close to the optical axis, and the second lens group LG2 refracts light incident through the first lens group LG1 toward the periphery of the image sensor 300. The first distance CG1 between the first lens group LG1 and the second lens group LG2 may be greater than the minimum center thickness of the lenses. If the center thickness of the first lens 101, 111, and 121 is CT1 and the maximum center thickness among the lenses is CT_Max, the following conditions may be satisfied.

$$CG 1 < CT 1 ( provided that CT 1 = CT\_Max ) \qquad Condition 1$$

$$CG 1 > CT 1 ( provided that CT 1 \neq CT\_Max ) \qquad Condition 2$$

If the center thickness of the first lens 101, 111, and 121 is the thickest within the lens unit 100, Condition 1: CG1<CT1 is satisfied, and if the center thickness of the first lens 101, 111, and 121 is not the thickest within the lens unit 100, Condition 2: CG1>CT1 may be satisfied. When the center thickness CT1 of the first lens 101 is provided as thick as possible, the center distance CG1 between the first and second lenses may be made smaller than the center thickness CT1 of the first lens 101, and an increase in the effective length and curvature radius of the sensor-side surface of the first lens 101 may be suppressed. When the center thickness CT1 of the first lens 111 and 121 is provided as thin as possible, the center distance CG1 between the first and second lenses may be made larger than the center thickness CT1 of the first lens 111 and 121, and the effective length and curvature radius of the sensor-side surface of the first lens 111 and 121 may be made larger than the center thickness CT1 of the first lens 111 and 121, thereby controlling the optical path.

The Abbe number of the spherical lens within the lens unit 100, 100A, and 100B may be smaller than the Abbe number of the aspherical lens. The refractive index of the spherical lens within the lens unit 100, 100A, and 100B may be smaller than the refractive index of the aspherical lens. Since the effective length of the spherical first lens 101, 111, and 121 is provided at its maximum, the field of view may be widened compared to the focal length, and the amount of incident light may be improved. The refractive index of the d-line of the first lens 101, 111, and 121 may be greater than 1.6 and less than 1.9. The refractive index of at least one or both of the second lens 102, 112, and 122 and the third lens 103, 113, and 123 may be greater than the refractive index of the first lens 101, 111, and 121. The sum of the refractive indices of the lenses of the lens units 100, 100A, and 100B of the embodiment may be 7 or less, for example, in the range of 3 to 7, and the average of the refractive indices may be 1.65 or more, for example, in the range of 1.65 to 1.9. The sum of the Abbe numbers of each of the lenses may be 200 or less, for example, in the range of 70 to 200, and the average of the Abbe numbers may be 30 or more, for example, in the range of 30 to 65. The sum of the center thicknesses of the entire lens may be 11 mm or more, for example, in the range of 11 mm to 21 mm or 11 mm to 19 mm. The average of the center thicknesses of the entire lens may be 4 mm or more, for example, in the range of 4 mm to 6 mm. The sum of the center distances between the lenses on the optical axis OA may be 4.6 mm or more, for example, in the range of 4.6 mm to 10 mm, and may be less than the sum of the center thicknesses of the lenses.

Within the lens units 100, 100A, and 100B, the difference between the maximum and minimum center thicknesses of the lenses may be 5 mm or less, for example, in the range of 0.1 mm to 5 mm or 0.5 mm to 4.5 mm. By setting the difference in center thicknesses of the lenses to be small, an increase in effective length may be suppressed without increasing the difference in curvature radius, and distortion may be reduced. The radius of curvature of the object-side surface of the first lens 101, 111, and 121 may be the largest among the object-side and sensor-side surfaces of the first to third lenses. The radius of curvature of the sensor-side surface of the third lens 103, 113, and 123 may be smaller than the radius of curvature of the object-side surface of the third lens 103, 113, and 123.

The average value of the effective length of each lens surface of the lens unit 100, 100A, and 100B may be provided as 8 mm or more, for example, in the range of 8 mm to 16 mm or 9 mm to 12 mm. The difference between the maximum effective length and the minimum effective length among the lens surfaces may be 7 mm or more, for example, in the range of 7 mm to 20 mm. Therefore, in the optical system, since lenses having an average center thickness of the entire lens of 4 mm or more and an average effective length of 8 mm or more are provided, the assemblability between the lenses and the lens barrel may be improved. The maximum effective length of the third lens 103, 113, and 123 may be greater than the maximum effective length of the second lens 102, 112, and 122 and less than the maximum effective length of the first lens 101, 111, and 121.

The F number (F #) of the optical system or camera module according to an embodiment of the invention may be less than 2, for example, in the range of 1.0 to 1.5 or in the range of 1.0 to 1.2. The field of view (diagonal FOV) of the optical system according to an embodiment of the invention may be more than 80 degrees, for example, more than 80 degrees and less than 150 degrees, or in the range of 110 degrees to 135 degrees. Here, the horizontal field of view of the optical system is 110 degrees or less, for example, in the range of 75 degrees to 110 degrees, and may be smaller than the diagonal field of view. The vertical field of view of the optical system is 90 degrees or less, in the range of 60 degrees to 90 degrees, and may be smaller than the horizontal field of view. The horizontal field of view is a field of view measured based on the horizontal length of the image sensor 300, and the vertical field of view is a field of view measured based on the vertical length of the image sensor 300. The image sensor 300 may have, for example, a diagonal sensor length of 8.0 mm+0.5 mm, a horizontal sensor length of 6.40 mm+0.5 mm, and a vertical sensor height of 4.80 mm+0.5 mm. Accordingly, the image sensor can suppress changes in the focus position due to temperature changes and provide a vehicle camera with excellent correction of various aberrations.

The optical system 1000 has a diagonal FOV of 110 to 135 degrees and, when equipped with at least one spherical lens and at least one aspherical lens, can reduce the difference in center thickness or center distance between the spherical lens and the aspherical lens. Accordingly, the number of glass lenses and the center thickness of the glass lenses within the optical system 1000 can reduce the impact on optical performance, i.e., changes in optical performance due to temperature changes from low to high temperatures.

The optical system 1000 or camera module may include an image sensor 300. The image sensor 300 may detect light and convert it into an electrical signal. The image sensor 300 may detect light that sequentially passes through the lens units 100, 100A, and 100B. The image sensor 300 may include an element capable of detecting incident light, such as a CCD (Charge coupled device) or a CMOS (Complementary metal oxide semiconductor). Here, the diagonal length of the image sensor 300 may be 50% or less of the maximum effective diameter of the lens surfaces, for example, in the range of 35% to 50% or 35% to 45%. The optical system 1000 or camera module may include an optical filter 500. The optical filter 500 may be disposed between the second lens group LG2 and the image sensor 300. The optical filter 500 may be disposed between the n-th lens and the image sensor 300. For example, the optical filter 500 may be disposed closer to the image sensor 300 than the last lens 103, 113, and 123.

The optical filter 500 may include an infrared filter or an infrared cut-off filter (IR cut-off). The optical filter 500 may pass light within a set wavelength band and filter light within a different wavelength band. When the optical filter 500 includes an infrared filter, it may block radiant heat emitted from external light from being transmitted to the image sensor 300. Additionally, the optical filter 500 may transmit visible light and reflect or block infrared light. The optical filter 500 can pass a wavelength of 920 nm or more, for example, a wavelength band of 920 nm to 960 nm. As another example, the optical filter 500 can pass at least one wavelength of the lidar, for example, 905 nm±20 nm or 1550 nm±20 nm.

A cover glass (not shown) may be disposed on the image sensor 300. The cover glass protects the upper portion of the image sensor 300 and can prevent a decrease in the reliability of the image sensor 300. The cover glass may be removed.

The embodiment may include an optical system 1000 in a device such as a mobile device or an electronic device. Since the optical system 1000 is applied to a camera of a vehicle having a mobile device or an electronic device, the lens unit 100, 100A, and 100B may include an aspherical lens and a spherical lens, and the first lens 101, 111, and 121 closest to the object may be provided with a glass material. This has the advantage that the glass material is scratch-resistant and insensitive to external temperature compared to a plastic material. Since the first lens 101, 111, and 121 has a convex shape toward the driver inside the vehicle, it can more effectively prevent foreign substances from accumulating or scratches and improve the incidence efficiency. Accordingly, the reliability of the driver monitoring camera module may be improved. The last lens within the lens unit 100, 100A, and 100B may be provided with an aspherical lens. Since the last lens is an aspherical lens, the influence on optical characteristics may be reduced. Furthermore, since the last lens is provided as an aspherical lens, chromatic aberration may be corrected and light may be refracted throughout the entire area of the image sensor 300.

The optical system 1000 according to the embodiment may further include a reflective member (not shown) for changing the path of light. The reflective member may be implemented as a prism that reflects the incident light of the first lens group LG1 toward the lenses. The prism may be a right-angle prism. As another example, the optical system 1000 may include a first reflective member disposed on the object side and a second reflective member positioned between the last lens and the image sensor 300. The reflective member, which changes the path of light, can reduce the thickness of the camera module.

The optical system according to the first embodiment will be described with reference to FIGS. 1 to 10. As shown in FIGS. 1 to 3, the optical system 1000 according to the first embodiment includes a lens unit 100, and the lens unit 100 may include a first lens 101 to a third lens 103. The first to third lenses 101, 102, and 103 may be sequentially aligned along the optical axis OA. Light corresponding to information about an object may pass through the first lens 101 to the third lens 103 and be incident on the image sensor 300. The first lens 101 is a lens of the first lens group LG1 and is the lens closest to the object. The second and third lenses 102 and 103 are lenses of the second lens group LG2, and the third lens 103 is the lens closest to the image sensor 300. The focal lengths of the first to third lenses 101, 102, and 103 are F1, F2, and F3, respectively. The composite focal length of the second and third lenses 102 and 103 is F23. The overall focal length of the optical system 1000 is F. The following conditions may be satisfied:

$$\vert F 1 \vert < F 3 < F 2 ( provided that F 1 < 0 ) \qquad Condition 1$$

$$F < F 2 < F 23 \qquad Condition 2$$

$$F < \vert F 1 \vert \qquad Condition 3$$

$$F * 2 < F 2 \qquad Condition 4$$

The first lens 101 may have positive (+) or negative (−) power on the optical axis OA. The first lens 101 may have negative (−) power. The first lens 101 may be made of plastic or glass material, for example, glass material. The first lens 101 of glass material may reduce changes in the center position and radius of curvature due to temperature changes in the surrounding environment, and can protect the incident surface of the optical system 1000. On the optical axis OA, the first surface S1 on the object side of the first lens 101 may be convex, and the second surface S2 on the sensor side may have a concave shape. The first lens 101 may have a meniscus shape convex toward the object on the optical axis. The first lens 101 may be a spherical lens made of glass material, and the first surface S1 and the second surface S2 may be spherical. When the first surface S1 of the first lens 101 has a convex shape, the accumulation of foreign substances such as dust may be suppressed.

The first lens 101 may have a center thickness thicker than that of the second lens 102, thereby preventing a decrease in rigidity due to external impact. When the temperature changes due to the glass material of the first lens 101, a change in optical performance may be suppressed. In addition, since the first lens 101 is applied as a spherical lens made of glass, even if the thickness of the first lens 101 is designed to be thick, the change in the refractive index of light may not be large. Here, the thickness of the first lens 101 may be the center thickness. Alternatively, the first surface S1 may have a concave shape in the optical axis OA, and the second surface S2 may have a convex shape. The first lens 101 has a convex first surface S1 and a concave second surface S2 on the optical axis, thereby refracting incident light in a direction closer to the optical axis and reducing the effective diameter of the second lens 102. At least one or both of the first surface S1 and the second surface S2 may be provided without a critical point from the optical axis OA to the end of the effective area.

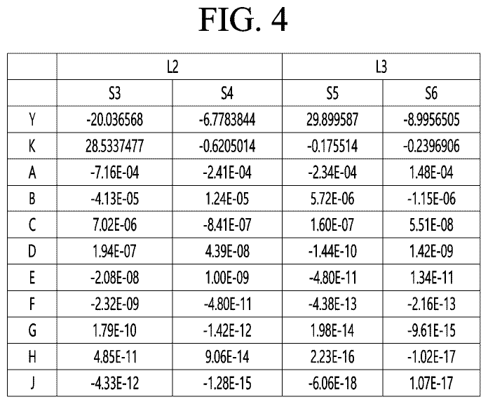

The second lens 102 may be disposed between the first lens 101 and the third lens 103. The second lens 102 may have positive (+) or negative (−) power on the optical axis OA, for example, positive (+) power. The second lens 102 may be made of plastic or glass. For example, the second lens 102 may be made of glass. On the optical axis OA, the object-side third surface S3 of the second lens 102 may have a concave shape, and the sensor-side fourth surface S4 may have a convex shape. The second lens 102 may have a convex meniscus shape toward the image sensor 300 on the optical axis. Alternatively, the third surface S3 may be convex, and the fourth surface S4 may be concave. Alternatively, the second lens 102 may have a concave shape on both sides. Alternatively, the third surface S3 may be convex, and the fourth surface S4 may be convex. The second lens 102 may be provided as an aspherical lens made of glass. The third surface S3 and the fourth surface S4 may be aspherical. As shown in FIG. 4, the radius of curvature (Y), the conic constant (K), and the aspheric coefficients (A to J) from the 4th to 20th orders of the third surface S3 and the fourth surface S4 are shown. At least one or both of the third surface S3 and the fourth surface S4 may be provided without a critical point from the optical axis OA to the end of the effective area.

The aperture stop ST is a member that controls the amount of light, and may be disposed around the area between the first lens 101 and the second lens 102. The aperture stop ST may be disposed around the area between the second surface S2 of the first lens 101 and the third surface S3 of the second lens 102. The aperture stop ST may be disposed closer to the third surface S3 than to the second surface S2. Accordingly, an increase in the effective diameter of the third surface S3 may be suppressed. The effective diameter of the aperture stop ST may have a range of 65% to 135% of the effective diameter of the sensor-side second surface S2 of the first lens 101. Accordingly, the amount of light passing through the first lens 101 may be controlled. For example, the effective diameter of the aperture stop ST may be smaller than the effective diameter of the second surface S2, and may be, for example, in the range of 65% to 99% of the effective diameter of the second surface S2. The effective diameter of the aperture stop ST may be the diameter of the inner hole of the aperture stop ST. In addition, the effective diameter of the aperture stop ST may be smaller than the effective diameter of the third surface S3, and may be, for example, in the range of 75% to 99% of the effective diameter of the third surface S3.

When the effective diameter of the aperture stop ST is CA_ST, the effective diameter of the second surface S2 is CA12, and the effective diameter of the third surface S3 is CA21, the following conditions may be satisfied.

$$0.65 \leq CA\_ST / CA 12 < 1 \qquad Condition 1$$

Preferably, 0.68≤CA_ST/CA12≤0.99 or 0.68≤CA_ST/CA12≤0.90 may be satisfied.

$$0.75 \leq CA\_ST / CA 21 < 1 \qquad Condition 2$$

Preferably, 0.78≤CA_ST/CA21≤0.99 or 0.80≤CA_ST/CA21≤0.90 may be satisfied.

$$CA\_ST / CA 12 < CA\_ST / CA 21 \qquad Condition 3$$

By providing the effective diameter of the aperture stop ST within the above range, the amount of light passing through the first lens 101 may be controlled, and an increase in the effective diameter of the third surface S3 of the second lens 102 may be suppressed. Since the aperture stop ST is disposed on the perimeter between the first and second lenses 101 and 102, the difference in effective diameter between the second and third surfaces S2 and S3 of the first and second lenses 101 and 102 may be reduced. The powers of the first lens 101 and second lens 102 on either side of the aperture stop ST may have opposite signs.

The third lens 103 may have positive (+) or negative (−) power on the optical axis OA. The third lens 103 may have positive (+) power. The third lens 103 may include a plastic or glass material. For example, the third lens 103 may be made of glass material. The fifth surface S5 on the object side of the third lens 103 on the optical axis OA may have a convex shape, and the sixth surface S6 on the sensor side may have a convex shape. The third lens 103 may have a convex shape on both sides on the optical axis OA. The fifth surface S5 and the sixth surface S6 of the third lens 103 may be aspherical on the optical axis, and as shown in FIG. 4, the radius of curvature (Y), the conic constant (K), and the aspheric coefficients (A to J) from the 4th to 20th orders of the fifth surface S5 and the sixth surface S6 are shown. Alternatively, the third lens 103 may have a meniscus shape convex toward the sensor. Alternatively, the third lens 103 may have a concave shape on both sides, or a meniscus shape convex toward the object side.

At least one or both of the fifth surface S5 and the sixth surface S6 of the third lens 103 may be provided without a critical point from the center to the ends of the effective area. Alternatively, at least one of the fifth surface S5 and sixth surface S6 may have at least one critical point from the center to the edge of the effective area. The critical point is the point where the Sag value (sagittal height) trend changes. That is, the point where the Sag value increases and then decreases, or the point where the Sag value decreases and then increases.

The third lens 103 may be an aspherical lens closest to the image sensor 300. By positioning the aspherical lens closest to the image sensor 300, optical performance degradation may be prevented, aberration characteristics may be improved, and the impact on resolution may be controlled. Furthermore, by positioning the aspherical lens closest to the image sensor 300, it may be less sensitive to assembly tolerances than a spherical lens. In other words, being less sensitive to assembly tolerances means that even if the assembly is slightly different from the design, optical performance may not be significantly affected. Additionally, the third lens 103 may improve assembly tolerances by providing a small difference between the center thickness CT3 and the edge thickness ET3.

The center thickness CT1 of the first lens 101 may be thicker than the center thickness CT2 of the second lens 102. The edge thickness ET1 of the first lens 101 may be the thickest among the edge thicknesses of the lenses. Since the first lens 101 has a thick thickness and a convex meniscus shape toward the object on the optical axis, the effective diameter of the second surface S2 of the first lens 101 may be reduced, and the center distance CG1 between the first and second lenses 101 and 102 may be increased.

The second lens 102 has a meniscus shape convex toward the sensor, and a convex fourth surface S4 and a convex fifth surface S5 may face each other in the area between the second lens 102 and the third lens 103. Accordingly, the center distance between the second lens 102 and the third lens 103 may be reduced, and the edge distance may be increased. In addition, the effective diameter of the fifth surface S5 of the third lens 103 may be set to be larger than the effective diameter of the fourth surface S4 of the second lens 102. Since the third lens 103 has a biconvex shape and the center of the sixth surface S6 of the third lens 103 is positioned closer to the object than the edge, the optical axis distance (i.e., BFL) between the third lens 103 and the image sensor 300 may be increased, and the effective diameter of the third lens 103 may be provided to be larger than the diagonal length of the image sensor 300. A space for installing the optical filter 500 may be provided within the area between the third lens 103 and the image sensor 300. The center distance CG2 between the second and third lenses 102 and 103 may be smaller than the thickness of the optical filter 500.

Here, the optical axis distance between the sensor-side sixth surface S6 of the third lens 103 in the image sensor 300 is BFL, the center distance between the first and second lenses 101 and 102 is CG1, and the center distance between the second and third lenses 102 and 103 is CG2. The following conditions may be satisfied:

$$CG 2 * 5 < BFL \qquad Condition 1$$

$$CG 1 < BFL \qquad Condition 2$$

$$ImgH < BFL \qquad Condition 3$$

$$ImgH < CG 1 \qquad Condition 4$$

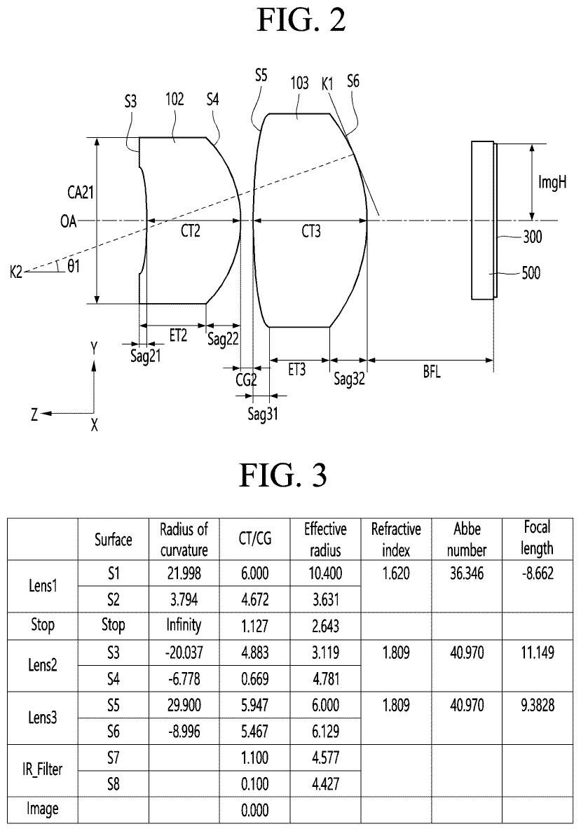

Referring to FIG. 2, the distance along the optical axis from the center of the object-side third surface S3 of the second lens 102 to the third surface S3 perpendicular to the optical axis is Sag21. As shown in FIG. 6, the value of Sag21 is the distance between the lens surface disposed on the sensor side and the line relative to the line, and may have a negative value. The distance in the direction of the optical axis from a straight line perpendicular to the optical axis from the center of the sensor-side fourth surface S4 of the second lens 102 to the fourth surface S4 is Sag22, and as shown in FIG. 6, the value of Sag22 may have a negative value. The distance in the direction of the optical axis from a straight line perpendicular to the optical axis from the center of the object-side fifth surface S5 of the third lens 103 to the fifth surface S5 is Sag31, and as shown in FIG. 6, the value of Sag31 has a positive value.

The distance in the direction of the optical axis from a straight line perpendicular to the optical axis from the center of the sensor-side sixth surface S6 of the third lens 103 to the sixth surface S6 is Sag32, and as shown in FIG. 6, the value of Sag32 has a negative value. In this way, the Sag values of the first and second surfaces S1 and S2 of the first lens 101 may be defined as Sag11 and S12, and as shown in FIG. 6, the value of Sag11 has a positive value, and the value of Sag12 has a positive value. Here, the Max_Sag value is the maximum distance in the direction of the optical axis from a straight line perpendicular to the center of the object-side surface or the sensor-side surface of each lens to the lens surface, and the Sag value may have a negative value when located on the object-side surface relative to the straight line perpendicular to the center, and may have a positive value when located on the sensor-side surface relative to the straight line perpendicular to the center. The maximum Sag values of the first, second, and third lenses 101, 102, and 103 may satisfy the following conditions.

$$\vert Max\_Sag22 \vert < Max\_Sag 11 < Max\_Sag12 \qquad Condition 1$$

$$\vert Max\_Sag21 \vert < \vert Max\_Sag22 \vert \qquad Condition 2$$

$$\vert Max\_Sag31 \vert < \vert Max\_Sag32 \vert \qquad Condition 3$$

$$Max\_Sag 31 < \vert Max\_Sag22 \vert \qquad Condition 4$$

$$Max\_Sag12 / Max\_Sag11 < \vert Max\_Sag 22 / Max\_Sag21 \vert \qquad Condition 5$$

The maximum Sag values of the first surface S1 and the second surface S2 of the first lens 101 may be 2 mm or greater, and Max_Sag11 or Max_Sag12 may be the largest absolute maximum Sag values of the lenses. For example, the condition of Max_Sag12<Max_Sag11 may be satisfied.

The BFL (Back focal length) is the optical axis distance from the image sensor 300 to the center of the sensor-side surface of the last lens 103. A tangent line K1 passing through an arbitrary point of the sixth surface S6 of the third lens 103 and a normal line K2 perpendicular to the tangent line K1 may have a predetermined tangent angle θ1 with the optical axis OA. The maximum tangent angle θ1 on the sixth surface S6 in the first direction X may be 45 degrees or less, for example, in the range of 1 degree to 45 degrees or 10 degrees to 35 degrees, based on an axis parallel to the optical axis.

As shown in FIGS. 1 and 2, CT1, CT2, and CT3 are the center thicknesses or optical axis thicknesses of the first, second, and third lenses 101, 102, and 103, and ET1, ET2, and ET3 are the thicknesses in the optical axis direction at the edges of the first, second, and third lenses 101, 102, and 103. The edge thickness of each lens is the distance in the optical axis direction between the object-side surface and the sensor-side surface at the end of the effective area of each lens. The center thickness and edge thickness of the lenses may satisfy the following conditions.

$$CT 2 < CT 1 \qquad Condition 1$$

$$CT 2 < CT 3 \qquad Condition 2$$

$$ET 3 < ET 1 \qquad Condition 3$$

$$ET 3 < ET 2 \qquad Condition 4$$

$$CT 2 < ET 1 \qquad Condition 5$$

$$CT 1 / ET 1 < CT 2 / ET 2 < CT 3 / ET 3 \qquad Condition 6$$

The effective diameters of the first lens 101 to the third lens 103 are the average of the effective diameters of the object-side surface and the sensor-side surface and are defined as CA1, CA2, and CA3, and the effective diameters of the object-side surface and the sensor-side surface of the first lens 101 to the third lens 103 may be defined as CA11, CA12, CA21, CA22, CA31, and CA32. When the aperture stop ST is arranged on the sensor-side surface of the first lens 101, the following conditions may be satisfied.

$$CA 2 < CA 3 < CA 1 \qquad Condition 1$$

$$( ImgH * 2 ) < CA 3 \qquad Condition 2$$

$$CA 21 < CA 31 < CA 11 \qquad Condition 3$$

$$CA 21 < CA 22 < CA 31 \qquad Condition 4$$

$$CA 21 < CA 12 < CA 12 * 2 < CA 11 \qquad Condition 5$$

Since the first lens 101, disposed on the object side of the aperture stop ST, has a negative power (F1<0) and a convex meniscus shape toward the object, the first lens 101 can refract incident light toward the second lens 102. Furthermore, since the two opposing surfaces of the second and third lenses 102 and 103 are convex, the edge distance between the second and third lenses 102 and 103 may be greater than the center distance. Accordingly, the center distance CG2 between the second and third lenses 102 and 103 may be reduced, preventing a decrease in the yield by weight of the optical system and improving production efficiency. Here, an increase in the effective diameter of the second lens 102 arranged on the sensor side of the aperture stop ST may be prevented, and the thickness of the camera module may be provided slimly within the field of view range.

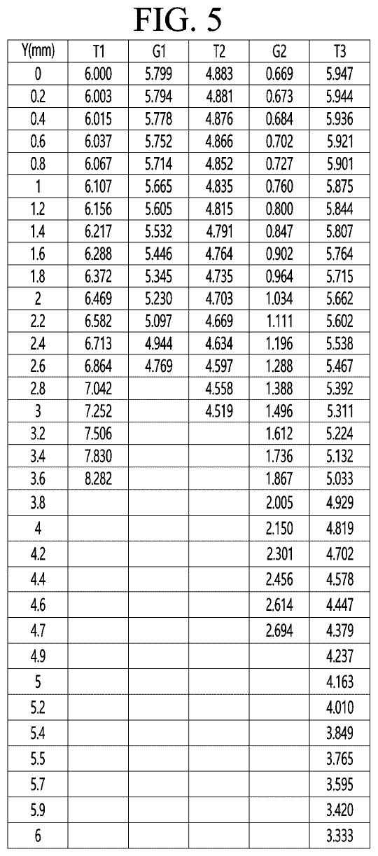

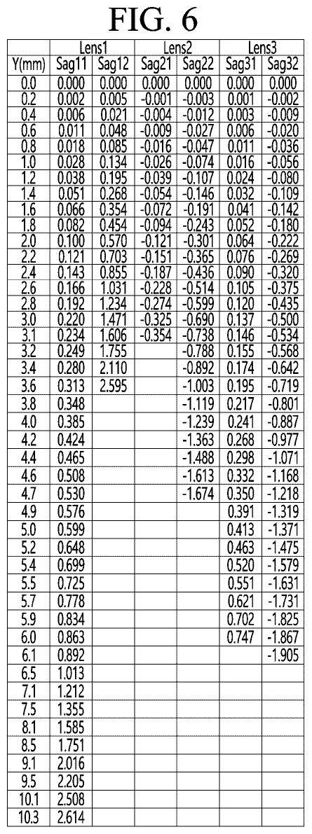

FIG. 5 is a graph showing the thickness of each lens and the distance between adjacent lenses in the optical system of FIG. 1, measured at intervals of 0.1 mm or more from the center to the edge, wherein T1, T2, and T3 represent the thicknesses from the center to the edge of the first to third lenses 101, 102, and 103, G1 represents the distance between the first lens 101 and the second lens 102, and represents the distance from the center to the edge, and G2 represents the distance between the second lens 102 and the third lens 103, and represents the distance from the center to the edge. The distance G1 between the first and second lenses 101 and 102 may gradually decrease from the optical axis toward the edge due to the concave shape of the sensor-side surface of the first lens 101 and the concave shape of the object-side surface of the second lens 102. That is, the distance G1 between the first and second lenses 101 and 102 may have the largest center distance CG1 and the smallest edge distance. In the distance G1 between the first and second lenses 101 and 102, the difference between the center distance CG1 and the edge distance may be 20% or less or 2 mm or less based on the center distance.

Since the center distance CG1 between the first lens 101 and the second lens 102 is smaller than the maximum center thickness of the lenses and is provided as a distance of less than 6 mm, the change in the Sag value of the third surface S4 of the second lens 102 may be set to be gentle so that the edge distance between the first and second lenses 101 and 102 does not increase abruptly. The distance G2 between the second lens 102 and the third lens 103 may gradually increase from the center to the edge. This distance G2 nat gradually increase from the optical axis toward the edge due to the convex shape of the sensor-side surface of the second lens 102 and the convex shape of the object-side surface of the third lens 103. That is, the distance G2 between the second lens 102 and the third lens 103 may have the smallest center distance and the largest edge distance.

FIG. 3 is an example of lens data of the optical system of the first embodiment of FIG. 1. As shown in FIG. 3, the radius of curvature of the first to third lenses 101, 102, and 103 on the optical axis OA, the center thickness CT of the lenses, the center distance CG between adjacent lenses, the refractive index at the d-line, the Abbe number, the semi-aperture (or effective radius), and the focal length may be set. The radii of curvature of the first and second surfaces S1 and S2 of the first lens 101 are L1R1 and L1R2, the radii of curvature of the third and fourth surfaces S3 and S4 of the second lens 102 are L2R1 and L2R2, and the radii of curvature of the fifth and sixth surfaces S5 and S6 of the third lens 103 may be expressed as L3R1 and L3R2. These radii of curvature are radii of curvature on the optical axis of each lens surface, and may satisfy at least one of the following conditions.

$$L 1 R 2 < L 1 R 1 \qquad Condition 1$$

$$L 1 R 2 < \vert L 2 R 2 \vert < \vert L 2 R 1 \vert \qquad Condition 2$$

$$\vert L 2 R 2 \vert < \vert L 3 R 2 \vert \qquad Condition 3$$

$$\vert L 3 R 2 \vert < \vert L 2 R 1 \vert < L 3 R 1 \qquad Condition 4$$

If the third lens 103 is designed as an aspherical surface, thermal compensation may be satisfied and optical performance may be improved. However, assembly may be more difficult than with a spherical lens. Furthermore, the aspherical third lens 103 may affect the optical characteristics of lenses positioned closer to the object than the third lens 103. The invention facilitates assembly by adjusting the thickness and radius of curvature of the aspherical third lens 103. That is, since the edge thickness ET3 of the third lens 103 is 2 mm or more, and the difference (absolute value) in the radius of curvature of the fifth and sixth surfaces S5 and S6 is provided to be 30 mm or less, the deterioration of the assembling ability of the third lens 103 within the lens barrel may be prevented. The thickness and radius of curvature of the second lens 102 having an aspherical surface can facilitate assembly. That is, since the edge thickness ET2 of the second lens 102 is 2.5 mm or more, and the difference (absolute value) in the radius of curvature of the third and fourth surfaces S3 and S4 is provided to be 20 mm or less, the deterioration of the assembling ability of the second lens 102 within the lens barrel may be prevented.

Furthermore, since the first lens 101 having a spherical surface is disposed on the object side of the aperture stop ST and is the lens most sensitive to optical characteristics, the effective diameter of the second lens 102 is set to be larger than the effective diameter of the sensor-side surface of the first lens 101, and the difference in the radius of curvature between the second surface S2 of the first lens 101 and the third surface S3 of the second lens 102 may be set to 20 mm or less. Furthermore, the difference in the center thicknesses of the first lens 101 and the second lens 102 may be set to 2 mm or less. Furthermore, the difference in the center thicknesses of the second lens 102 and the third lens 103 may be set to 2 mm or less. Accordingly, an optical system having a low CRA (Chief ray angle) may be implemented by the aperture stop ST between the first and second lenses 101 and 102.

In terms of the thickness of the lenses, the center thickness CT2 of the second lens 102 may be smaller than the center thicknesses CT1 and CT3 of the first and third lenses 101 and 103. Preferably, the maximum thickness among the lenses may be the center thickness CT1 of the first lens 101. Since the center thickness CT1 of the first lens 101 is thicker than 4 mm and the radius of curvature of the sensor-side second surface S2 is provided as a minimum, light incident through the glass lens may be refracted to the end of the effective area of the last lens. The sum of the center thicknesses of the first to third lenses 101-103 may be defined as YCT, and the sum of the edge thicknesses of the first to third lenses 101-103 may be defined as YET. The ratio of the center thickness and the edge thickness of each lens may satisfy the following conditions.

$$0.5 < CT 1 / ET 1 < 1 \qquad Condition 1$$

$$0.5 < CT 2 / ET 2 < 1.5 \qquad Condition 2$$

$$1 < CT 3 / ET 3 < 2.5 \qquad Condition 3$$

$$0.5 < \sum CT / \sum ET < 1.5 \qquad Condition 4$$

Furthermore, the thickness of each lens may satisfy the following conditions:

$$1 < CT 1 / CT 2 < 3 \qquad Condition 1$$

$$0.5 < CT 2 / CT 3 < 1.5 \qquad Condition 2$$

$$0.2 < CT 1 / \sum CT < 0.5 \qquad Condition 3$$

$$0.3 < ET 1 / \sum CT < 0.6 ( where CT 1 < ET 1 ) \qquad Condition 4$$

In the above conditions, if CTi/ETi (i=1~3), it may be minimum when i is 1. The difference between the center thickness and the edge thickness of each lens may be set to be greater than 0.1 mm and less than 3.5 mm. By arranging an aspherical lens on the third lens 103, the incident light may be refracted to the periphery of the image sensor 300 without increasing the difference between the center thickness and the edge thickness of each lens. Furthermore, by setting the center thickness and edge thickness difference of the third lens 103 to 3.5 mm or less, the difference in the radius of curvature between the object-side surface and the sensor-side surface may be designed to be small, improving the assembling performance of the aspherical third lens 103 and reducing the impact on optical characteristics.

Furthermore, the difference between the maximum and minimum center thicknesses of the lenses may be 3 mm or less, for example, in the range of 0.1 mm to 3 mm or 0.5 mm to 2 mm. In other words, even if the center thickness difference of the glass lenses is designed to be small, optical performance may not be degraded, and the thickness of the camera module may be slimmed down. Furthermore, since the difference between the center and edge thicknesses of each lens is not significant, even if at least one lens is tilted, the influence on optical characteristics may be reduced. Furthermore, the influence on thermal characteristics between the center and edge of the lenses may be reduced.

The center distance between the first to third lenses 101, 102, and 103 is defined as CG1 and CG2, and the sum of the center distances between the first to third lenses 101, 102, and 103 may be defined as YCG. The following conditions may be satisfied:

$$\sum CG < \sum CT \qquad Condition 1$$

$$1 < \sum CG / CG 1 < 1.5 \qquad Condition 2$$

$$CG 2 * 5 < CG 1 \qquad Condition 3$$

Regarding the refractive indices, each of the first to third lenses 101, 102, and 103 may have a refractive index of 1.5 or greater. Each of the first to third lenses 101, 102, and 103 may be made of glass material and have a refractive index of 1.60 or greater, and a maximum refractive index of 1.9 or less, for example, less than 1.9. The second and third lenses 102 and 103 may be made of the same glass material, and may be made of a different glass material from the first lens 101. That is, the second and third lenses 102 and 103 may have the same refractive index. The second and third lenses 102 and 103 may have the same Abbe number. The first lens 101 may be a spherical lens, and the second and third lenses 102 and 103 may be aspherical lenses.

The difference in refractive index between the first and third lenses 101 and 103 is 0.25 or less. The difference in refractive index between the first and second lenses 101 and 102 may be equal to the difference in refractive index between the first and third lenses 101 and 103. The first lens 101 is the glass lens closest to the object and is arranged with a thick thickness. Accordingly, the first lens 101 made of glass exhibits minimal lens shrinkage and movement as the ambient temperature changes from room temperature to low or high temperatures. Therefore, resolution degradation is less severe than with plastic lenses, even with temperature changes. The fact that the first lens 101, positioned at the very front of the optical system, is made of glass reduces the overall resolution change of the optical system as the ambient temperature changes from room temperature to low or high temperatures. The last third lens 103 employs an aspherical lens to prevent resolution degradation due to temperature changes.

The focal lengths F2 and F3 of the second and third lenses 102 and 103 have positive power, while the focal length F1 of the first lens 101 may have negative power. Accordingly, when each lens repeatedly contracts and expands as the temperature changes from low to high, chromatic aberration may be corrected by the highly heat-resistant glass lenses.

When the focal length is expressed as an absolute value, the focal length of the second lens 102 is the largest among the lenses, and may have a difference of 10 mm or less from the focal lengths of the first and third lenses 101 and 103. By setting the difference between the absolute value of the focal length of the first lens 101, which is a spherical lens, and the focal lengths of the second and third lenses 102 and 103 small, the optical system may have improved MTF characteristics, aberration control characteristics, resolution characteristics, etc. in the set field of view range, and may have good optical performance in the periphery of the field of view.

As shown in FIG. 4, among the lenses of the lens unit 100 in the embodiment, the lens surfaces S3, S4, S5, and S6 of the second and third lenses 102 and 103 may include aspherical surfaces having aspherical coefficients (A to J) from the 4th to 20th orders. For example, the third and fourth surfaces S3 and S4 of the second lens 102 may include lens surfaces having aspherical coefficients from the 4th to the 20th order. The fifth and sixth surfaces S5 and S6 of the third lens 103 may include lens surfaces having aspherical coefficients from the 4th to the 20th order. As described above, since an aspherical surface having a 20th aspherical coefficient (a value other than “0”) can significantly change the aspherical shape of the periphery, the optical performance of the periphery of the FOV may be well corrected. As shown in FIG. 5, the thicknesses T1, T2, and T3 of the first to third lenses 101, 102, and 103 and the gaps G1, G2, and G3 between adjacent two lenses may be set. As shown in FIG. 5, the thicknesses T1, T2, and T3 of each lens may be represented at intervals of 0.1 mm or more in the Y-axis direction from the optical axis toward the edge of each lens, and the intervals (G1, G2) between adjacent lenses may be represented at intervals of 0.1 mm or more.

FIG. 7 is a modified example of FIG. 1. Referring to FIG. 7, two aperture stops ST1 and ST may be included. The two aperture stops ST1 and ST may include an external aperture stop ST1 and an internal aperture stop ST. The external aperture stop ST1 is disposed around the object-side surface of the first lens 101 closest to the object and may be an upper aperture stop. The internal aperture stop ST may be a light-adjusting member disposed between adjacent lenses. Here, the external aperture stop ST1 may be a light-shielding film or a light-shielding layer coated around the effective area of the object-side surface of the first lens 101. As another example, the external aperture stop ST1 may be a part of a lens barrel or a cover covering the lens barrel. The external aperture stop ST1 may be defined as a first aperture, and the internal aperture stop ST may be defined as a second aperture stop or an aperture stop. The optical system of FIG. 7 may include the configurations of FIGS. 2 to 6. As shown in FIG. 7, the external aperture stop ST1 may be disposed around the first surface S1 of the first lens 101. The position of the external aperture stop ST1 may be disposed lower than the apex of the first surface S1 of the first lens 101. That is, the position of the external aperture stop ST1 may be disposed between a straight line perpendicular to the optical axis OA at the vertex of the first surface S1 of the first lens 101 and a straight line perpendicular to the optical axis OA at the edge of the first surface S1. The effective diameter of the external aperture stop ST1 may be larger than the effective diameter of the first surface S1. When the effective diameter of the external aperture stop ST1 is CA_ST1 and the effective diameter of the first surface S1 is CA11, the following condition may be satisfied.

$$1 < CA\_ST1 / CA 11 < 1.6 \qquad Condition$$

The external aperture stop ST1 adjusts the incident angle of light incident on the edge of the first surface S1 of the first lens 101, and by adjusting the incident angle, light incident on the outside of the 1.0 field of the image sensor 300, i.e., the 1.1 field, may be blocked. That is, since the external aperture stop ST1 is provided within the above range, it blocks invalid light incident outside the 1.0 field, significantly reducing the relative illumination value incident on the 1.1 field of the image sensor 300.

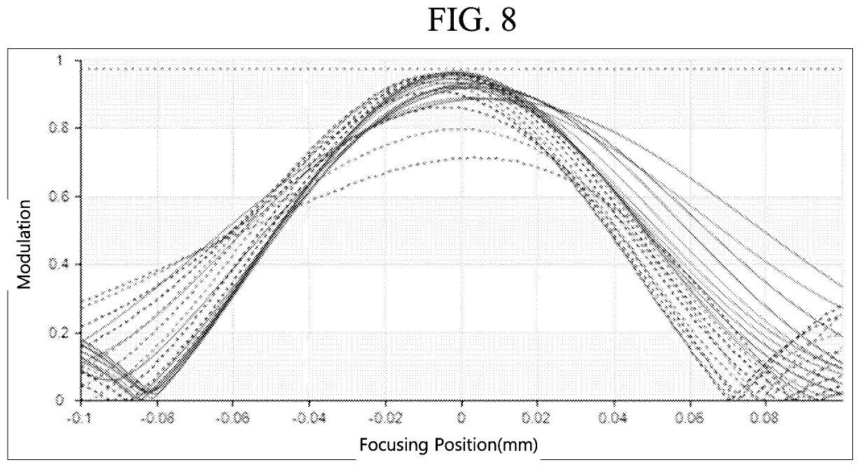

FIG. 8 is a graph showing the diffraction MTF (Modulation Transfer Function) at room temperature in the optical system of FIG. 1, and is a graph showing the modulation ratio according to spatial frequency. As in FIG. 8, the x-axis represents the defocusing position, and the y-axis represents the MTF. The graphs are measured from F1 to F11, from 0.000 mm to 4.000 mm, in 0.400 mm increments.

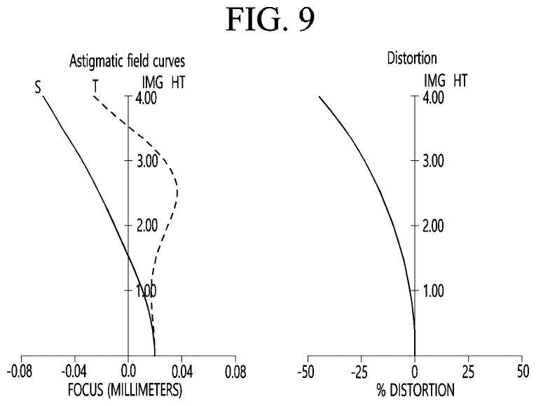

FIG. 9 is a graph showing the aberration characteristics of the optical system of FIG. 1. In the aberration graph of FIG. 9, astigmatic field curves and distortion are measured from left to right. In FIG. 9, the X-axis may represent the focal length (mm) and the degree of distortion (%), and the Y-axis may represent the height of the image. In addition, the graph for astigmatic field curves and distortion aberration is a graph for light in a wavelength band of approximately 940 nm. In the aberration diagram of FIG. 9, it may be interpreted that the closer each curve is to the Y-axis, the better the aberration correction function is, and it may be seen that the optical system 1000 according to the embodiment has measured values close to the Y-axis in almost all areas. That is, the optical system 1000 according to the embodiment has improved resolution and may have good optical performance in the center and periphery of the FOV. Here, Low temperature is −20 degrees or lower, for example, in the range of −20 to −40 degrees, room temperature is 22 degrees+5 degrees or 18 to 27 degrees, and high temperature is 80 degrees or higher, for example, in the range of 80 to 105 degrees. Accordingly, it can be seen that the decrease in luminance ratio (modulation) from low temperature to high temperature is less than 10%, for example, 5% or lower, or is almost unchanged.

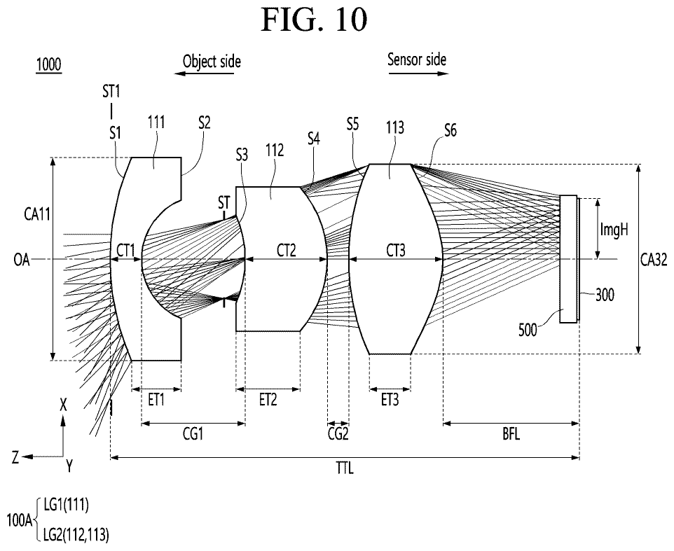

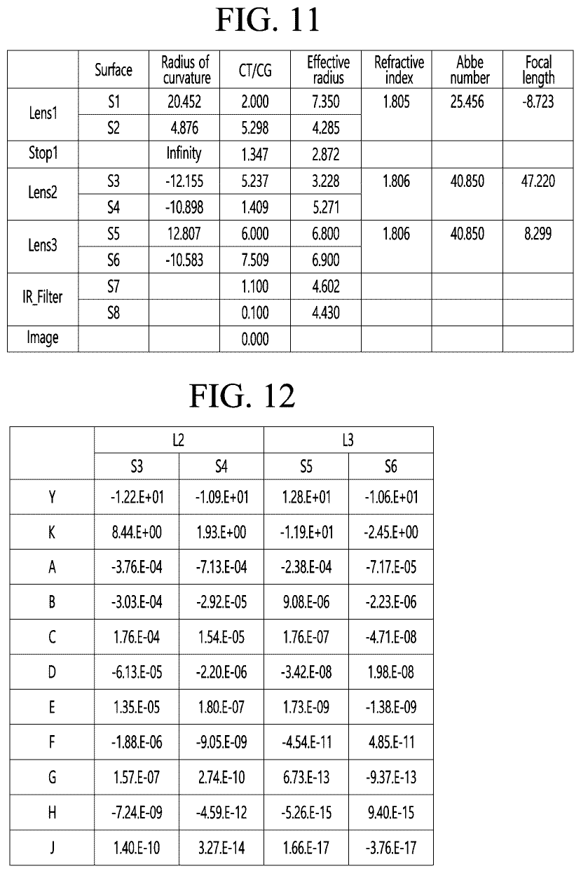

An optical system according to the second embodiment will be described with reference to FIGS. 10 to 16. In describing the second embodiment, the description of the first embodiment may include configurations identical to those of the first embodiment. As shown in FIGS. 10 and 11, the optical system 1000 according to the second embodiment includes a lens unit 100A, which may include a first lens 111 to a third lens 113. The first to third lenses 111, 112, and 113 and the image sensor 300 may be sequentially arranged along the optical axis OA. The first lens 111 is the first lens group LG1, and the second and third lenses 112 and 113 are the second lens group LG2. The first lens group LG1 may have a negative focal length, and the second lens group LG2 may have a positive focal length. The focal lengths of each lens may satisfy the following conditions.

$$\vert F 1 \vert < F 2 ( provided that F 1 < 0 ) \qquad Condition 1$$

$$F < F 23 < F 3 < F 2 \qquad Condition 2$$

$$F < \vert F 1 \vert \qquad Condition 3$$

$$F * 2 < F 2 \qquad Condition 4$$

$$1 < \vert F 1 \vert / F 3 < 1.5 \qquad Condition 5$$

The first lens 111 may have a negative power on the optical axis OA. The first lens 111 may be made of glass. On the optical axis OA, the first surface S1 on the object side of the first lens 111 may be convex, and the second surface S2 on the sensor side may have a concave shape. The first lens 111 may be a spherical lens made of glass, and the first surface S1 and the second surface S2 may be spherical. When the first surface S1 of the first lens 111 has a convex shape, foreign substances such as dust may be prevented from accumulating. The center thickness CT1 of the first lens 111 may be thinner than the center thickness CT2 of the second lens 112, and may be smaller than the center distance CG1 between the first and second lenses 111 and 112. Since the center thickness CT1 of the first lens 111 is less than 4 mm, its effective length may be set to less than 20 mm to prevent rigidity degradation. This first lens 111 can suppress changes in optical performance when temperature changes due to the glass material. Since the first lens 111 is applied as a spherical lens made of glass, the change in the refractive index of light may not be significant.

The second lens 112 may have positive power on the optical axis OA. The second lens 112 may include a glass material. The object-side third surface S3 of the second lens 112 on the optical axis OA may be concave, and the sensor-side fourth surface S4 may have a convex shape. The second lens 112 may be provided as an aspherical lens made of glass material.

The third lens 113 may have positive (+) power. The third lens 113 may be made of glass material. On the optical axis OA, the fifth surface S5 on the object side of the third lens 113 may have a convex shape, and the sixth surface S6 on the sensor side may have a convex shape. The fifth surface S5 and the sixth surface S6 of the third lens 113 may be aspherical on the optical axis. Alternatively, the third lens 113 may have a meniscus shape convex toward the sensor side. Alternatively, the third lens 113 may have a concave shape on both sides, or a meniscus shape convex toward the object side. The third surface S3 and the fourth surface S4 of the second lens 112 may be aspherical. As shown in FIG. 12, the radius of curvature (Y), the conic constant (K), and the aspheric coefficients (A to J) from the 4th to 20th orders of the third and fourth surfaces S3 and S4 and the fifth and sixth surfaces S5 and S6 are shown. At least one or both of the third surface S3 to the sixth surface S6 may be provided without a critical point from the optical axis OA to the end of the effective area.

The aperture stop ST is a member that controls the amount of light, and may be disposed between the first lens 111 and the second lens 112. The aperture stop ST may be disposed around the perimeter between the second surface S2 of the first lens 111 and the third surface S3 of the second lens 112. The aperture stop ST may be disposed closer to the third surface S3 than to the second surface S2. Accordingly, the increase in the effective diameter of the third surface S3 may be suppressed. The effective diameter of the aperture stop ST, the effective diameter of the sensor-side second surface S2 of the first lens 111, and the effective diameter of the third surface S3 of the second lens 112 will refer to the description of the first embodiment. Since the effective diameter of the aperture stop ST is provided within the above range, the amount of light passing through the first lens 111 may be controlled, and the increase in the effective diameter of the third surface S3 of the second lens 112 may be suppressed. Since the aperture stop ST is arranged on the periphery between the first and second lenses 111 and 112, the difference in effective diameter between the second and third surfaces S2 and S3 of the first and second lenses 111 and 112 may be reduced to 2 mm or less. The powers of the first lens 111 and the second lens 112 on either side of the aperture stop ST may have opposite signs. The optical system of the second embodiment further includes an external aperture stop ST1, which may be disposed around the object-side surface of the first lens 111.

At least one or both of the lens surfaces of the first to third lenses 111, 112, and 113 may be provided without a critical point from the center to the edge of the effective area. Alternatively, at least one of the fifth surface S5 and the sixth surface S6 may have at least one critical point from the center to the edge of the effective area. The critical point is the point where the Sag value (sagittal height) trend changes. That is, the point where the Sag value increases and then decreases, or the point where the Sag value decreases and then increases. The third lens 113 has a difference between its center thickness CT3 and its edge thickness ET3 greater than the center thickness of the first lens 111, and the edge thickness ET3 of the third lens 113 is set to 2 mm or more, thereby preventing problems due to assembly tolerances of the third lens 113.

The center thickness CT3 of the third lens 113 may be thicker than the center thicknesses CT1 and CT2 of the first and second lenses 111 and 112. The edge thickness ET2 of the second lens 112 may be the thickest among the edge thicknesses of the lenses. Since the third lens 113 has a thick center thickness and a convex shape on both sides along the optical axis, the center distance (BFL) between the third lens 113 and the image sensor 300 may be increased.

The second lens 112 has a meniscus shape convex toward the sensor, and a convex fourth surface S4 and a convex fifth surface S5 may face each other on an area between the second lens 112 and the third lens 113. Accordingly, the center distance CG2 between the second lens 112 and the third lens 113 may be reduced, and the edge distance may be increased. In addition, the effective diameter of the fifth surface S5 of the third lens 113 may be set to be larger than the effective diameter of the fourth surface S4 of the second lens 112. Since the third lens 113 has a biconvex shape and the center of the sixth surface S6 of the third lens 113 is positioned closer to the object than the edge, the optical axis distance (i.e., BFL) between the third lens 113 and the image sensor 300 may be increased, and the effective diameter of the third lens 113 may be provided to be larger than the diagonal length of the image sensor 300. In addition, a space for installing components such as the optical filter 500 and cover glass may be provided within the area between the third lens 113 and the image sensor 300. The center distance CG2 between the second and third lenses 112 and 113 may be larger than the thickness of the optical filter 500. Here, the following conditions may be satisfied.

$$CG 2 * 4 < BFL \qquad Condition 1$$

$$CG 1 < BFL \qquad Condition 2$$

$$ImgH < BFL \qquad Condition 3$$

$$ImgH < CG 1 < ImgH * 2 \qquad Condition 4$$

Preferably, ImgH*2<BFL may be satisfied.

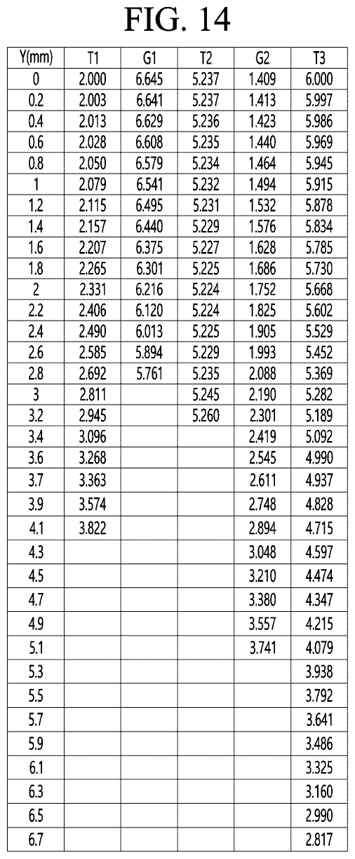

Referring to FIGS. 10 and 14, the maximum Sag values of the first, second, and third lenses 111, 112, and 113 may satisfy the following conditions.

$$Max\_Sag12 > \vert Max\_Sag22 \vert > Max\_Sag11 \qquad Condition 1$$

$$\vert Max\_Sag21 \vert < \vert Max\_Sag22 \vert \qquad Condition 2$$

$$Max\_Sag31 < \vert Max\_Sag32 \vert \qquad Condition 3$$

$$Max\_Sag31 < \vert Max\_Sag22 \vert \qquad Condition 4$$

$$Max\_Sag12 / Max\_Sag11 < \vert Max\_Sag22 / Max\_Sag21 \vert \qquad Condition 5$$

The maximum Sag value of the second surface S2 of the first lens 111 may be 2 mm or greater, and the Max_Sag12 value may be the largest absolute maximum Sag value among the lenses. For example, the condition may satisfy: Max_Sag11<Max_Sag12.

A tangent line K1 passing through any point of the sixth surface S6 of the third lens 113 and a normal line K2 perpendicular to the tangent line K1 may have a predetermined tangent angle θ1 (See FIG. 2) with the optical axis OA. The maximum tangent angle θ1 on the sixth surface S6 in the first direction X may be 45 degrees or less, for example, in the range of 1 degree to 45 degrees or 10 degrees to 35 degrees, with respect to an axis parallel to the optical axis. The center thickness and edge thickness of the lens may satisfy the following conditions.

$$CT 1 < CT 2 \qquad Condition 1$$

$$CT 2 < CT 3 \qquad Condition 2$$

$$ET 3 < ET 1 \qquad Condition 3$$

$$ET 3 < ET 2 \qquad Condition 4$$

$$CT 2 > ET 1 \qquad Condition 5$$

$$CT 1 / ET 1 < CT 2 / ET 2 < CT 3 / ET 3 \qquad Condition 6$$

When the aperture stop ST is disposed on the sensor side of the first lens 111, the following conditions may be satisfied.

$$CA 2 < CA 1 < CA 3 \qquad Condition 1$$

$$( ImgH * 2 ) < CA 3 , CA 1 \qquad Condition 2$$

$$CA 21 < CA 31 < CA 11 \qquad Condition 3$$

$$CA 21 < CA 22 < CA 31 \qquad Condition 4$$

$$CA 21 < CA 12 < CA 12 * 2 < CA 11 \qquad Condition 5$$

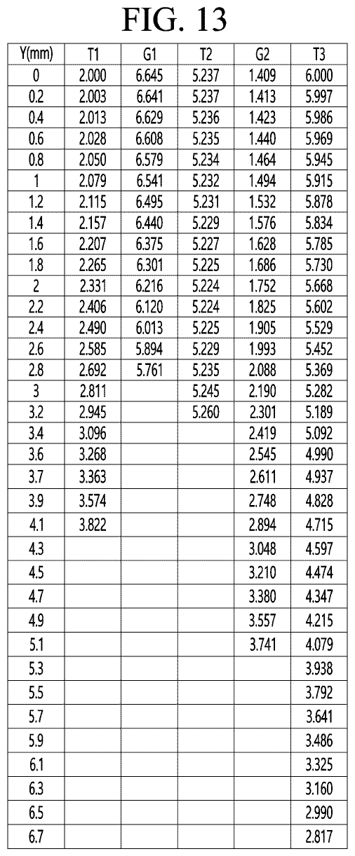

FIG. 13 shows the thickness of each lens and the distance between adjacent lenses in the optical system of FIG. 10, measured at intervals of 0.1 mm or more from the center to the edge. T1, T2, and T3 represent the thicknesses of the first to third lenses 111, 112, and 113 from the center to the edge, and G1 and G2 represent the distance between the first lens 111 and the second lens 112, and the distance between the second lens 112 and the third lens 113, from the center to the edge. The distance G1 between the first and second lenses 111 and 112 may gradually decrease from the center toward the edge due to the concave shape of the sensor-side surface of the first lens 111 and the concave shape of the object-side surface of the second lens 112. In the distance G1 between the first and second lenses 111 and 112, the difference between the center distance CG1 and the edge distance may be 20% or less or 2 mm or less based on the center distance.

Since the first distance CG1 between the first lens 111 and the second lens 112 is greater than the maximum center thickness of the lenses, for example, 5 mm or more, the effective diameter and radius of curvature of the second surface S2 may be adjusted to control the optical path between the first and second lenses 111 and 112. The distance G2 between the second lens 112 and the third lens 113 may gradually increase from the center to the edge. This distance G2 may gradually increase from the optical axis toward the edge due to the convex shape of the sensor-side surface of the second lens 112 and the convex shape of the object-side surface of the third lens 113. In other words, the distance G2 between the second lens 112 and the third lens 113 may have the smallest center distance CG2 and the largest edge distance.

FIG. 11 illustrates an example of lens data for the optical system of the second embodiment of FIG. 10. As shown in FIG. 11, the radius of curvature along the optical axis OA, the center thickness CT of the lenses, the center distance CG between adjacent lenses, the refractive index at the d-line, the Abbe number, the effective radius (semi-aperture or effective radius), and the focal length of the first to third lenses 111, 112, and 113 may be set. The radius of curvature of the object-side and sensor-side surfaces of each lens may satisfy at least one of the following conditions.

$$L 1 R 2 < L 1 R 1 \qquad Condition 1$$

$$L 1 R 2 < \vert L 2 R 2 \vert < \vert L 2 R 1 \vert \qquad Condition 2$$

$$\vert L 2 R 2 \vert < \vert L 3 R 1 \vert \qquad Condition 3$$

$$\vert L 3 R 2 \vert < L 3 R 1 < L 1 R 1 \qquad Condition 4$$

The invention facilitates assembly by adjusting the thickness and radius of curvature of the third lens 113 having an aspherical surface. The edge thickness ET3 of the third lens 113 is 2 mm or more, and the difference (absolute value) in the radius of curvature of the fifth and sixth surfaces S5 and S6 is provided to be 10 mm or less, so that the assembling ease of the third lens 113 may be prevented from deteriorating within the lens barrel. The thickness and radius of curvature of the second lens 112 having an aspherical surface can facilitate assembly. That is, the edge thickness ET2 of the second lens 112 is 2.5 mm or more, and the difference (absolute value) in the radius of curvature of the third and fourth surfaces S3 and S4 is provided to be 10 mm or less, so that the assembling ease of the second lens 112 may be prevented from deteriorating within the lens barrel.

Furthermore, since the first lens 111 having a spherical surface is disposed on the object side of the aperture stop ST and is the lens most sensitive to optical characteristics, the effective diameter of the second lens 112 is set to be smaller than the effective diameter of the sensor-side surface of the first lens 111, and the difference in the radius of curvature between the second surface S2 of the first lens 111 and the third surface S3 of the second lens 112 may be set to 15 mm or less. Furthermore, the difference in the center thicknesses between the first lens 111 and the second lens 112 may be set to 3.5 mm or less. Furthermore, the difference in the center thicknesses between the second lens 112 and the third lens 113 may be set to 2 mm or less. Accordingly, an optical system having a low CRA (Chief ray angle) may be implemented by the aperture stop ST between the first and second lenses 111 and 112.

In terms of the thickness of the lenses, the center thickness CT1 of the first lens 111 may be smaller than the center thicknesses CT2 and CT3 of the second and third lenses 112 and 113. Preferably, the maximum thickness among the lenses may be the center thickness CT3 of the third lens 113. Since the center thickness CT1 of the first lens 111 is thin, less than 4 mm, the radius of curvature of the sensor-side second surface S2 is provided as minimum, and the wide center distance between the first and second lenses 111 and 112 allows light incident through the first lens 111 made of glass to be refracted to the end of the effective area of the last lens. The ratio of the center thickness and the edge thickness of each lens may satisfy the following conditions.

$$0.5 < CT 1 / ET 1 < 1 \qquad Condition 1$$

$$1 < CT 2 / ET 2 < 1.5 \qquad Condition 2$$

$$1 < CT 3 / ET 3 < 3 \qquad Condition 3$$

$$1 < \sum CT / \sum ET < 1.5 \qquad Condition 4$$

Furthermore, the thickness of each lens may satisfy the following conditions:

$$0 < CT 1 / CT 2 < 1 \qquad Condition 1$$

$$0.5 < CT 2 / CT 3 < 1 \qquad Condition 2$$

$$0.3 < CT 3 / \sum CT < 0.6 \qquad Condition 3$$

$$0.2 < ET 2 / \sum CT < 0.5 ( where ET 2 < CT 3 ) \qquad Condition 4$$

$$\sum CG < \sum CT \qquad Condition 5$$

$$1 < \sum CG / CG 1 < 1.5 \qquad Condition 6$$

$$CG 2 * 3 < CG 1 \qquad Condition 7$$

In the above conditions, if CTi/ETi (i=1~3) is present, it may be minimized when i is 1. The difference between the center thickness and the edge thickness of each lens may be set to be greater than 0.5 mm and less than 4 mm. This allows the aspherical lens to be disposed on the third lens 113 to refract incident light to the periphery of the image sensor 300 without increasing the difference between the center and edge thicknesses of each lens. Furthermore, by setting the center and edge thickness difference of the third lens 113 to 4 mm or less, the difference in curvature radius between the object-side and sensor-side surfaces may be reduced, improving the assembly of the aspherical third lens 113 and reducing the impact on optical characteristics. Furthermore, the difference between the maximum and minimum center thicknesses of the lenses may be less than 4.5 mm, for example, in the range of 3 mm to 4.5 mm.

Regarding the refractive index, each of the first to third lenses 111, 112, and 113 may have a refractive index of 1.5 or greater. Each of the first to third lenses 111, 112, and 113 is made of glass and may have a refractive index of 1.60 or greater, and a maximum refractive index of 1.9 or less, for example, less than 1.9. The second and third lenses 112 and 113 may be made of the same glass material, or may be made of a different glass material from the first lens 111. That is, the second and third lenses 112 and 113 may have the same refractive index. The second and third lenses 112 and 113 may have the same Abbe number.

The difference between the refractive index of the first lens 111 and the refractive index of the second and third lenses 112 and 113 may be 0.1 or less. The third lens 113 is the glass lens closest to the image sensor 300 and is arranged with a thick thickness. Furthermore, the first lens 111 made of glass exhibits minimal lens shrinkage and movement as the ambient temperature changes from room temperature to low or high temperatures. Therefore, resolution degradation is less severe compared to plastic lenses, even with temperature changes. The fact that the first lens 111, located at the very front of the optical system, is made of glass minimizes the resolution change of the entire optical system as the ambient temperature changes from room temperature to low or high temperatures. The last third lens 113 employs an aspherical lens to prevent resolution degradation due to temperature changes.

The focal lengths F2 and F3 of the second and third lenses 112 and 113 have positive power, while the focal length F1 of the first lens 111 may have negative power. Accordingly, when each lens undergoes repeated shrinkage and expansion as the temperature changes from low to high temperatures, chromatic aberration may be corrected by the highly heat-resistant glass lenses. When the focal length is expressed as an absolute value, the focal length of the second lens 112 is the largest among the lenses, and may have a difference of 10 mm or more from the focal lengths of the first and third lenses 111 and 113. Accordingly, the optical system may have improved MTF characteristics, aberration control characteristics, resolution characteristics, etc. in the set field of view range, and may have good optical performance in the periphery of the field of view.

As shown in FIG. 12, among the lenses of the lens unit 100A in the embodiment, the lens surfaces S3, S4, S5, and S6 of the second and third lenses 112 and 113 may include aspherical surfaces having aspherical coefficients (A to J) from the 4th to the 20th. For example, the third and fourth surfaces S3 and S4 of the second lens 112 may include lens surfaces having aspherical coefficients from the 4th to the 20th. The fifth and sixth surfaces S5 and S6 of the third lens 113 may include lens surfaces having aspherical coefficients from the 4th to the 20th. As described above, the aspherical surface having the 20th aspherical coefficient (a value other than “0”) can significantly change the aspherical shape of the periphery, and thus can effectively correct the optical performance of the periphery of the FOV. As shown in FIG. 13, the thicknesses T1, T2, and T3 of the first to third lenses 111, 112, and 113 and the distance G1, G2, and G3 between adjacent lenses may be set. The thicknesses T1, T2, and T3 of each lens may be expressed at intervals of 0.1 mm or more in the Y-axis direction from the optical axis toward the edges of each lens, and the distance G1 and G2 between adjacent lenses may be expressed at intervals of 0.1 mm or more. The distance G1 gradually decreases from the center toward the edges, and the distance G1 gradually decreases from the center toward the edges.

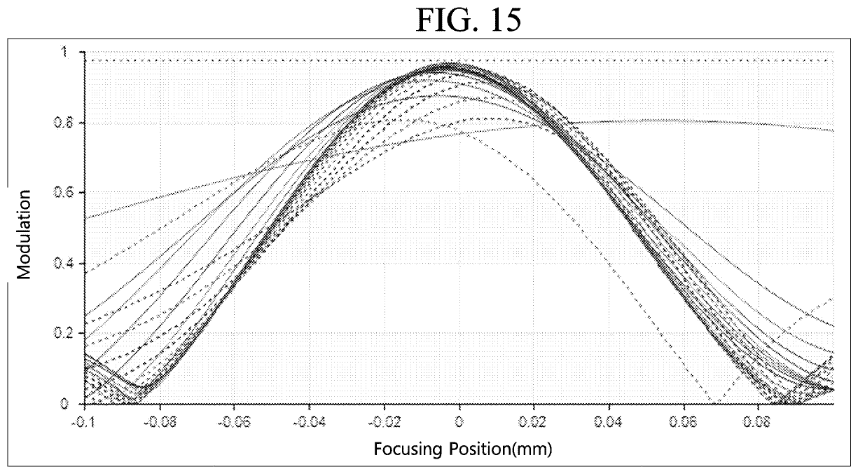

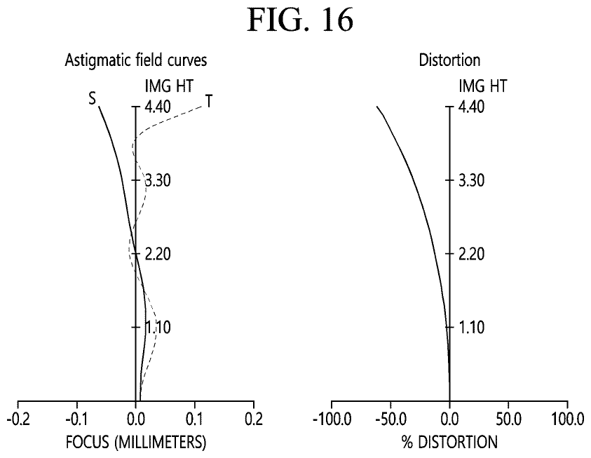

FIG. 15 is a graph showing the diffraction MTF at room temperature in the optical system of FIG. 10, and is a graph showing the luminance ratio according to spatial frequency. As shown in FIG. 15, the x-axis represents the defocusing position, and the y-axis represents the MTF, and these are graphs measured from 0.000 mm to 4.000 mm in increments of 0.400 mm from F1 to F11. FIG. 16 is a graph showing the aberration characteristics in the optical system of FIG. 10. In the aberration graph of FIG. 16, astigmatic field curves and distortion are graphs measured from left to right. In FIG. 16, the x-axis can represent the focal length (mm) and distortion (%), and the y-axis can mean the height of the image. In addition, the graphs for astigmatic aberration and distortion aberration are graphs for light in a wavelength band of approximately 940 nm. In the aberration diagram of FIG. 16, it may be interpreted that the closer each curve is to the Y-axis, the better the aberration correction function is, and it may be seen that the optical system 1000 according to the embodiment has measured values close to the Y-axis in almost all areas. That is, the optical system 1000 according to the embodiment has improved resolution and may have good optical performance even in the center and periphery of the FOV. Here, the low temperature is −20 degrees or lower, for example, in the range of −20 to −40 degrees, the room temperature is in the range of 22 degrees+5 degrees or in the range of 18 degrees to 27 degrees, and the high temperature may be 80 degrees or higher, for example, in the range of 80 degrees to 105 degrees. Accordingly, it may be seen that the decrease in the luminance ratio (modulation) from low temperature to high temperature is less than 10%, for example, 5% or lower, or is almost unchanged.

The optical system 1000 may be designed to enable temperature compensation for the aspherical lens, even if it uses at least one aspherical lens within the lens unit 100A, thereby preventing a decrease in the reliability of optical characteristics. Furthermore, even when the temperature changes from room temperature to low or high, the effective focal length, TD, BFL, F number (F #), and diagonal FOV remain largely unchanged. Here, TD is the optical axis distance from the center of the object-side surface of the first lens 111 to the center of the sensor-side surface of the last lens 113.

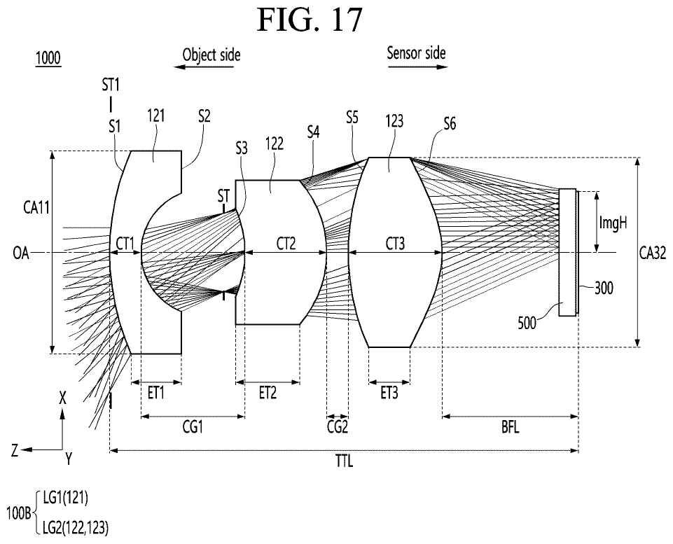

An optical system according to a third embodiment will now be described with reference to FIGS. 17 to 23. In describing the third embodiment, configurations identical to those of the first embodiment may include the description of the first embodiment.

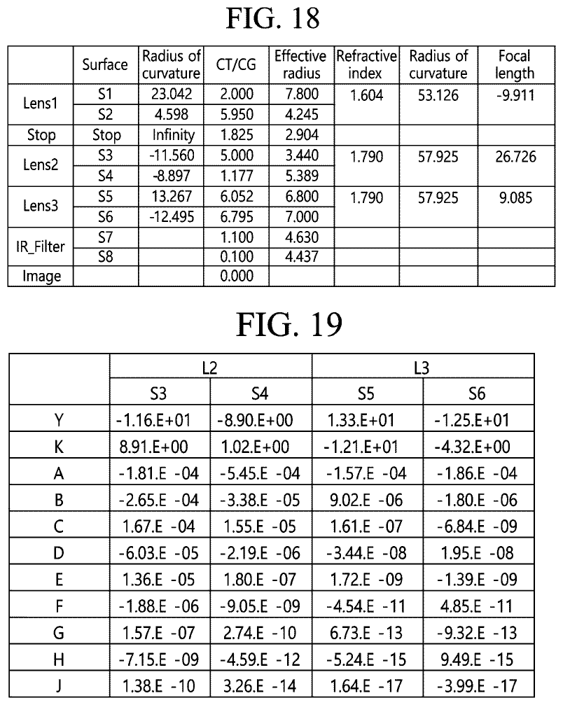

Referring to FIGS. 17 and 18, an optical system 1000 according to a third embodiment includes a lens unit 100B, and the lens unit 100B may include a first lens 121 to a third lens 123. The first to third lenses 121, 122, and 123 and the image sensor 300 may be sequentially aligned along the optical axis OA. The first lens 121 is the first lens group LG1, and the second and third lenses 122 and 123 are the second lens group LG2. The focal lengths of each lens may satisfy the following conditions.

$$\vert F 1 \vert < F 2 ( provided that F 1 < 0 ) \qquad Condition 1$$

$$F < F 23 < F 3 < F 2 \qquad Condition 2$$

$$F 23 < \vert F 1 \vert \qquad Condition 3$$

$$F * 2 < F 2 \qquad Condition 4$$

$$1 < \vert F 1 \vert / F 3 < 1.5 \qquad Condition 5$$

The first lens 121 may have negative power on the optical axis OA. The first lens 121 may be made of glass material. The object-side first surface S1 of the first lens 121 on the optical axis OA may be convex, and the sensor-side second surface S2 may be concave. The first lens 121 may be a spherical lens made of glass material, and the first surface S1 and the second surface S2 may be spherical. The center thickness CT1 of the first lens 121 may be thinner than the center thickness CT2 of the second lens 122 and smaller than the central distance CG1 between the first and second lenses 121 and 122. Since the center thickness CT1 of the first lens 121 is less than 4 mm, its effective length may be set to less than 20 mm to prevent rigidity degradation. The first lens 121 can suppress changes in optical performance when temperature changes due to the glass material. Since the first lens 121 is applied as a spherical lens made of glass, the change in the refractive index of light may not be significant.

The second lens 122 may have positive (+) power on the optical axis OA. The second lens 122 may include a glass material. On the optical axis OA, the object-side third surface S3 of the second lens 122 may have a concave shape, and the sensor-side fourth surface S4 may have a convex shape. The second lens 122 may be provided as an aspherical lens made of glass. The third lens 123 may have positive (+) power. The third lens 123 may be made of glass material. On the optical axis OA, the object-side fifth surface S5 of the third lens 123 may have a convex shape, and the sensor-side sixth surface S6 may have a convex shape. Alternatively, the third lens 123 may have a concave shape on both sides, or a meniscus shape convex toward the object side.

The third surfaces S3 to the sixth surfaces S6 of the second and third lenses 122 and 123 may be aspherical. As shown in FIG. 19, the radius of curvature (Y), the conic constant (K), and the aspherical coefficients (A to J) from the 4th to the 20th order of the third and fourth surfaces S3 and S4 and the fifth and sixth surfaces S5 and S6 are shown. At least one or both of the third surface S3 to the sixth surface S6 may be provided without a critical point from the optical axis OA to the end of the effective area. At least one or all of the lens surfaces of the first to third lenses 121, 122, and 123 may be provided without a critical point from the center to the end of the effective area. Alternatively, at least one of the fifth surface S5 and the sixth surface S6 may have at least one critical point from the center to the end of the effective area. The critical point is a point where the trend of the Sag value (sagittal height) changes. That is, it is a point where the Sag value increases and then decreases, or a point where the Sag value decreases and then increases.

The aperture stop ST is a member that controls the amount of light, and the aperture stop ST may be disposed between the first lens 121 and the second lens 122. The aperture stop ST may be arranged on the periphery between the second surface S2 of the first lens 121 and the third surface S3 of the second lens 122. The aperture stop ST may be arranged closer to the third surface S3 than to the second surface S2. Accordingly, an increase in the effective diameter of the third surface S3 may be suppressed. The effective diameter of the aperture stop ST, the effective diameter of the sensor-side second surface S2 of the first lens 121, and the effective diameter of the third surface S3 of the second lens 122 will refer to the description of the first embodiment. By providing the effective diameter of the aperture stop ST within the above range, the amount of light passing through the first lens 121 may be controlled, and an increase in the effective diameter of the third surface S3 of the second lens 122 may be suppressed. Since the aperture stop ST is disposed on the perimeter between the first and second lenses 121 and 122, the difference in effective diameter between the second and third surfaces S2 and S3 of the first and second lenses 121 and 122 may be reduced to 2 mm or less. The powers of the first lens 121 and the second lens 122 on either side of the aperture stop ST may have opposite signs. The third lens 123 provides a difference between the center thickness CT3 and the edge thickness ET3 to be greater than the center thickness CT1 of the first lens 121, and the edge thickness (ET3) of the third lens 123 is set to 2 mm or more to prevent problems due to assembly tolerance of the third lens 123.

The center thickness CT3 of the third lens 123 may be thicker than the center thicknesses CT1 and CT2 of the first and second lenses 121 and 122. The edge thickness ET2 of the second lens 122 may be the thickest among the edge thicknesses of the lenses. Since the third lens 123 has a thick center thickness and has a shape in which both sides are convex on the optical axis, the center distance (BFL) between the third lens 123 and the image sensor 300 may be increased.

The second lens 122 has a meniscus shape convex toward the sensor side, and a convex fourth surface S4 and a convex fifth surface S5 can face each other in the area between the second lens 122 and the third lens 123. Accordingly, the center distance CG2 between the second lens 122 and the third lens 123 may be reduced, and the edge distance may be increased. In addition, the effective diameter of the fifth surface S5 of the third lens 123 may be set to be larger than the effective diameter of the fourth surface S4 of the second lens 122. Since the third lens 123 has a biconvex shape and the center of the sixth surface S6 of the third lens 123 is positioned closer to the object than the edge, the optical axis distance (i.e., BFL) between the third lens 123 and the image sensor 300 may be increased, and the effective diameter of the third lens 123 may be provided to be larger than the diagonal length of the image sensor 300. In addition, a space for installing components such as the optical filter 500 and cover glass may be provided within the area between the third lens 123 and the image sensor 300. The center distance CG2 between the second and third lenses 122 and 123 may be larger than the thickness of the optical filter 500. Here, the following conditions may be satisfied.

$$CG 2 * 4 < BFL \qquad Condition 1$$

$$CG 1 < BFL \qquad Condition 2$$

$$ImgH < BFL \qquad Condition 3$$

$$ImgH < CG 1 < ImgH * 2 \qquad Condition 4$$

Preferably, ImgH*2<BFL may be satisfied.

$$Condition 2 may satisfy : 0 < ( B F L - CG 1 ) < 0.5 mm .$$

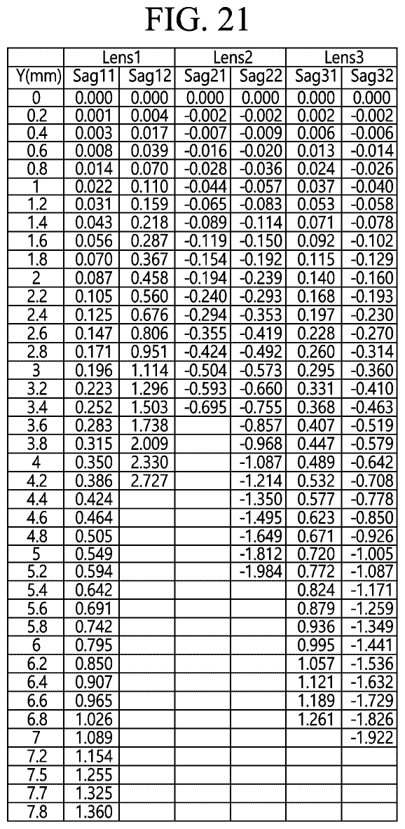

Referring to FIGS. 17 and 21, the maximum Sag values of the first, second, and third lenses (121, 122, and 123) may satisfy the following conditions:

$$Max\_Sag21 < \vert Max\_Sag 22 \vert > Max\_Sag 11 \qquad Condition 1$$

$$\vert Max\_Sag21 \vert < \vert Max\_Sag 22 \vert \qquad Condition 2$$

$$Max\_Sag31 < \vert Max\_Sag 32 \vert \qquad Condition 3$$

$$Max\_Sag31 < \vert Max\_Sag 22 \vert \qquad Condition 4$$

$$Max\_Sag12 / Max\_Sag 11 < \vert Max\_Sag 22 / Max\_Sag 21 \vert \qquad Condition 5$$

The maximum Sag value of the second surface S2 of the first lens 121 may be 2 mm or greater, and the Sag12 value may be the largest absolute maximum Sag value among the lenses. For example, the condition may satisfy: Max_Sag11<Max_Sag12.

A tangent line K1 passing through any point of the sixth surface S6 of the third lens 123 and a normal line K2 perpendicular to the tangent line K1 may have a predetermined tangent angle θ1 (See FIG. 2) with the optical axis OA. The maximum tangent angle θ1 on the sixth surface S6 in the first direction X may be 45 degrees or less, for example, in the range of 1 degree to 45 degrees or 10 degrees to 35 degrees, with respect to an axis parallel to the optical axis. The center thickness and edge thickness of the lens may satisfy the following conditions.

$$CT 1 < CT 2 \qquad Condition 1$$

$$CT 2 < CT 3 \qquad Condition 2$$

$$ET 3 < ET 1 \qquad Condition 3$$

$$ET 3 < ET 2 \qquad Condition 4$$

$$CT 2 > ET 1 \qquad Condition 5$$

$$CT 1 / ET 1 < CT 2 / ET 2 < CT 3 / ET 3 \qquad Condition 6$$

When the aperture stop ST is disposed on the sensor side of the first lens 121, the following conditions may be satisfied.

$$CA 2 < CA 1 < CA 3 \qquad Condition 1$$

$$( ImgH ⋆ 2 ) < CA 1 , CA 3 \qquad Condition 2$$

$$CA 21 < CA 31 < CA 11 \qquad Condition 3$$

$$CA 21 < CA 22 < CA 31 \qquad Condition 4$$

$$CA 21 < CA 12 < CA 12 ⋆ 2 < CA 11 \qquad Condition 5$$

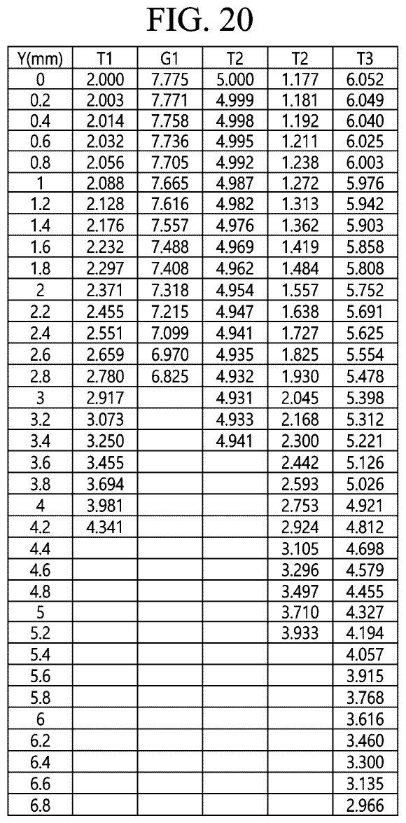

In FIG. 20, the distance G1 between the first and second lenses 121 and 122 may gradually decrease from the center toward the edge due to the concave shape of the sensor-side surface of the first lens 121 and the concave shape of the object-side surface of the second lens 122. In the distance G1 between the first and second lenses 121 and 122, the difference between the center distance CG1 and the edge distance may be 20% or less, or 2 mm or less, of the center distance. Since the center distance CG1 between the first lens 121 and the second lens 122 is greater than the maximum center thickness of the lenses, for example, 5 mm or more, the optical path between the first and second lenses 121 and 122 may be controlled by adjusting the effective diameter and radius of curvature of the second surface S2. The distance G2 between the second lens 122 and the third lens 123 may gradually increase from the center toward the edge. This distance G2 may gradually increase from the optical axis toward the edge due to the convex shape of the sensor-side surface of the second lens 122 and the convex shape of the object-side surface of the third lens 123. In other words, the distance G2 between the second lens 122 and the third lens 123 may have the smallest center distance CG2 and the largest edge distance.

FIG. 18 is an example of lens data of the optical system of the second embodiment of FIG. 17. As shown in FIG. 18, the radius of curvature of the optical axis OA of the first to third lenses 121, 122, and 123, the center thickness CT of the lenses, the center distance CG between adjacent lenses, the refractive index at the d-line, the Abbe number, the effective radius (semi-aperture or effective radius), and the focal length may be set. The radius of curvature of the object-side surface and the sensor-side surface of each lens may satisfy at least one of the following conditions.

$$L 1 R 2 < L 1 R 1 \qquad Condition 1$$

$$L 1 R 2 < \vert L 2 R 2 \vert < \vert L 2 R 1 \vert \qquad Condition 2$$

$$\vert L 2 R 2 \vert < \vert L 3 R 1 \vert \qquad Condition 3$$

$$\vert L 3 R 2 \vert < L 3 R 1 < L 1 R 1 \qquad Condition 4$$

The invention facilitates assembly by adjusting the thickness and radius of curvature of the third lens 123 having an aspherical surface. The edge thickness ET3 of the third lens 123 is 2 mm or greater, and the difference (absolute value) in the radius of curvature between the fifth and sixth surfaces S5 and S6 is 10 mm or less, thereby preventing degradation of the assembly of the third lens 123 within the lens barrel. The thickness and radius of curvature of the second lens 122 having an aspherical surface facilitate assembly. That is, since the edge thickness ET2 of the second lens 122 is 2.5 mm or more, and the difference (absolute value) in the radius of curvature of the third and fourth surfaces S3 and S4 is provided to be 10 mm or less, the deterioration of the assemblability of the second lens 122 within the lens barrel may be prevented.

In addition, since the first lens 121 having a spherical surface is arranged on the object side of the aperture stop ST and is the lens most sensitive to optical characteristics, the effective diameter of the object-side surface of the second lens 122 may be made smaller than the effective diameter of the sensor-side surface of the first lens 121, and the difference in the radius of curvature between the second surface S2 of the first lens 121 and the third surface S3 of the second lens 122 may be set to 15 mm or less. Furthermore, the difference in the center thickness of the first lens 121 and the second lens 122 may be set to 3.5 mm or less. Additionally, the difference in center thickness between the second lens 122 and the third lens 123 may be set to 2 mm or less. Accordingly, an optical system with a low Chief ray angle (CRA) may be implemented by the aperture stop ST between the first and second lenses 121 and 122.

Regarding the thicknesses of the lenses, the center thickness CT1 of the first lens 121 may be smaller than the center thicknesses CT2 and CT3 of the second and third lenses 122 and 123. Preferably, the maximum thickness among the lenses may be the center thickness CT3 of the third lens 123. The center thickness CT1 of the first lens 121 is thin, less than 4 mm, the radius of curvature of the sensor-side second surface S2 is provided as minimum, and due to the wide center distance between the first and second lenses 121 and 122, light incident through the first lens 121 made of glass may be refracted to the end of the effective area of the last lens. The ratio of the center thickness to the edge thickness of each lens may satisfy the following conditions.

$$0.3 < CT 1 / ET 1 < 1 \qquad Condition 1$$

$$1 < CT 2 / ET 2 < 1.7 \qquad Condition 2$$

$$1 < CT 3 / ET 3 < 3 \qquad Condition 3$$

$$1 < \sum CT / \sum ET < 1.5 \qquad Condition 4$$

In addition, the thickness of each lens may satisfy the following conditions.

$$0 < CT 1 / CT 2 < 1 \qquad Condition 1$$

$$0.5 < CT 2 / CT 3 < 1 \qquad Condition 2$$

$$0.3 < CT 3 / \sum CT < 0.6 \qquad Condition 3$$

$$0.2 < ET 2 / \sum CT < 0.5 ( where ET 2 < CT 2 ) \qquad Condition 4$$

$$\sum CG < \sum CT \qquad Condition 5$$

$$1 < \sum CG / CG 1 < 1.5 \qquad Condition 6$$

$$CG 2 ⋆ 5 < CG 1 \qquad Condition 7$$

In the above conditions, when CTi/ETi (i=1~3), it may be minimum when i is 1. The difference between the center thickness and the edge thickness of each lens may be set to more than 0.5 mm and less than 4 mm. This allows the aspherical lens to be disposed on the third lens 123 to refract the incident light to the periphery of the image sensor 300 without increasing the difference between the center thickness and the edge thickness of each lens. In addition, by setting the difference between the center thickness and the edge thickness of the third lens 123 to 4 mm or less, the difference in the radius of curvature between the object-side surface and the sensor-side surface may be designed without being large, and the assemblability of the aspherical third lens 123 may be improved and the influence on the optical characteristics may be reduced. In addition, the difference between the maximum center thickness and the minimum center thickness of the lenses may be 4.5 mm or less, for example, in the range of 3 mm to 4.5 mm.

Regarding the refractive indices, the first through third lenses 121, 122, and 123 may each have a refractive index of 1.5 or greater. Each of the first through third lenses 121, 122, and 123 may be made of glass and have a refractive index of 1.60 or greater, with a maximum refractive index of 1.9 or less, for example, less than 1.9. The second and third lenses 122 and 123 may be made of the same glass material, or may be made of a different glass material from the first lens 121. That is, the second and third lenses 122 and 123 may have the same refractive indices. The second and third lenses 122 and 123 may have the same Abbe number.

The difference between the refractive indices of the first lens 121 and the second and third lenses 122 and 123 may be 0.3 or less. The third lens 123 is the closest glass lens to the image sensor 300 and is arranged with a thick thickness. In addition, the first lens 121 made of glass has less lens shrinkage and movement, etc., as the ambient temperature changes from room temperature to low temperature or high temperature. Therefore, the resolution decreases less compared to a plastic lens even when the temperature changes. The fact that the first lens 121, which is arranged at the front end of the optical system, is made of glass affects the decrease in the resolution change of the entire optical system as the ambient temperature changes from room temperature to low temperature or high temperature. The last third lens 123 can prevent the resolution decrease due to temperature change by applying an aspherical lens. The focal lengths F2 and F3 of the second and third lenses 122 and 123 have positive power, and the focal length F1 of the first lens 121 may have negative power. Accordingly, when each lens repeatedly contracts and expands as the temperature changes from low to high, chromatic aberration may be corrected by the heat-resistant glass lenses.

If the focal length is expressed as an absolute value, the focal length of the second lens 122 is the largest among the lenses and can differ by at least 10 mm from the focal lengths of the first and third lenses 123 and 123. Accordingly, the optical system may have improved MTF characteristics, aberration control characteristics, and resolution characteristics within the set field of view range, and can achieve excellent optical performance at the periphery of the field of view.

As shown in FIG. 19, among the lenses of the lens unit 100A in the embodiment, the lens surfaces S3, S4, S5, and S6 of the second and third lenses 122 and 123 may include aspherical surfaces with aspherical coefficients (A to J) from the 4th to the 20th orders. For example, the third and fourth surfaces S3 and S4 of the second lens 122 may include lens surfaces having aspherical coefficients from the 4th to the 20th order. The fifth and sixth surfaces S5 and S6 of the third lens 123 may include lens surfaces having aspherical coefficients from the 4th to the 20th order. As described above, since an aspherical surface having a 20th aspherical coefficient (a value other than “0”) can significantly change the aspherical shape of the periphery, the optical performance of the periphery of the FOV may be well corrected. As shown in FIG. 20, the thicknesses T1, T2, and T3 of the first to third lenses 121, 122, and 123 and the distances G1, G2, and G3 between adjacent two lenses may be set. The thickness of each lens T1, T2, and T3 in the Y-axis direction toward the edge of each lens from the optical axis may be expressed at intervals of 0.1 mm or more, and each distance G1 and G2 between adjacent lenses may be expressed at intervals of 0.1 mm or more, and the distance G1 gradually decreases from the center toward the edge, and the distance G1 may gradually decrease from the center toward the edge.

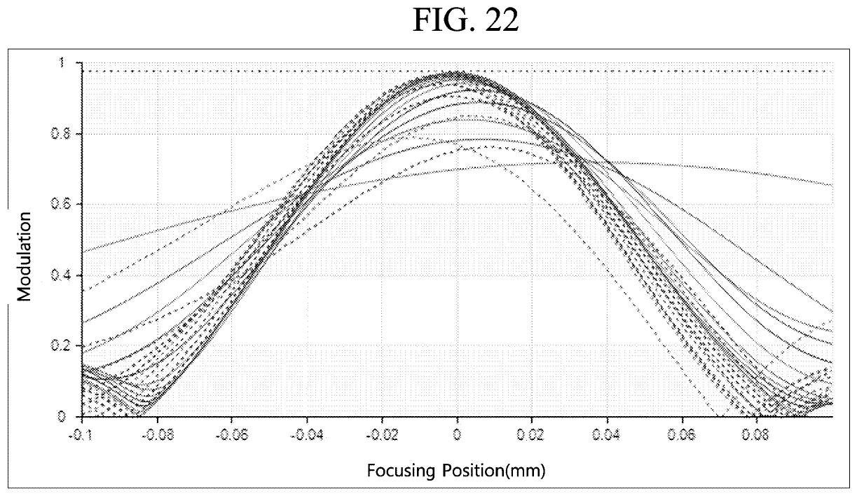

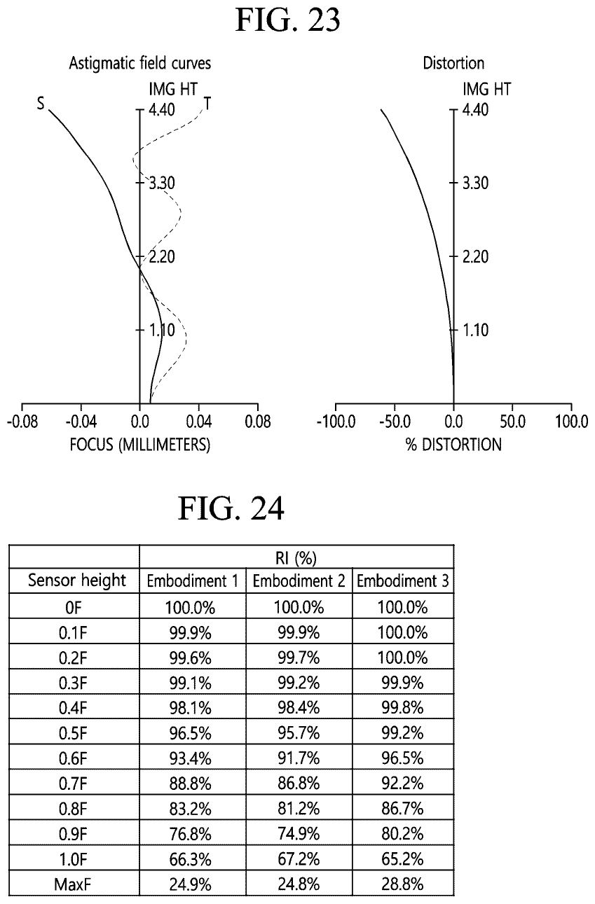

FIG. 22 is a graph showing the diffraction MTF at room temperature in the optical system of FIG. 17, and is a graph showing the luminance ratio according to the spatial frequency. As in FIG. 22, the x-axis represents the defocusing position, and the y-axis represents the MTF, and the graphs are measured from F1 to F11 from 0.000 mm to 4.000 mm in units of 0.400 mm. FIG. 23 is a graph showing the aberration characteristics in the optical system of FIG. 17. In the aberration graph of FIG. 23, astigmatic field curves and distortion are measured from left to right. In FIG. 23, the X-axis may represent the focal length (mm) and the degree of distortion (%), and the Y-axis may represent the height of the image. In addition, the graph for astigmatic field curves and distortion aberration is a graph for light in a wavelength band of approximately 940 nm. In the aberration diagram of FIG. 23, it may be interpreted that the closer each curve is to the Y-axis, the better the aberration correction function is, and it may be seen that the optical system 1000 according to the embodiment has measured values close to the Y-axis in almost all areas. That is, the optical system 1000 according to the embodiment has improved resolution and may have good optical performance in the center and periphery of the FOV. Here, the low temperature is −20 degrees or less, for example, in the range of −20 to −40 degrees, the room temperature is 22 degrees+5 degrees or 18 to 27 degrees, and the high temperature is 80 degrees or more, for example, in the range of 80 to 105 degrees. Accordingly, it may be seen that the luminance ratio (modulation) decreases by less than 10%, for example, 5% or less, or remains largely unchanged from low to high temperatures.

The optical system 1000 may be designed to enable temperature compensation for the aspherical lens, even if at least one aspherical lens is used in the lens unit 100A, thereby preventing a decrease in optical reliability. Furthermore, it may be seen that the effective focal length, TD, BFL, F-number (F #), and diagonal FOV remain largely unchanged even when the temperature changes from room temperature to low or high. Here, TD is the optical axis distance from the center of the object-side surface of the first lens 121 to the center of the sensor-side surface of the last lens 123.

The optical system 1000 according to the first to third embodiments may be designed to enable temperature compensation for the aspherical lens even when at least one aspherical lens is used within the lens unit 100, 100A, and 100B, thereby preventing a decrease in the reliability of optical characteristics. Furthermore, it may be seen that the effective focal length, TD, BFL, F number (F #), and diagonal FOV remain largely unchanged even when the temperature changes from room temperature to low or high. Here, TD is the optical axis distance from the center of the object-side surface of the first lens 101 to the center of the sensor-side surface of the last lens 103, 113, and 123. When the central wavelength of the infrared wavelength is 940 nm+20 nm and the distance from the subject to the first lens 101, 111, and 121 of the camera module is 5,000 mm, the optical system of the embodiment can effectively control various aberration characteristics and achieve excellent optical performance not only at the center but also at the periphery of the FOV.

As shown in FIG. 24, a table showing the peripheral illumination ratio or relative illumination from the center of the image sensor to the sensor height (image height), i.e., from 0 to the maximum height (MaxF=1.1F), in the optical systems according to the first to third embodiments shows that the peripheral illumination ratio is greater than 60%, for example, 64%, from the center of the image sensor to the diagonal end (1.0F). In other words, the difference in peripheral illumination at low, room, and high temperatures is virtually identical from the optical axis to the edge of the effective area. Accordingly, since the minimum light quantity from the center to the edge of the image sensor exceeds 60%, more accurate sensing values can be obtained across the entire area of the image sensor. Here, 60%<1.OF_RI<100% is satisfied, so the minimum light quantity for sensor accuracy may be secured in 1.0 field. 1.OF_RI represents the relative illuminance value in 1.0 field. 0%<Max_RI<30% is satisfied, and the relative illuminance value in Max_RI, which is 1.1 field, may be set to less than 30%, for example, 25% or less, which may be set as the minimum condition for suppressing measurement errors.

The optical system 1000 according to the first to third embodiments disclosed above may satisfy at least one or two or more of the Mathematical Formulas described below. Accordingly, the optical system 1000 according to the embodiments may have improved optical characteristics. For example, when the optical system 1000 satisfies at least one Mathematical Formula, the optical system 1000 can effectively control aberration characteristics such as chromatic aberration and distortion aberration, and may have good optical performance not only at the center but also at the periphery of the FOV. In addition, the optical system 1000 may have improved resolution. In addition, the thickness of the lens at the optical axis OA described in the Mathematical Formulas and the distance between adjacent lenses at the optical axis OA may refer to the embodiments disclosed above.

$$0 < CT 1 / CT 2 < 3 \qquad [ Mathematical Formula 1 ]$$

CT1 refers to the center thickness of the first lens 101, 111, and 121, and CT2 refers to the center thickness of the second lens 102, 112, and 122. Mathematical Formula 1 can adjust the chromatic aberration of the optical system by setting the difference in the center thickness of the first and second lenses to be small. Preferably, the first embodiment satisfies: 1<CT1/CT2<1.5, and the second and third embodiments may satisfy: 0<CT1/CT2<1. By setting the center thickness of each of the first lens having a spherical surface and the second lens having an aspherical surface, the optical performance of the central and peripheral regions of the FOV may be improved.

$$0.5 < CG 1 / CT 1 < 5 \qquad [ Mathematical Formula 2 ]$$

CG1 is the center distance between the first lens 101 and the second lens 102, 112, and 122. When Mathematical Formula 2 is satisfied, the effective diameter of the second lens 102, 112, and 122 may be suppressed from increasing due to the center distance between the first and second lenses and the shape of the first lens 101. Preferably, the first embodiment satisfies: 0.5<CG1/CT1<1, and the second and third embodiments satisfies: 2<CG1/CT1<5.

$$Po 1 < 0 \qquad [ Mathematical Formula 3 ]$$

In Mathematical Formula 3, Pol represents the power of the first lens 101, 111, and 121 and may be set to have an effective focal length F smaller than TTL in the optical system for the performance of the optical system. Accordingly, the condition of TTL>F may be satisfied. Furthermore, a wide field of view may be set by the focal length of the first lens 101 and the overall effective focal length F. That is, the focal length of the first lens 101, 111, and 121 is F1, and F1<0 may be satisfied.

$$1.75 < Nd 3 < 2.2 \qquad [ Mathematical Formula 4 ]$$

Nd3 is the refractive index of the third lens 103, 113, and 123 at the d-line. Mathematical Formula 4 adjusts the factors affecting the reduction of third-order aberrations (Seidel aberrations) of the optical system by setting the refractive index of the third lens 103, 113, and 123 high, thereby reducing aberrations that may occur when the TTL is slightly extended. Mathematical Formula 4 preferably satisfies the condition of 1.75<Nd3<1.95. If designed below the lower limit of Mathematical Formula 4, aberrations may be reduced to achieve performance, but the power of the third lens 103, 113, and 123 may be weakened, preventing it from efficiently refracting light, thereby degrading the performance of the optical system. If designed above the upper limit of Mathematical Formula 4, there is a disadvantage in that materials become difficult to obtain. Furthermore, if the refractive index of the third lens 103, 113, and 123 is designed below the lower limit of Mathematical Formula 4, the radius of curvature of the third lens must be increased to increase the power of the second lens. This makes lens manufacturing more difficult, increases the lens defect rate, and may result in lower yields.

$$1.75 < Nd 2 < 2.2 \qquad [ Mathematical Formula 4 ‐ 1 ]$$

Nd2 is the refractive index of the second lens at the d-line, and preferably satisfies: 1.75<Nd3<1.95.

$$1.65 < Aver ( Nd 1 : Nd 3 ) < 1.85 \qquad [ Mathematical Formula 4 ‐ 2 ]$$

In Mathematical Formula 4-1, Aver(Nd1:Nd3) is the average of the refractive index values at the d-line of the first to third lenses. If the optical system 1000 according to the embodiment satisfies Mathematical Formula 4-1, the optical system may set the resolution and suppress the influence of TTL.

$$L 1 R 1 > 0 \qquad [ Mathematical Formula 5 ]$$

L1R1 represents the radius of curvature of the first surface S1 of the first lens 101, 111, and 121 and may be set to be greater than 0. If the radius of curvature of the first surface S1 of the first lens 101, 111, and 121 satisfies Mathematical Formula 5, the shape of the optical system may be restricted. The object-side surface of the first lens 101, 111, and 121 has a convex shape toward the object from the optical axis, and can increase the amount of incident light. In addition, since the condition of L1R1*L1R2>0 is satisfied, the incident light may be refracted in a direction closer to the optical axis. Accordingly, the embodiment can increase the center distance between the first and second lenses, and thereby provide the effective diameter of the third surface S3 of the second lens to be larger than the effective diameter of the second surface S2 of the first lens.

$$L 1 R 1 / L 1 R 2 > \vert L 2 R 1 / L 2 R 2 \vert \qquad [ Mathematical Formula 6 ]$$

L1R2 is the radius of curvature of the sensor-side surface of the first lens 101, 111, and 121, L2R1 is the radius of curvature of the object-side surface of the second lens 102, 112, and 122, and L2R2 is the radius of curvature of the sensor-side surface of the second lens 102, 112, and 122. The difference in the radius of curvature between the object-side surface and the sensor-side surface of the first lens 101, 111, and 121 may be provided to be greater than the difference in the radius of curvature between the sensor-side surface and the object-side surface of the second lens. Accordingly, light passing through the first lens may be refracted toward the object-side surface of the second lens, thereby improving the incidence efficiency of the second lens.

$$\vert L 2 R 2 \vert < \vert L 2 R 1 \vert \qquad [ Mathematical Formula 6 - 1 ]$$

L2R1 is the radius of curvature of the object-side surface of the second lens 102, 112, and 122, and L2R2 is the radius of curvature of the sensor-side surface of the second lens. Since the first lens has a meniscus shape convex toward the object side, and the second lens 102, 112, and 122 has a meniscus shape convex toward the sensor side and an aspherical lens surface, the center distance between the second and third lenses may be reduced, and light may be uniformly distributed over the entire area of the object-side surface of the third lens. That is, in terms of the absolute value of the radius of curvature, the radius of curvature of the lens surface located on the sensor side of the aperture stop ST may be smaller than the radius of curvature of the lens surface located on the object side of the aperture. In addition, |L3R2|<Since the condition of L3R1 is satisfied, the radius of curvature of the sensor-side surface of the third lens 103, 113, and 123, which is an aspherical lens, may be set small, thereby increasing the distance between the image sensor 300 and the third lens 103, 113, and 123. Accordingly, the position of the optical filter 500 may be disposed between the third lens 103, 113, and 123 and the image sensor 300. The optical filter 500 may be arranged closer to the image sensor 300 than to the third lens 103, 113, and 123.

$$0 < CG 1 / BFL < 1 \qquad [ Mathematical Formula 7 ]$$

BFL is the optical axis distance from the center of the sensor-side surface of the last lens, i.e., the third lens 103, 113, and 123, to the surface of the image sensor 300. When the optical system satisfies mathematical formula 7, the diagonal length of the image sensor 300 is set to be less than 50% of the TTL, for example, less than 40%, thereby setting the conditions for manufacturing a vehicle camera module. In addition, the BFL can secure a space in which a configuration such as an optical filter 500 located between the image sensor 300 and the third lens 103, 113, and 123, or an optical filter 500 and a cover glass may be arranged. When the range of mathematical formula 7 is smaller than the lower limit, the space for arranging circuit structures such as the image sensor 300 becomes restricted, and the process of assembling the circuit structures into the optical system may become difficult. When the range of mathematical formula 7 is larger than the upper limit, the process of assembling circuit structures such as the image sensor into the optical system is easy, but the TTL becomes long, making it difficult to miniaturize the optical system. Preferably, 0.5<CG1/BFL<1 may be satisfied.

$$1 < CA 11 / CA 12 < 4 \qquad [ Mathematical Formula 8 ]$$

CA11 represents the effective diameter of the object-side surface of the first lens 101, 111, and 121, and CA12 represents the effective diameter of the sensor-side surface of the first lens. By setting the effective diameter of the concave sensor-side surface of the first lens 101, 111, and 121 to be smaller than the effective diameter of the convex object-side surface of the first lens, the distance between the first and second lenses and the effective diameter of the second lens may be adjusted. Preferably, 2<CA11/CA12<3.5 may be satisfied. The effective diameter of the object-side first surface S1 of the first lens may be more than twice the effective diameter of the second surface S2. The effective diameter of the object-side first surface S1 of the first lens may be more than twice the effective diameter of the third surface S3 of the second lens.

$$0 < ( CA 12 * CT 1 ) / ( CA 21 * CT 2 ) < 2 \qquad [ Mathematical Formula 9 ]$$

CA21 is the effective diameter of the object-side surface of the second lens 102, 112, and 122. In Mathematical Formula 9, the difference between the values of (CA12*CT1) and (CA21*CT2) may be designed to be small, thereby improving spherical aberration. Preferably, 0<(CA12*CT1)/(CA21*CT2)<1.6 may be satisfied. In addition, the first embodiment satisfies: 1<(CA12*CT1)/(CA21*CT2)<1.6, and the second and third embodiments satisfies: 0<(CA12*CT1)/(CA21*CT2)<1.

$$0.1 < CT 1 / ( CT 2 + CT 3 ) < 1 \qquad [ Mathematical Formula 10 ]$$

Mathematical Formula 10 may be designed so that the difference between the sum of the center thickness CT1 of the first lens 101, 111, and 121 and the center thicknesses CT2 and CT3 of the second and third lenses is not large. In this case, since the first lens 101, 111, and 121 is a spherical lens, the assembly of the first lens may be improved, and since the second and third lenses are aspherical lenses, spherical aberration caused by the spherical lens may be corrected. Furthermore, since the second and third lenses are aspherical lenses made of glass, thermal compensation may be satisfied and optical performance may be improved. Preferably, 0.1<CT1/(CT2+CT3)<0.7 may be satisfied. The first embodiment satisfies: 0.3<CT1/(CT2+CT3)<0.7, and the second and third embodiments may satisfy: 0.1<CT1/(CT2+CT3)<0.5.

$$0.5 < CT 2 / CT 3 < 1.5 \qquad [ Mathematical Formula 11 ]$$

Mathematical Formula 11 is a thickness comparison between aspherical lenses. By ensuring that the difference in the center thickness of the second lens 102, 112, and 122 and the third lens 103, 113, and 123 is not significant, assembly degradation may be prevented, aberration characteristics may be improved, and the influence on optical characteristics may be suppressed. Preferably, 0.5<CT2/CT3<1 may be satisfied.

$$0.5 < CA 11 / CA 31 < 3 \qquad [ Mathematical Formula 12 ]$$

CA11 refers to the effective diameter of the first surface S1 of the first lens 101, 111, and 121, and CA31 refers to the effective diameter of the fifth surface S5 of the third lens 103, 113, and 123. When Mathematical formula 12 is satisfied, the size of the optical system 1000 may be set to control the incident light path and adjust factors affecting aberration. Preferably, Mathematical formula 12 satisfies: 1<CA11/CA31<2.2. Since the first and third lenses satisfy Mathematical formula 12, the amount of incident light may be increased by the first lens, and the deterioration of assembly due to the difference in effective diameters of the first and third lenses may be prevented. In addition, the optical effects due to temperature changes may be reduced by the glass lenses. The first embodiment satisfies: 1.4<CA11/CA31<2.4, and the second and third embodiments may satisfy: 1<CA11/CA31<1.3.

$$1 < CA 2 / CT 2 < 5 \qquad [ Mathematical formula 13 ]$$

CA2 is the average of the effective diameters of the object-side and sensor-side surfaces of the second lens 102, 112, and 122. When the optical system satisfies Mathematical Formula 13, the center thickness of the second lens 102, 112, and 122 having an effective diameter of 6 mm or greater may be set. Preferably, 1.2<CA2/CT2<2.2 may be satisfied.

$$1 < CA 3 / CT 3 < 5 \qquad [ Mathematical Formula 13 - 1 ]$$

CA3 is the average of the effective diameters of the object-side and sensor-side surfaces of the third lens 103, 113, and 123. When the optical system satisfies Mathematical Formula 13-1, the center thickness of the third lens 103, 113, and 123 having an effective diameter of 8 mm or greater may be set. Preferably, 1.5<CA3/CT3<2.5 may be satisfied.

$$0.5 < CA 22 / CA 31 < 1.5 \qquad [ Mathematical Formula 14 ]$$

CA22 refers to the effective diameter of the fourth surface S4 of the second lens 102, 112, and 122, and CA31 refers to the effective diameter of the fifth surface S5 of the third lens 103, 113, and 123. When the optical system 1000 according to the embodiment satisfies Mathematical Formula 14, light traveling within the second lens group LG2 may be controlled, and factors affecting lens sensitivity may be set. Mathematical Formula 14 preferably satisfies: 0.5<CA22/CA31<1. Since the second and third lenses satisfy Mathematical Formula 14, the size for assembling the aspherical lenses may be set.

$$3 < CT 2 / CG 2 < 10 \qquad [ Mathematical Formula 15 ]$$

CG2 is the center distance between the second and third lenses. In Mathematical formula 15, the TTL may be adjusted by setting the center thickness of the second lens 102 and the center distance between the second and third lenses. Preferably, 3<CT2/CG2<8 may be satisfied. If this is satisfied, the center distance between the second and third lenses may be reduced, and the curvature radii and effective diameters of the second and third lenses may be set. The first embodiment satisfies: 5<CT2/CG2<10, and the second and third embodiments satisfies: 3<CT2/CG2<5.

$$3 < CT 3 / CG 2 < 11 \qquad [ Mathematical formula 16 ]$$

In Mathematical formula 16, the TTL may be adjusted by setting the center thickness of the third lens 103, 113, and 123 and the center distance between the second and third lenses. Preferably, 3.5<CT3/CG2<10 may be satisfied. Additionally, CT2 and CT3 may each be 3.5 mm or greater or 4 mm or greater. 5<CT3/CG2<10, and the second and third embodiments may satisfy: 3<CT3/CG2<8.

$$CG 1 > CG 2 \qquad [ Mathematical Formula 16 - 1 ]$$

$$3 < CG 1 / CG 2 < 10 \qquad [ Mathematical Formula 16 - 2 ]$$

In Mathematical Formulas 16-1 and 16-2, the center distance between the first and second lenses is set to be greater than the center distance between the second and third lenses, for example, more than three times, thereby establishing an optical path between the first lens having the largest effective length and the second lens having the smallest effective length.

$$0.1 < Max\_Sag 11 / Max\_Sag12 < 1.5 \qquad [ Mathematical Formula 17 ]$$

Max_Sag11 is the maximum optical axis distance from the center of the object-side first surface S1 of the first lens 101, 111, and 121 to the end of the first surface S1 from a straight line perpendicular to the optical axis OA. Max_Sag12 is the maximum optical axis distance from the center of the sensor-side second surface S2 of the first lens 101, 111, and 121 to the end of the second surface S2 from a straight line perpendicular to the optical axis. When the first lens satisfies Mathematical Formula 17, the radius of curvature and the effective diameter of the object-side surface and the sensor-side surface of the first lens may be set. The first embodiment may satisfy: 0.8<Max_Sag11/Max_Sag12<1.2. The second and third embodiments may satisfy: 0.2<Max_Sag11/Max_Sag12<1.

$$1 < CG 1 / Max\_Sag12 < 3 \qquad [ Mathematical Formula 18 ]$$

When the optical system satisfies Mathematical Formula 18, the center distance CG1 between the first and second lenses may be set according to the size of the maximum Sag value of the concave sensor-side surface of the first lens 101, 111, and 121, i.e., the concave depth of the sensor-side surface. Preferably, the first embodiment may satisfy: 2<CG1/Max_Sag12<2.5, and the second and third embodiments may satisfy: 2.3<CG1/Max_Sag12<3.

$$1 < \vert Max\_Sag32 / Max\_Sag31 \vert < 5 \qquad [ Mathematical Formula 19 ]$$

Max_Sag31 is the maximum optical axis distance from the straight line perpendicular to the optical axis OA at the center of the object-side fifth surface S5 of the third lens 103, 113, and 123 to the end of the fifth surface S5. Max_Sag32 is the maximum optical axis distance from the straight line perpendicular to the optical axis at the center of the sensor-side sixth surface S6 of the third lens 103, 113, and 123 to the end of the sixth surface S6. When the third lens 103, 113, and 123 satisfies Mathematical Formula 19, the radius of curvature and the effective diameter of the object-side surface and the sensor-side surface of the third lens may be set. In addition, the object-side surface and the sensor-side surface of the third lens may have a Sag value for refracting light to the entire area of the image sensor 300. Preferably, 1<|Max_Sag32/Max_Sag31|<3 may be satisfied.

$$\vert Max\_Sag22 \vert > \vert Max\_Sag31 \vert \qquad [ Mathematical Formula 20 ]$$

Max_Sag22 is the maximum optical axis distance from the straight line perpendicular to the optical axis OA at the center of the sensor-side fourth surface S4 of the second lens 102, 112, and 122 to the end of the fourth surface S4. By setting the maximum Sag value of the sensor-side surface of the second lens 102, 112, and 122 to be greater than the maximum Sag value of the object-side surface of the third lens 103, 113, and 123, the center distance between the second and third lenses may be reduced and the edge distance may be increased, and light refracted through the second lens 102, 112, and 122 may be uniformly incident on the entire area of the third lens 103, 113, and 123.

$$CA 2 / ( ImgH * 2 ) < CA 3 / ( ImgH * 2 ) \qquad [ Mathematical Formula 21 ]$$

The ImgH value is half the diagonal length of the image sensor 300, and the average effective diameter of the third lens 103, 113, and 123 may be set to be larger than the average effective diameter of the second lens 102, 112, and 122. Furthermore, (ImgH*2)<CA3 may be satisfied, and CA21<(ImgH*2)<CA22 may be satisfied.

$$( ImgH * 2 ) < CA 22 < CA 11 \qquad [ Mathematical Formula 22 ]$$

CA22 is the effective diameter of the fourth surface S4 of the second lens 102, 112, and 122, and CA11 is the effective diameter of the first surface S1 of the first lens 101, 111, and 121. The diagonal length of the image sensor 300 may be set to be smaller than the effective diameter of the first surface S1 of the first lens and the effective diameter of the fourth surface S4 of the second lens 102, 112, and 122. Among the lens surfaces of the first to third lenses, the lens surfaces smaller than the diagonal length of the image sensor 300 may include the second surface S2 and the third surface S3. That is, CA12<(ImgH*2) may be satisfied.

$$0 < DLG 1 / DLG 2 < 1 \qquad [ Mathematical Formula 23 ]$$

DLG1 is the optical axis distance of the first lens group LG1, for example, the optical axis distance from the object-side surface of the first lens 101, 111, and 121 to the sensor-side surface. DLG2 is the optical axis distance of the second lens group LG2, for example, the optical axis distance from the object-side surface of the second lens 102, 112, and 122 to the sensor-side surface of the third lens 103, 113, and 123. When the optical system satisfies mathematical formula 23, the optical axis distances may be set to have 5 or less, or 4 or less lenses based on the position of the aperture stop ST, respectively. In mathematical formula 23, the optical axis distance of the first lens group DLG1 disposed on the object side of the aperture stop ST1 may be provided to be smaller than the optical axis distance of the second lens group LG2, so that distortion and chromatic aberration caused by the first lens 101, 111, and 121 may be corrected. Preferably, the first embodiment may satisfy: 0.2<DLG1/DLG2<0.8, and the second and third embodiments may satisfy: 0.1<DLG1/DLG2<0.5. Since mathematical formula 23 is satisfied, aberration and distortion that may occur in an optical system having a TTL of 20 mm or more may be reduced.

$$0 < CG 1 / TTL < 0.6 \qquad [ Mathematical Formula 24 ]$$

In Mathematical Formula 24, by setting the center distance CG1 between the first and second lenses relative to the total length (TTL), the effective diameter, radius of curvature, refractive index, Abbe number, etc. of the first and second lenses may be set. Preferably, 0<CG1/TTL<0.5 or 0<CG1/TTL<0.35 may be satisfied.

$$0 < CT 3 / TTL < 0.4 \qquad [ Mathematical Formula 25 ]$$

In Mathematical Formula 25, by setting the center thickness of the third lens 103, 113, and 123 within the above range based on TTL, light incident through the first and second lenses may be refracted to the entire area of the image sensor 300, thereby improving chromatic aberration of the optical system. Preferably, 0.1<CT3/TTL<0.3 may be satisfied.

$$1 < CT 3 / ImgH < 2 \qquad [ Mathematical Formula 25 - 1 ]$$

In Mathematical Formula 25-1, by setting the center thickness of the third lens 103, 113, and 123 relative to ImgH within the above range, changes in optical characteristics due to temperature changes may be reduced.

$$1 < CT 2 / ImgH < 1.5 \qquad [ Mathematical Formula 25 - 2 ]$$

In Mathematical Formula 25-1, by setting the center thickness of the second lens 102, 112, and 122 relative to ImgH within the above range, changes in optical characteristics due to temperature changes may be reduced.

$$0 < \vert L 2 R 1 / L 3 R 2 \vert < 3 \qquad [ Mathematical Formula 26 ]$$

L2R1 represents the radius of curvature of the third surface S3 of the second lens 102, 112, and 122, and L3R2 represents the radius of curvature of the sixth surface S6 of the third lens 103, 113, and 123. In Mathematical Formula 26, by setting the radius of curvature of the object-side surface of the second lens and the sensor-side surface of the third lens, the power of the second and third lenses may be controlled. Accordingly, good optical performance may be achieved at the center and periphery of the field of view. Preferably, the first embodiment may satisfy: 1.7<|L2R1/L3R2|<2.7, and the second and third embodiments may satisfy: 0.5<|L2R1/L3R2|<1.5.

$$1 < L 3 R 1 / CT 3 < 10 \qquad [ Mathematical Formula 27 ]$$

L3R1 represents the radius of curvature of the fifth surface S5 of the third lens 103, 113, and 123. When the optical system satisfies Mathematical Formula 27, the power of the aspherical third lens 103, 113, and 123 may be controlled and assembly degradation may be prevented by setting the radius of curvature and center thickness of the object-side surface of the third lens 103, 113, and 123. Preferably, 1<L3R1/CT3<6 may be satisfied.

$$1 < \vert L 2 R 1 \vert / L 1 R 2 < 10 \qquad [ Mathematical Formula 28 ]$$

L1R2 represents the radius of curvature of the sensor-side surface S2 of the first lens 101, 111, and 121. When the first and second lenses satisfy Mathematical Formula 28, the path of incident light to the second lens 102, 112, and 122 may be controlled by adjusting the exit angle of the sensor-side surface of the first lens 101, 111, and 121. Preferably, 1<|L2R1|/L1R2<6 may be satisfied.

$$0 < \vert L 2 R 2 / L 3 R 1 \vert < 1 \qquad [ Mathematical Formula 29 ]$$

L2R2 and L3R1 may have radii of curvature with opposite signs on the optical axis. For example, the radius of curvature of the sensor-side surface of the second lens 102, 112, and 122 may be negative, while the radius of curvature of the object-side surface of the third lens 103, 113, and 123 may be positive. Accordingly, by setting the radii of curvature of the two lens surfaces facing each other in the second lens group, spherical aberration may be controlled. Preferably, the first embodiment may satisfy: 0<L2R2/L3R1|<0.5, and the second and third embodiments may satisfy: 0.5<|L2R2/L3R1|<1.

$$( Nd 1 * Vd 1 ) < ( Nd 3 * Vd 3 ) \qquad [ Mathematical Formula 30 ]$$

In the optical system, Nd1 and Nd3 are refractive indices of the first and third lenses at the d-line, and Vd1 and Vd3 are Abbe numbers of the first and third lenses. The relationship between the refractive index and Abbe number of the spherical first lens and the refractive index and Abbe number of the aspherical third lens may be set. By setting the refractive index and Abbe number of the aspherical third lens, incident light may be guided to the third lens. Here, the refractive index of each of the first to third lenses may be 1.5 or more and 1.9 or less, for example, less than 1.9.

$$( Nd 1 * Vd 1 ) < ( Nd 2 * Vd 2 ) \qquad [ Mathematical Formula 30 - 1 ]$$

Nd2 is the refractive index of the second lens 102, 112, and 122, and Vd2 is the Abbe number of the second lens. Mathematical Formula 30-1 can establish the relationship between the refractive index and Abbe number of the spherical first lens and the refractive index and Abbe number of the aspherical second lens 102, 112, and 122.

$$0.5 < CT\_Max / CG\_Max < 1.5 \qquad [ Mathematical Formula 31 ]$$

Mathematical Formula 31 can establish the relationship between the maximum center thickness CT_Max among lenses and the maximum center distance CG_Max between adjacent lenses. When Mathematical Formula 31 is satisfied, the optical system can exhibit good optical performance at the focal length and the set field of view, and can reduce the TTL. Preferably, 0.6<CT_Max/CG_Max<1.2 may be satisfied.

$$0.8 < CT\_Max / CT\_Min < 5 \qquad [ Mathematical Formula 32 ]$$

CT_Min is the minimum center thickness of the lenses. Mathematical Formula 32 sets the difference in the center thickness of the lenses to 2 mm or less, thereby improving the assembly of the lenses. Preferably, 1<CT_Max/CT_Min<3.5 may be satisfied.

$$( CT\_Max / CT\_Min ) < ( CA\_Max / CA\_Min ) \qquad [ Mathematical Formula 33 ]$$

CA_Max is the maximum effective diameter of the lens surfaces, and CA_Min is the minimum effective diameter of the lens surfaces. Mathematical Formula 33 sets the difference in the effective diameter of the lens surfaces to be greater than the difference in the center thickness of the lenses, thereby reducing the influence of optical characteristics in optical systems with five or fewer lenses and preventing deterioration in assembly.

$$1 < \sum CT / \sum CG < 5 \qquad [ Mathematical Formula 34 ]$$

In Mathematical Formula 34, ΣCT is the sum of the center thicknesses of the lenses, and ΣCG is the sum of the center distances between adjacent lenses. When Mathematical Formula 34 is satisfied, the optical system can achieve good optical performance at a set focal length and a reduced TTL. Preferably, 1<ΣCT/ΣCG<3 and ΣCT>ΣCG may be satisfied.

$$1 < \sum Nd < 10 \qquad [ Mathematical Formula 35 ]$$

ΣNd represents the sum of the refractive indices of each of the multiple lenses at the d-line. When Mathematical Formula 35 is satisfied, the TTL may be controlled and improved resolution may be achieved in an optical system 1000 comprising a mixture of aspherical and spherical lenses. Furthermore, by arranging spherical and aspherical lenses made of glass with relatively high refractive indices along the optical axis, the number of lenses may be reduced. Mathematical formula 35 preferably satisfies: 3<ΣNd<7.

$$10 < \sum Vd / \sum Nd < 50 \qquad [ Mathematical formula 36 ]$$

ΣVd represents the sum of the Abbe numbers of each of the plurality of lenses. When Mathematical formula 36 is satisfied, the optical system 1000 may have improved aberration characteristics and resolution. In Mathematical formula 36, the optical characteristics may be controlled by setting the Abbe sum and the sum of the refractive indices of the lenses, and preferably satisfies: 15<ΣVd/ΣNd<40.

$$1 < CA 11 / CA\_Min < 6 \qquad [ Mathematical formula 37 ]$$

CA11 represents the effective diameter of the object-side surface of the first lens 101, 111, and 121. When Mathematical formula 37 is satisfied, the optical system can control incident light, maintain optical performance, and provide a slimmer module. Mathematical formula 37 preferably satisfies: 2<CA11/CA_Min<5. Furthermore, CA11 may be CA_Max.

$$0.4 < CA\_ST / CA 21 < 1.4 \qquad [ Mathematical formula 38 ]$$

CA_ST is the effective diameter of the aperture stop ST. Mathematical formula 38 may set the effective diameter of the aperture stop ST and the effective diameter of the incident surface of the second lens 102, 112, and 122. Accordingly, the amount of light incident on the second lens 102, 112, and 122 through the aperture stop ST may be controlled. Preferably, 0.5<CA_ST/CA21<1 may be satisfied.

$$0.5 < CA\_ST / CA 12 < 1.5 \qquad [ Mathematical Formula 39 ]$$

Mathematical Formula 39 can establish a relationship between the effective diameter of the aperture stop ST and the effective diameter of the sensor-side surface of the first lens 101, 111, and 121. Accordingly, the aperture stop ST can control the amount of light passing through the sensor-side surface of the first lens to the second lens 102, 112, and 122. Preferably, 0.5<CA_ST/CA12<1 may be satisfied.

$$2 < CA 11 / CA\_ST < 6 \qquad [ Mathematical Formula 40 ]$$

Mathematical Formula 40 can establish a relationship between the effective diameter of the aperture stop ST and the effective diameter of the object-side surface of the first lens 101, 111, and 121. Accordingly, the aperture stop ST can control the amount of light passing through the first lens to the second lens 102, 112, and 122. Preferably, 2<CA11/CA_ST<4.5 may be satisfied.

$$1 < CA\_Max / ( 2 * ImgH ) < 3.5 \qquad [ Mathematical Formula 41 ]$$

Mathematical Formula 41 may be set by the maximum effective diameter CA_Max of the lens surfaces and the diagonal length of the image sensor. If this is satisfied, the optical system can maintain good optical performance and be sized for a slim and compact structure. Preferably, 1.5<CA_Max/(2*ImgH)<3 may be satisfied.

$$1 < TD / CA\_Max < 3 \qquad [ Mathematical Formula 42 ]$$

TD is the optical axis distance from the center of the object-side surface of the first lens 101, 111, and 121 to the center of the sensor-side surface of the third and last lens 103, 113, and 123. Specifically, TD is the maximum optical axis distance of the lenses. If Mathematical Formula 42 is satisfied, the total optical axis distance of the lenses and the maximum effective diameter of the lens surfaces may be set, thereby sizing the system for good optical performance. Mathematical Formula 42 preferably satisfies: 1<TD/CA_Max<1.5.

$$TD > S D \qquad [ Mathematical Formula 42 - 1 ]$$

The SD is the optical axis distance from the position of the aperture stop ST to the center of the sensor-side surface of the last lens. This means that the aperture stop ST may be disposed closer to the object-side surface of the second lens 102, 112, and 122 than to the sensor-side surface of the first lens 101, 111, and 121.

$$0 < CT\_Max / TD < 0.7 \qquad [ Mathematical Formula 43 ]$$

Mathematical Formula 43 allows for setting the maximum center thickness and maximum optical axis distance (TD) of the lenses, thereby improving optical performance. Preferably, 0.1<CT_Max/TD<0.5 may be satisfied.

$$0 < F / CA 31 < 0.5 \qquad [ Mathematical Formula 44 ]$$

F represents the effective focal length (EFL) of the optical system and may be 10 mm or less, for example, in the range of 1 mm to 10 mm or 1 mm to 6 mm. In Mathematical Formula 44, the relationship between the effective focal length and the effective diameter of the object-side surface of the last aspherical lens is set, thereby controlling the influence on optical system reduction, for example, TTL. Mathematical Formula 44 preferably satisfies 0<F/CA31<0.2.

$$0 < F / L 1 R 1 < 0.3 \qquad [ Mathematical Formula 45 ]$$

In Mathematical Formula 44, the effective focal length of the optical system and the radius of curvature of the object-side surface of the first lens are set, thereby controlling the influence on incident light and TTL. Mathematical Formula 45 preferably satisfies 0<F/L1R1<0.2.

$$1 < Max ( CT / ET ) < 3 \qquad [ Mathematical Formula 46 ]$$

Max(CT/ET) represents the maximum value of the ratio of the center thickness to the edge thickness of each lens. When Mathematical Formula 46 is satisfied, the optical system can control the influence on the effective focal length and improve assembly. Mathematical Formula 46 preferably satisfies: 1.2<Max(CT/ET)<2.5.

$$0 < EPD / L 1 R 1 < 1 \qquad [ Mathematical Formula 47 ]$$

EPD refers to the size (mm) of the entrance pupil diameter of the optical system 1000. When the optical system 1000 according to the embodiment satisfies Mathematical Formula 47, the optical system 1000 can control incident light. Mathematical Formula 47 preferably satisfies: 0<EPD/L1R1<0.5. Furthermore, EPD<BFL may be satisfied.

$$0 \text{.5} < \vert F 1 / F 3 \vert < 1.5 \qquad [ Mathematical Formula 48 ]$$

F1 is the focal length of the first lens, and F3 is the focal length of the third lens. When Mathematical Formula 48 is satisfied, the resolution may be improved by controlling the power of the first and third lenses, and the TTL and effective focal length F may be affected. Preferably, 0.5<| F1/F3|<1.2 may be satisfied. Accordingly, by controlling the power of each lens, light may be effectively guided to the aspherical lens. The composite focal length F23 of the second and third lenses may have positive power. That is, the composite focal length F23 of the two lenses positioned closer to the sensor than the aperture stop ST is designed to be greater than 0. In this case, the optical system may be miniaturized by reducing the TTL at 90 degrees or more of the horizontal field of view (FOV_H).

$$P o 2 * Po 3 > 0 \qquad [ Mathematical Formula 49 ]$$

Po2 is the power of the second lens, and Po3 is the power of the third lens. In other words, the powers of the second and third lenses are equal, which improves aberrations and effectively guides light through the aspherical lens.

$$1 < Vd 3 - Vd 1 < 20 \qquad [ Mathematical Formula 50 ]$$

In Mathematical Formula 50, Vd1 is the Abbe number of the first lens, and Vd3 is the Abbe number of the third lens. When Mathematical Formula 50 is satisfied, the difference in Abbe numbers between the spherical lens and the aspherical lens may be maintained within a certain value, thereby improving chromatic aberration. Mathematical Formula 50 preferably satisfies: Vd1<Vd3. The first and third embodiments satisfy: 1<Vd3−Vd1<10, and the second embodiment may satisfy: 10<Vd3−Vd1<20.

$$0 < \vert F 1 / F 23 \vert < 2 \qquad [ Mathematical Formula 51 ]$$

In mathematical formula 51, by setting the relationship between the focal length F1 of the first lens and the composite focal length F23 of the second and third lenses, the power of the lenses may be controlled to improve resolution, and the optical system may be provided in a slim and compact size. In mathematical formula 51, the first embodiment may satisfy: 0.2<F1/F23<0.8, and the second and third embodiments may satisfy: 1<F1/F23<2.

$$20 mm < TTL < 40 mm \qquad [ Mathematical Formula 52 ]$$

TTL (Total track length) refers to the distance (mm) from the center of the first surface S1 of the first lens 101, 111, and 121 to the surface of the image sensor 300 along the optical axis OA. In Mathematical Formula 52, by setting the TTL to less than 40 mm, a miniaturized vehicle optical system may be provided. Preferably, the condition may satisfy: 23 mm<TTL<37 mm.

$$2 mm < Img H \qquad [ Mathematical Formula 53 ]$$

Mathematical Formula 53 may set the diagonal length of the image sensor 300 to half, providing an optical system having a vehicle sensor size. Mathematical Formula 53 preferably satisfies the condition: 3 mm<ImgH<5 mm.

$$3 mm < BFL < 10 mm \qquad [ Mathematical Formula 54 ]$$

In Mathematical Formula 54, the BFL is set to less than 10 mm to secure installation space for the optical filter 500 or cover glass, improve the assemblability of components through the gap between the image sensor 300 and the last lens, and enhance joint reliability. Mathematical Formula 54 preferably satisfies: 4 mm<BFL<9 mm. If the BFL is less than the range of Mathematical Formula 54, some of the light traveling to the image sensor may not be transmitted to the image sensor, which may cause resolution degradation. If the BFL exceeds the range of Mathematical Formula 54, stray light may be introduced, degrading the aberration characteristics of the optical system.

$$0.5 < BFL / CG 1 < 1.5 \qquad [ Mathematical Formula 55 ]$$

In Mathematical Formula 55, by setting the center distance CG1 between the BFL and the first and second lenses, the installation space for optical filters, cover glasses, etc., and the distance between the glass lenses may be adjusted to improve the joint reliability of the components. In Mathematical Formula 55, 0.8<BFL/CG1<1.5 may be satisfied. The center distance CG1 between the first and second lenses may be the largest among the center distances between the lenses.

$$0 < CT 1 / BFL < 1.5 \qquad [ Mathematical Formula 56 ]$$

In Mathematical Formula 56, by setting the BFL to be greater than the center thickness of the first lens 101, 111, and 121, the installation space for optical filters, cover glasses, etc. may be secured, and the distance between the image sensor 300 and the last lens may be adjusted to improve the assembly reliability of the components and the joint reliability. If the BFL does not satisfy Mathematical Formula 56, some of the emitted light may not be transmitted to the effective area of the image sensor, thereby degrading the resolution. Preferably, the first embodiment satisfies: 0.7<CT1/BFL<1.2, and the second and third embodiments satisfies: 0<CT1/BFL<0.5.

$$1 < BFL / CT 2 < 2 \qquad [ Mathematical Formula 56 - 1 ]$$

Mathematical Formula 56-1 may set the distance between the image sensor 300 and the last lens and the center thickness of the second lens.

$$2 mm < F < 8 mm \qquad [ Mathematical Formula 57 ]$$

Mathematical Formula 57 may set the overall effective focal length F to suit the vehicle optical system. Mathematical Formula 57 may satisfy the ranges: 2 mm<F<6 mm or 2 mm<F<5 mm.

$$80 degrees < FOV < 150 degrees \qquad [ Mathematical Formula 58 ]$$

In Mathematical Formula 58, FOV (Field of View) refers to the diagonal field of view (Degree) of the optical system 1000, and a vehicle optical system having a field of view exceeding 80 degrees may be provided. Preferably, 90 degrees<FOV<135 degrees may be satisfied. The FOV may be a minimum value for the reception performance range. Here, the horizontal field of view of the optical system 1000 may be smaller than the diagonal field of view and may be larger than 90 degrees, and the vertical field of view may be smaller than the horizontal field of view and may be larger than 70 degrees.

$$400 < FOV * F < 550 \qquad [ Mathematical Formula 58 - 1 ]$$

Mathematical Formula 58-1 sets the product of the diagonal field of view and the effective focal length of the optical system to be greater than 450, thereby achieving a wide field of view and a small effective focal length.

$$1 < TTL / CA\_Max < 3 \qquad [ Mathematical Formula 59 ]$$

CA_Max refers to the largest effective diameter (mm) among the object-side and sensor-side surfaces of the plurality of lenses. Mathematical Formula 59 establishes the relationship between the total optical axis length of the optical system and the maximum effective diameter, thereby providing an improved vehicle optical system. Mathematical Formula 59 preferably satisfies: 1.2<TTL/CA_Max<2.5. Here, CA_Max is the effective diameter of the object-side surface of the first lens.

$$5 < TTL / ImgH < 10 \qquad [ Mathematical Formula 60 ]$$

Mathematical Formula 60 may set the total optical axis length (TTL) of the optical system and the diagonal length (ImgH) from the optical axis of the image sensor 300. If the optical system 1000 according to the embodiment satisfies Mathematical Formula 60, the optical system 1000 may have a TTL for application to the vehicle image sensor 300, thereby providing improved image quality. Mathematical Formula 60 preferably satisfies: 6<TTL/ImgH<9.

$$1 < BFL / ImgH < 3 \qquad [ Mathematical Formula 61 ]$$

Mathematical Formula 61 may set the relationship between the optical axis distance (BFL) between the image sensor 300 and the last lens and the diagonal length from the optical axis of the image sensor 300. When the optical system 1000 according to the embodiment satisfies Mathematical Formula 61, the optical system 1000 can secure a BFL suitable for the size of the vehicle image sensor 300, set the distance between the last lens and the image sensor 300, and achieve good optical characteristics at the center and periphery of the FOV. Mathematical Formula 61 preferably satisfies the conditions: 1.2<BFL/ImgH<2.5, and BFL>ImgH.

$$1 < T T L / B FL < 10 \qquad [ Mathematical Formula 62 ]$$

Mathematical Formula 62 may set the total optical axis length (TTL) of the optical system and the optical axis distance (BFL) between the image sensor 300 and the last lens. When the optical system 1000 according to the embodiment satisfies Mathematical Formula 62, the optical system 1000 can secure a BFL. That is, by setting the TTL to less than 40 mm, a sufficient BFL may be secured to provide an optical system for a vehicle. Mathematical formula 62 preferably satisfies: 3<TTL/BFL<8.

$$5 < T T L / F < 15 \qquad [ Mathematical formula 63 ]$$

Mathematical formula 63 may set the overall focal length (F) and overall optical axis length (TTL) of the optical system 1000. Accordingly, an optical system for a driver assistance system or driver monitoring may be provided. Mathematical formula 63 preferably satisfies: 5<TTL/F<10. When the optical system 1000 according to the embodiment satisfies Mathematical formula 63, the optical system 1000 may have an appropriate focal length within the set TTL range, and can provide an optical system that maintains an appropriate focal length and can form an image even when the temperature changes from low to high temperatures. If it is below the lower limit of Mathematical Formula 63, the power of the lenses must be increased, making correction of spherical aberration or distortion difficult. If it exceeds the upper limit of Mathematical Formula 63, the effective diameter or TTL of the lenses may become longer, which may lead to a problem of the imaging lens system becoming larger.

$$0 < F / B F L < 2 \qquad [ Mathematical Formula 64 ]$$

Mathematical Formula 64 may set the overall effective focal length (F) of the optical system 1000 and the optical axis distance (BFL) between the image sensor 300 and the last lens. If the optical system 1000 according to the embodiment satisfies Mathematical Formula 64, the optical system 1000 may have a set field of view and an appropriate focal length, and may be provided as an optical system for a vehicle. In addition, the optical system 1000 can minimize the distance between the last lens and the image sensor 300, thereby providing excellent optical characteristics at the periphery of the FOV. Mathematical formula (64) preferably satisfies: 0.3<F/BFL<1.

$$0 < F / ImgH < 2 \qquad [ Mathematical formula 65 ]$$

Mathematical formula 65 may set the overall effective focal length (F) of the optical system 1000 and a value (ImgH) equal to half the diagonal length of the image sensor 300. This optical system 1000 may have improved aberration characteristics for the size of the vehicle image sensor 300. Mathematical formula S6 preferably satisfies: 0.5<F/ImgH<1.

$$0 < F / E P D < 2 \qquad [ Mathematical formula 66 ]$$

Mathematical formula 66 may set the overall effective focal length (F) and the entrance pupil size of the optical system 1000. Accordingly, the overall brightness of the optical system may be controlled. Mathematical formula 66 can preferably set: 1<F/EPD<1.5.

$$0 < B F L / T D < 0.5 \qquad [ Mathematical formula 67 ]$$

Mathematical formula 67 may set the relationship between the optical axis distance (TD) and the back focal distance (BFL) of the lenses of the optical system 1000. Accordingly, the resolution of the optical system may be maintained while the overall size may be controlled. Mathematical formula 67 can preferably satisfy: 0.1<BFL/TD<0.4. If the conditional value of BFL/TD exceeds 0.5, the BFL is designed to be large compared to the TD, so the size of the entire optical system increases, making it difficult to miniaturize the optical system. In addition, the distance between the third lens and the image sensor increases, which can increase the amount of unnecessary light passing through the third lens and the image sensor, resulting in a problem of lowering the resolution, such as deteriorating aberration characteristics.

$$0 < EPD / ImgH / FOV < 0.2 \qquad [ Mathematical Formula 68 ]$$

Mathematical Formula 68 may set the relationship between the entrance pupil diameter (EPD), the length of the image sensor's diagonal length (ImgH), and the diagonal field of view. Accordingly, the overall size and brightness of the optical system may be controlled. Mathematical Formula 68 preferably satisfies: 0<EPD/ImgH/FOV<0.05.

$$50 < F O V / F \# \qquad [ Mathematical Formula 69 ]$$

Mathematical Formula 69 may set the relationship between the diagonal field of view and the F number of the optical system. Mathematical Formula 69 preferably satisfies: 70<FOV/F #. Here, F # is set to 2.0 or less, thereby providing a bright image.

$$70 < TTL * nL < 110 \qquad [ Mathematical Formula 70 ]$$

Mathematical Formula 70 may set the number of lenses by multiplying the total length of the optical system by the total number nL of lenses. Preferably, mathematical formula 70 satisfies: 80<TTL*nL<100. Color dispersion and refraction angles may be controlled by glass lenses in an optical system with a TTL of less than 40 mm.

$$70 < TTL * nGL < 110 \qquad [ Mathematical Formula 70 - 1 ]$$

Mathematical Formula 72 may set the number of TTL and glass lenses (nGL), and can control color dispersion and refraction angles by glass lenses in an optical system with a TTL of less than 40 mm.

$$8 < ImgH * nL < 15 \qquad [ Mathematical Formula 71 ]$$

Mathematical Formula 71 is a value obtained by multiplying half the diagonal length of the image sensor by the number nL of lenses. This value may set the length of the image sensor according to the number of lenses. Preferably, mathematical formula 71 satisfies: 10<ImgH*nL<14. Color dispersion and refraction angles may be controlled by glass lenses in an optical system with an ImgH of less than 5 mm.

$$0 < N ss / Nass < 1 \qquad [ Mathematical Formula 72 ]$$

Mathematical Formula 72 may set the number of spherical surfaces Nss and aspherical surfaces Nass among the lens surfaces. When mathematical formula 73 is satisfied, light may be guided to the entire area of the image sensor by adjusting the spherical and aspherical lens surfaces of the lenses.

$$[ Mathematical Formula 73 ]$$

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} +$$

In Mathematical Formula 74, Z represents Sag, which may refer to the distance along the optical axis from an arbitrary location on the aspherical surface to the vertex of the aspherical surface. Y may refer to the distance from an arbitrary location on the aspherical surface to the optical axis in a direction perpendicular to the optical axis. c may refer to the curvature of the lens, and K may refer to the conic constant. Additionally, A, B, C, D, E, and F may refer to aspheric coefficients.

The optical system 1000 according to the embodiments may satisfy at least one or two or more of the Mathematical Formulas 1 to 36. At least one or two or more of the Mathematical Formulas 1 to 46 may satisfy at least one or two or more of the Mathematical Formulas 37 to 72. In this case, the optical system 1000 may have improved optical characteristics. Specifically, when the optical system 1000 satisfies at least one of the Mathematical Formulas 1 to 36 and/or at least one of the Mathematical Formulas 37 to 72, the optical system 1000 may have improved resolution and may improve aberration and distortion characteristics. In addition, the optical system 1000 may secure a BFL for applying a vehicle image sensor 300, compensate for optical characteristic degradation due to temperature changes, and minimize the distance between the last lens and the image sensor 300, thereby providing good optical performance at the center and periphery of the FOV.

Table 1 shows the items of the mathematical formulas described above in the optical system 1000 of the embodiment, including the TTL, BFL, effective focal length F, ImgH, effective diameter (CA), thickness, TD which is the optical axis distance from the first surface S1 to the eighth surface S8, the focal lengths F1, F2, and F3 of each of the first to third lenses, the sum of the refractive indices, the sum of the Abbe numbers, the sum of the center thicknesses of each lens, the sum of the distances between adjacent lenses, the diagonal FOV (Degree), the edge thickness (ET), the focal lengths of the first and second lens groups, and the F number, etc. of the optical system 1000.

TABLE 1

| Items | Embodiment 1 | Embodiment 2 | Embodiment 3 |
|---|---|---|---|
| F | 3.878 | 3.913 | 3.939 |
| F1 | −8.662 | −8.723 | −9.911 |
| F2 | 11.149 | 47.220 | 26.726 |
| F3 | 9.383 | 8.299 | 9.085 |
| FLG1 | −8.662 | −8.723 | −9.911 |
| FLG2 | 15.252 | 6.425 | 6.425 |
| ΣNd | 5.238 | 5.416 | 5.185 |
| ΣVd | 118.287 | 107.156 | 168.977 |
| ΣCT | 16.831 | 13.237 | 13.052 |
| ΣCG | 6.469 | 8.054 | 8.953 |
| ΣET | 16.114 | 9.996 | 9.903 |
| ET1 | 8.282 | 3.202 | 3.471 |
| ET2 | 4.500 | 4.103 | 3.563 |
| ET3 | 3.333 | 2.691 | 2.869 |
| F number | 1.10 | 1.100 | 1.100 |
| FOV (Diagonal) | 123.7491 | 126.983 | 128.530 |
| EPD | 3.5254 | 3.557 | 3.581 |
| BFL | 6.6672 | 8.709 | 7.995 |
| TD | 23.2994 | 21.291 | 22.005 |
| ImgH | 4.0000 | 4.000 | 4.000 |
| SD | 12.6273 | 13.993 | 14.055 |
| TTL | 29.967 | 30.000 | 30.000 |

Table 2 shows the results for the mathematical fomulas 1 to 36 described above in the optical system 1000 of the embodiment. Referring to Table 2, it may be seen that the optical system 1000 satisfies at least one, two, or three or more of the mathematical formulas 1 to 36. Accordingly, the optical system 1000 may have good optical performance and superior optical characteristics at the center and periphery of the FOV.

TABLE 2

| Mathematical formulas | | Embodiment 1 | Embodiment 2 | Embodiment 3 |
|---|---|---|---|---|
| 1 | 0 < CT1/CT2 < 3 | 1.229 | 0.382 | 0.400 |
| 2 | 0.5 < CG1/CT1 < 5 | 0.967 | 3.323 | 3.888 |
| 3 | Pol < 0 | Satisfaction | Satisfaction | Satisfaction |
| 4 | 1.75 < Nd3 < 2.2 | 1.809 | 1.806 | 1.790 |
| 5 | L1R1 > 0 | 21.998 | 20.452 | 23.042 |
| 6 | L1R1/L1R2 > \|L2R1/L2R2\| | Satisfaction | Satisfaction | Satisfaction |
| 7 | 0 < CG1/BFL < 1 | 0.870 | 0.763 | 0.973 |
| 8 | 1 < CA11/CA12 < 4 | 2.864 | 1.715 | 1.837 |
| 9 | 0 < (CA12*CT1)/(CA21*CT2) < 2 | 1.430 | 0.507 | 0.494 |
| 10 | 0.1 < CT1/(CT2 + CT3) < 1 | 0.554 | 0.178 | 0.181 |
| 11 | 0.5 < CT2/CT3 < 1.5 | 0.821 | 0.873 | 0.826 |
| 12 | 0.5 < CA11/CA31 < 3 | 1.733 | 1.081 | 1.147 |
| 13 | 1 < CA2/CT2 < 5 | 1.618 | 1.623 | 1.766 |
| 14 | 0.5 < CA22/CA31 < 1.5 | 0.797 | 0.775 | 0.793 |
| 15 | 3 < CT2/CG2 < 10 | 7.296 | 3.716 | 4.247 |
| 16 | 3 < CT3/CG2 < 11 | 8.886 | 4.258 | 5.140 |
| 17 | 0.1 < Max_Sag11/Max_Sag12 < 1.5 | 1.007 | 0.562 | 0.499 |
| 18 | 1 < CG1/Max_Sag12 < 3 | 2.235 | 2.770 | 2.852 |
| 19 | 1 < \|Max_Sag32/Max_Sag31\| < 5 | 2.549 | 1.632 | 1.525 |
| 20 | \|Max_Sag22\| > \|Max_Sag31\| | Satisfaction | Satisfaction | Satisfaction |
| 21 | CA2/(ImgH*2) < CA3/(ImgH*2) | Satisfaction | Satisfaction | Satisfaction |
| 22 | (ImgH*2) < CA22 < CA11 | Satisfaction | Satisfaction | Satisfaction |
| 23 | 0 < DLG1/DLG2 < 1 | 0.522 | 0.158 | 0.164 |
| 24 | 0 < CG1/TTL < 0.6 | 0.194 | 0.222 | 0.259 |
| 25 | 0 < CT3/TTL < 0.4 | 0.198 | 0.200 | 0.202 |
| 26 | 0 < \|L2R1/L3R2\| < 3 | 2.227 | 1.149 | 0.925 |
| 27 | 1 < L3R1/CT3 < 10 | 5.027 | 2.134 | 2.192 |
| 28 | 1 < \|L2R1\|/L1R2 < 10 | 5.280 | 2.493 | 2.514 |
| 29 | 0 < \|L2R2/L3R1\| < 1 | 0.227 | 0.851 | 0.671 |
| 30 | (Nd1*Vd1) < (Nd3*Vd3) | Satisfaction | Satisfaction | Satisfaction |
| 31 | 0.5 < CT_Max/CG_Max < 1.5 | 1.035 | 0.903 | 0.778 |
| 32 | 0.8 < CT_Max/CT_Min < 5 | 1.229 | 3.000 | 3.026 |
| 33 | (CT_Max/CT_Min) < (CA_Max/CA_Min) | Satisfaction | Satisfaction | Satisfaction |
| 34 | 1 < ΣCT/ΣCG < 5 | 2.602 | 1.643 | 1.458 |
| 35 | 1 < ΣNd < 10 | 5.238 | 5.416 | 5.185 |
| 36 | 10 < ΣVd/ΣNd < 50 | 22.584 | 19.784 | 32.591 |

Table 3 shows the results for the mathematical formulas 37 to 72 described above in the optical system 1000 of the embodiment. Referring to Table 5, it may be seen that the optical system 1000 satisfies at least one, two, or three of the mathematical formulas 37 to 72. Accordingly, the optical system 1000 may have good optical performance and superior optical characteristics at the center and periphery of the FOV.

TABLE 3

| Mathematical formulas | | Embodiment 1 | Embodiment 2 | Embodiment 3 |
|---|---|---|---|---|
| 37 | 1 < CA11/CA_Min < 6 | 3.335 | 2.277 | 2.267 |
| 38 | 0.4 < CA_ST/CA21 < 1.4 | 0.847 | 0.890 | 0.844 |
| 39 | 0.5 < CA_ST/CA12 < 1.5 | 0.728 | 0.670 | 0.684 |
| 40 | 2 < CA11/CA_ST < 6 | 3.935 | 2.559 | 2.686 |
| 41 | 1 < CA_Max/(2*ImgH) < 3.5 | 2.600 | 1.838 | 1.950 |
| 42 | 1 < TD/CA_Max < 3 | 1.120 | 1.448 | 1.411 |
| 43 | 0 < CT_Max/TD < 0.7 | 0.258 | 0.282 | 0.275 |
| 44 | 0 < F/CA31 < 0.5 | 0.092 | 0.081 | 0.081 |
| 45 | 0 < F/L1R1 < 0.3 | 0.050 | 0.054 | 0.048 |
| 46 | 1 < Max (CT/ET) < 3 | 1.784 | 2.229 | 2.109 |
| 47 | 0 < EPD/L1R1 < 1 | 0.160 | 0.174 | 0.155 |
| 48 | 0.5 < \|F1/F3\| < 1.5 | 0.923 | 1.051 | 1.091 |
| 49 | Po2 * Po3 > 0 | Satisfaction | Satisfaction | Satisfaction |
| 50 | 1 < Vd3 − Vd1 < 20 | 4.624 | 15.394 | 4.799 |
| 51 | 0 < \|F1/F23\| < 2 | 0.568 | 1.358 | 1.543 |
| 52 | 20 < TTL < 40 | 29.967 | 30.000 | 30.000 |
| 53 | 2 < ImgH | 4.000 | 4.000 | 4.000 |
| 54 | 3 < BFL < 10 | 6.667 | 8.709 | 7.995 |
| 55 | 0.5 < BFL/CG1 < 1.5 | 1.150 | 1.311 | 1.028 |
| 56 | 0 < CT1/BFL < 1.5 | 0.900 | 0.230 | 0.250 |
| 57 | 2 < F < 8 | 3.878 | 3.913 | 3.939 |
| 58 | 80 < FOV < 150 | 123.75 | 126.98 | 128.53 |
| 59 | 1 < TTL/CA_Max < 3 | 1.441 | 2.041 | 1.923 |
| 60 | 5 < TTL/ImgH < 10 | 7.492 | 7.500 | 7.500 |
| 61 | 1 < BFL/ImgH < 3 | 1.667 | 2.177 | 1.999 |
| 62 | 1 < TTL/BFL < 10 | 4.495 | 3.445 | 3.752 |
| 63 | 5 < TTL/F < 15 | 7.727 | 7.667 | 7.617 |
| 64 | 0 < F/BFL < 2 | 0.582 | 0.449 | 0.493 |
| 65 | 0 < F/ImgH < 2 | 0.970 | 0.978 | 0.985 |
| 66 | 0 < F/EPD < 2 | 1.100 | 1.100 | 1.100 |
| 67 | 0 < BFL/TD < 0.5 | 0.286 | 0.409 | 0.363 |
| 68 | 0 < EPD/ImgH/FOV < 0.2 | 0.009 | 0.009 | 0.0087 |
| 69 | 50 < FOV/F# | 112.499 | 115.439 | 116.846 |
| 70 | 70 < TTL*nL < 110 | 89.900 | 90.000 | 90.000 |
| 71 | 8 < ImgH*nL < 15 | 12.000 | 12.000 | 12.000 |
| 72 | 0 < Nss/Nass < 1 | 0.5 | 0.5 | 0.5 |

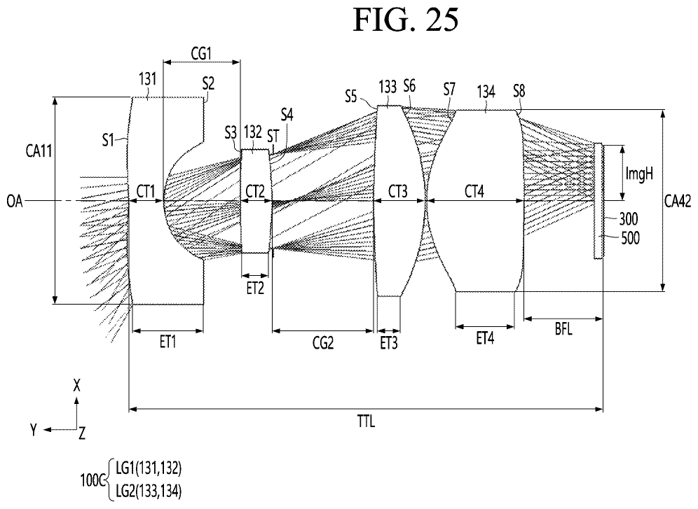

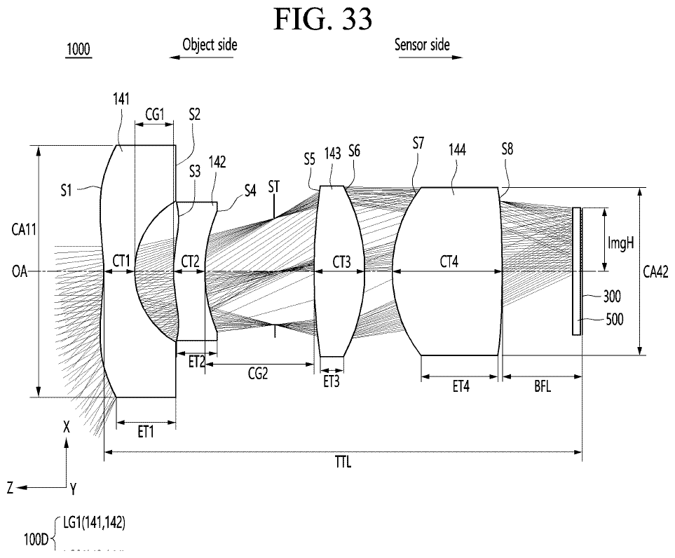

FIGS. 25 to 32 are drawings showing an optical system and a camera module according to a fourth embodiment, and FIGS. 33 to 40 are drawings showing an optical system and a camera module according to a fifth embodiment. The fourth and fifth embodiments are optical systems having different numbers of lenses from the first to third embodiments.

As shown in FIGS. 25 and 33, the optical system 1000 according to the fourth and fifth embodiments of the invention includes first and second lens groups LG1 and LG2, and the numbers of lenses of each of the first lens group LG1 and the second lens group LG2 may be the same. The number of lenses of the first lens group LG1 or the second lens group LG2 may be one or two or more. The optical axis distance of the first lens group LG1 may be greater than the optical axis distance of the second lens group LG2. The optical axis distance of the first lens group LG1 is the optical axis distance from the object-side surface S1 to the sensor-side surface S4. The optical axis distance of the second lens group LG2 is the optical axis distance between the object-side surface S5 of the lens 133 closest to the object side of the second lens group LG2 and the sensor-side surface S8 of the lens 134 closest to the image sensor 300. The optical axis distance of the first lens group LG1 is the optical axis distance from the first surface S1 to the fourth surface S4, and the optical axis distance of the second lens group LG2 is the optical axis distance from the fifth surface S5 to the eighth surface S8. The first lens group LG1 may have two or fewer lenses, for example, two lenses. The second lens group LG2 may include two or more lenses, for example, two lenses. The optical system 1000 may include n lenses, with the n-th lens being closest to the image sensor 300, and the n−1th lens being closest to the n-th lens. “n” is an integer less than or equal to 5, for example, 4.

The optical system 1000 may include plastic lenses and glass lenses. The number of glass lenses in the optical system 1000 may be equal to or less than the number of plastic lenses. The first lens group LG1 may include at least one plastic lens. The second lens group LG2 may include at least one plastic lens. The second lens group LG2 may include at least one glass lens. The n-2th lens may be made of glass or plastic material. The n−1th lens may be made of glass material. This glass material exhibits minimal expansion and contraction changes due to changes in external temperature and can reduce the optical impact on other lenses. The plastic lens may have aspherical lens surfaces on the optical axis. The glass lens may have spherical lens surfaces on the optical axis. As another example, the glass lens may have aspherical lens surfaces. The number of spherical lenses may be less than or equal to the number of aspherical lenses, and the spherical lenses may improve assembly with the lens barrel.

The second lens group LG2 may include at least one spherical lens and at least one aspherical lens. The optical system 1000 may include an aspherical lens closest to the object and an aspherical lens closest to the image sensor 300. The lens closest to the image sensor 300 may be provided as an aspherical lens to prevent degradation of optical performance. The aspherical lens can prevent spherical aberration within the optical system 1000 and suppress aberration even when the effective diameter increases, thereby improving the miniaturization and weight reduction of the camera module. The optical system 1000 utilizes a mixture of spherical and aspherical lenses to enable thermal compensation within the lens barrel and suppress degradation of optical characteristics due to temperature changes.

The lenses of the optical system 1000 may have an Abbe number in the range of 10 to 50, and a refractive index in the range of 1.5 to 2.2. The Abbe number and refractive index can control chromatic dispersion by the lenses. Here, the glass lens may have a higher refractive index than the plastic lens, and the Abbe number of the glass lens may be higher than that of the plastic lens. The refractive index of the i-th lens is Ndi, and the Abbe number of the i-th lens is Adi. A value of Ndi*Adi of 40 or greater indicates a glass lens, while a value of Ndi*Adi of less than 40 indicates a plastic lens. Here, * indicates multiplication.

Within the lens unit 100C and 100D, the lens surface with the largest effective diameter is an aspherical lens and may be disposed closest to the object. The lens surface with the largest effective diameter refracts incident light across the entire area, improving incident light efficiency. Furthermore, the lens surface S1 with the largest effective diameter is closest to the object and is an aspherical surface. Within the lens unit 100C and 100D, the first lens 131 and 141 may have the largest difference in effective diameter between the object-side surface and the sensor-side surface. The lens 132 and 142 with the smallest effective diameter is a spherical lens or an aspherical lens. A lens 132 and 142 having a minimum effective diameter may be disposed on the object side of an aperture stop ST disposed between the lenses. The first lens group LG1 may include a lens having a lens surface with a maximum effective diameter and a lens having a minimum effective diameter. The lens closest to the image sensor 300 may be an aspherical lens and made of plastic material. An embodiment of the invention can reduce the weight of the camera module, provide a more cost-effective manufacturing method, and suppress degradation of optical characteristics due to temperature changes by combining spherical and aspherical lenses within the optical system 1000.

When the effective diameter of the object-side surface of the i-th lens is defined as CAi1, the effective diameter of the sensor-side surface of the i-th lens is defined as CAi2, and the average effective diameter of the i-th lenses is defined as CAi, the condition: |CAi1−CAi2|*CAi is maximum when i is 1 and minimum when i is 2 or 3. Also, when i=2, 3, the condition: 1<|CAi1−CAi2|*CAi<14 may be satisfied. When i=1, the condition: 50<|CAi1−CAi2| *CAi<120 may be satisfied. Therefore, a lens with a minimum effective diameter may be disposed between the lenses and disposed on the object side of the aperture stop ST. The lens 132 and 142 with such a minimum effective diameter can control the path of light incident through the lens surface S1 with the maximum effective diameter.

Within the optical system 1000, the TTL (Total top length) may be greater than 5 times the ImgH, for example, greater than 5 times and less than 10 times. Preferably, the condition: 5<TTL/ImgH<10 may be satisfied. The TTL is the optical axis distance from the center of the object-side surface of the first lens 131 to the surface of the image sensor 300. The ImgH is the distance from the optical axis to the end of the effective area of the image sensor 300 in the diagonal direction. The ImgH is half the maximum diagonal length of the effective area of the image sensor 300.

The optical system 1000 can provide an effective focal length (EFL) of 10 mm or less and an FOV of over 80 degrees, and may be provided as a standard optical system in a vehicle camera module. That is, the optical system 1000 may have a wide field of view and reduce the focal length to 10 mm or less. For example, the optical system and camera module according to the embodiment may be applied to a camera module for a LiDAR system installed in a vehicle. For example, light transmitted by a transmission module of the camera system is reflected by an object, and the camera module receives the reflected light. Such a camera module for lidar may be selectively applied to devices such as a collision warning avoidance system, a blind spot monitor, a lane keeping assist, a lane departure warning, and an adaptive cruise control, and can provide functions that assist drivers and make autonomous driving safer and more comfortable. The optical system 1000 may have a value of TTL/(2*ImgH) greater than 2.5, for example, greater than 2.5 and less than 5. By setting the value of TTL/(2*ImgH) to greater than 2.5, the optical system 1000 can provide an optical system for driver assistance. The total number of lenses of the first and second lens groups LG1 and LG2 is 5 or less or 4 or less. Accordingly, the optical system 1000 can provide an image without exaggeration or distortion with respect to the formed image.

The number of lenses having an effective diameter larger than the diagonal length of the image sensor 300 within the optical system 1000 may be 1 or less or less than 1. The diagonal length of the image sensor 300 may be smaller than the effective diameters of the plastic lenses. The diagonal length of the image sensor 300 may be smaller than the diameter of the lens. The diagonal length of the image sensor 300 may be in the range of 80% to 120% of the minimum effective diameters of the lenses. The sensor-side surface of the first lens 131 and 141 closest to the object side within the lens unit 100C and 100D may have an effective diameter smaller than the effective diameter of the sensor-side surface of the last lens. Accordingly, the center thickness of the first lens 131 and 141 of the optical system 1000 may be provided to be thinner than the center thickness of the last lens, and the refractive angle and chromatic dispersion of the first lens 131 and 141 may be adjusted. Accordingly, it is possible to compensate for the degradation of optical characteristics due to resolution and temperature changes within the optical system 1000, improve chromatic aberration control characteristics, and improve the vignetting characteristics of the optical system 1000.

The aperture stop ST may be disposed around the sensor-side surface of a lens 132 and 142 having a minimum effective diameter. The effective diameter of the lens surface may decrease from the object toward the aperture stop ST. In the lenses disposed between the aperture stop ST and the image sensor 300, the average effective diameter of the lenses may decrease from the aperture stop ST toward the image sensor 300. Here, the average effective diameter is the average of the effective diameters of the object-side surface and the sensor-side surface of each lens. The aperture stop ST may be disposed between the first lens group LG1 and the second lens group LG2. Alternatively, the peripheral surface of at least one lens selected from the plurality of lenses may function as an aperture stop. Specifically, a flange portion of the object-side or sensor-side surface of one lens selected from the lenses of the optical system 1000 may function as an aperture stop that controls the amount of light. As another example, if there are two aperture stops, the two aperture stops may be spaced apart from each other. The first aperture stop may be disposed around the sensor-side surface of the lens having the minimum effective diameter, and the second aperture stop may be disposed around the peripheral surface of the lens surface S1 having the maximum effective diameter.

The second distance CG2 along the optical axis between the first lens group LG1 and the second lens group LG2 may be a distance along the optical axis between the sensor-side surface of the first lens group LG1 and the object-side surface of the second lens group LG2. The second distance CG2 may be the center distance between adjacent spherical lenses or the center distance between an aspherical lens and a spherical lens. In addition, the second distance CG2 may be larger than the third distance CG3. The third distance CG3 is the center distance between the spherical lens and the aspherical lens. By adjusting the second and third gaps G2 and G3, the effective diameters of the lenses located on the sensor side of the aperture stop ST may be suppressed from increasing. Accordingly, the optical system 1000 may be suppressed from increasing in size in the direction orthogonal to the optical axis OA. Here, the first lens group LG1 may include lenses located closer to the object side than the aperture stop ST, and the second lens group LG2 may include lenses located closer to the sensor side than the aperture stop ST. The first lens group LG1 and the second lens group LG2 may be divided into an object-side lens group and a sensor-side lens group based on the aperture stop ST. The object-side surface of the first lens group LG1 may be concave on the optical axis. The object-side surface of the second lens group LG2 may be convex on the optical axis, and the sensor-side surface may have a convex shape on the optical axis. The sensor-side surface of the first lens group LG1 and the object-side surface of the second lens group LG2 may face each other.

The BFL may be less than the maximum center thickness of the lenses and may be greater than 3 mm. The BFL may be provided to be greater than 3 mm and less than 8 mm by providing the last lens with an aspherical surface. Preferably, the BFL is greater than or equal to ImgH and less than Imgh*2. The first lens group LG1 refracts light incident through the object side in the direction of the optical axis, and the second lens group LG2 can refract light incident through the first lens group LG1 to the periphery of the image sensor 300. A second distance CG2 between the first lens group LG1 and the second lens group LG2 may be at least twice the minimum center thickness of the lenses.

The first lens group LG1 may have negative (−) power, and the second lens group LG2 may have positive (+) power. In the first lens group LG1, the lens closest to the object side may have negative (−) power, and among the lenses in the second lens group LG2, the lens closest to the sensor side may have positive (+) power. When the focal length of the first lens group LG1 is FLG1 and the focal length of the second lens group LG2 is FLG2, the Mathematical Formula may satisfy: FLG2<|FLG1|. The power of the first lens group LG1 may be negative, and the power of the second lens group LG2 may be positive.

Within the optical system 1000, the number of lenses with negative power may be less than the number of lenses with positive power. The number of lenses with negative power may be 40% or less of the total number of lenses, for example, in the range of 20% to 40%. When one or more glass lenses are arranged within the camera module, durability and heat resistance are improved, internal stress during the lens manufacturing process may be suppressed, and optical performance degradation may be prevented. Furthermore, the glass lens can improve chromatic aberration at high refractive indices. The average Abbe number of the spherical material lenses within the lens unit 100C and 100D may be greater than the Abbe number of the aspherical lens. The average refractive index of the spherical material lenses within the lens unit 100C may be greater than the refractive index of the aspherical lens. Since the first lens 131 and 141 closest to the object provides the maximum effective diameter, the field of view may be wide compared to the focal length. The sum of the refractive indices of the lenses of the lens unit 100C and 100D may be 9 or less, for example, in the range of 6 to 9, and the average refractive index may be 1.6 or more, for example, in the range of 1.6 to 1.9. The sum of the Abbe numbers of each of the lenses may be 150 or less, for example, in the range of 70 to 150, and the average Abbe number may be 45 or less, for example, in the range of 18 to 45. The sum of the center thicknesses of the entire lens may be 10 mm or greater, for example, in the range of 10 mm to 20 mm or 11 mm to 16 mm. The average of the center thicknesses of the entire lens may be 2.5 mm or greater, for example, in the range of 2.5 mm to 5 mm. The sum of the center distances between the lenses along the optical axis OA may be 8 mm or greater, for example, in the range of 8 mm to 13 mm or 9 mm to 13 mm. The sum of the center distances between the lenses along the optical axis OA may be less than the sum of the center thicknesses of the lenses.

The average effective diameter of each lens surface of the lens unit 100C and 100D may be 8 mm or greater, for example, in the range of 8 mm to 16 mm or 8 mm to 13 mm. The difference between the maximum and minimum effective diameters of each lens surface may be 10 mm or less, for example, in the range of 3 mm to 10 mm. Therefore, in the optical system, since lenses having an average center thickness of the entire lens of 2.5 mm or more and an average effective diameter of 8 mm or more are provided, the assemblage between the lenses and the lens barrel may be improved.

The F number F # of the optical system or camera module may be less than 2, for example, in the range of 1.0 to 1.5 or in the range of 1.0 to 1.2. In the optical system according to the embodiment of the invention, the field of view, that is, the diagonal field of view, may be greater than 80 degrees, for example, greater than 80 degrees and less than 150 degrees, or in the range of 110 degrees to 135 degrees. Here, the horizontal field of view of the optical system is less than or equal to 110 degrees, for example, in the range of 75 degrees to 110 degrees, and may be smaller than the diagonal field of view. The vertical field of view of the optical system is less than or equal to 90 degrees, and may be in the range of 60 degrees to 90 degrees, and may be smaller than the horizontal field of view. The horizontal field of view is a field of view measured based on the horizontal length of the image sensor 300, and the vertical field of view is a field of view measured based on the vertical length of the image sensor 300.

The image sensor 300 may have, for example, a diagonal sensor length of 8.0 mm+0.5 mm, a horizontal sensor length of 6.40 mm+0.5 mm, and a vertical sensor height of 4.80 mm+0.5 mm. Accordingly, it is possible to suppress changes in the focus imaging position due to temperature changes, and provide a vehicle camera in which various aberrations are well corrected. When the optical system 1000 has a diagonal FOV of 110 degrees to 135 degrees and has at least one spherical lens and at least one aspherical lens, the center thickness of the aspherical fourth lens 134 closest to the image sensor 300 may be the thickest. Accordingly, the number of glass lenses in the optical system 1000 and the center thickness of the glass lenses can reduce the influence on optical performance, that is, the change in optical performance due to temperature changes from low to high temperatures.

The diagonal length of the image sensor 300 may be 40% or more of the maximum effective diameter of the lens surfaces, for example, 40% to 80% or 50% to 75%.

An optical filter 500 may be disposed between the second lens group LG2 and the image sensor 300. The optical filter 500 may be disposed closer to the image sensor 300 than the last lens. The optical filter 500 may allow light to pass through a wavelength band of 920 nm or more, for example, 920 nm to 960 nm. As another example, the optical filter 500 may allow light to pass through at least one of the LiDAR wavelengths, for example, 905 nm 20 nm or 1550 nm+20 nm. A cover glass (not shown) may be disposed between the optical filter 500 and the image sensor 300.

Embodiments of the invention may be designed using both aspherical and spherical lenses. For example, the first lens 131 and 141 may be made of plastic and the n−1th lens may be made of glass. This has the advantage that glass is easier to assemble than plastic and is less sensitive to external temperature. Since the first lens 131 and 141 has an aspherical surface inside the vehicle and has a concave shape on both sides, the light path may be controlled by the first lens 131 and 141 and the occurrence of spherical aberration may be prevented. Accordingly, the reliability of the driver monitoring camera module may be improved. The last lens in the lens unit 100C and 100D may be provided as an aspherical lens. Since the last lens is an aspherical lens, the influence on optical characteristics may be reduced. In addition, since the last lens is provided as an aspherical lens, chromatic aberration may be corrected and light may be refracted to the entire area of the image sensor 300.

The optical system 1000 may further include a reflective member (not shown) for changing the path of light. The reflective member may be implemented as a prism that reflects the incident light of the first lens group LG1 toward the lenses. As another example, the optical system 1000 may include a first reflective member disposed on the object side and a second reflective member positioned between the last lens and the image sensor 300. The reflective member, which changes the path of light, may reduce the thickness of the camera module.

The optical system and camera module according to the fourth embodiment will now be described with reference to FIGS. 25 to 32.

Referring to FIGS. 25 to 27, the lens unit 100C may include a first lens 131 to a fourth lens 134. The first to fourth lenses 131, 132, 133, and 134 may be sequentially aligned along the optical axis OA. Light corresponding to object information can pass through the first lens 131 to the fourth lens 134 and be incident on the image sensor 300. The first and second lenses 131 and 132 are lenses of the first lens group LG1 and are two lenses adjacent to the object. The third and fourth lenses 133 and 134 are lenses of the second lens group LG2, and the fourth lens 134 is the lens closest to the image sensor 300. The focal lengths of the first to fourth lenses 131, 132, 133, and 134 are F1, F2, F3, and F4, the composite focal length of the first and second lenses 131 and 132 is F12, the composite focal length of the third and fourth lenses is F34, the overall focal length is F, and the following conditions may be satisfied.

$$\vert F 1 \vert < F 3 < F 2 \qquad Condition 1$$

$$\vert F 1 \vert < \vert F 12 \vert \qquad Condition 2$$

$$F 2 < ( \vert F 12 \vert + F 3 ) < F 2 * 2 \qquad Condition 3$$

$$\vert F 1 \vert < F 34 < F 4 < F 2 \qquad Condition 4$$

$$F < \vert F 1 \vert \qquad Condition 5$$

The first lens 131 may have positive (+) or negative (−) power on the optical axis OA. The first lens 131 may have negative (−) power. The first lens 131 may include a plastic material or glass material, and may be, for example, a plastic material. The first lens 131 made of a plastic material can minimize distortion, correct aberrations, and reduce chromatic dispersion.

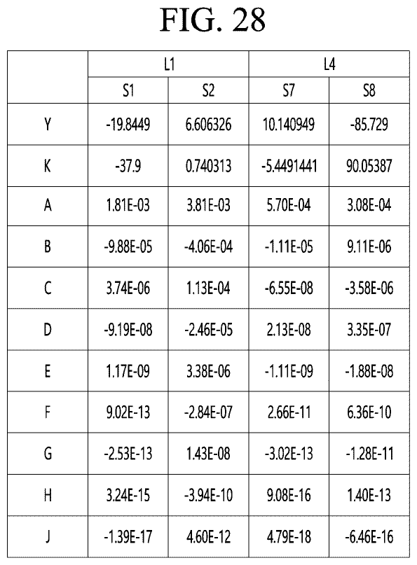

On the optical axis OA, the first surface S1 on the object side of the first lens 131 may be concave, and the second surface S2 on the sensor side may have a concave shape. The first lens 131 may have a concave shape on both sides on the optical axis. Alternatively, the first surface S1 may have a convex shape, and the second surface S2 may have a concave shape on the optical axis OA. The first lens 131 may be an aspherical lens made of a plastic material, and the first surface S1 and the second surface S2 may be aspherical. FIG. 28 shows the radius of curvature (Y), the conic constant (K), and the aspherical coefficients (A to J) from the 4th to the 20th order of the first and second surfaces S1 and S2.

The first lens 131 may have the thinnest center thickness CT1 among aspherical lenses. The first lens 131 is provided with a center thickness CT1 of more than 1 mm, and can prevent a decrease in rigidity due to external impact. In addition, since the first lens 131 has an aspherical surface made of plastic, even if the center thickness CT1 is designed to be thin, it can provide a change in the refractive angle of light. The first lens 131 has a first surface S1 that is concave on the optical axis and has a radius of curvature of 10 mm or more, and the second surface S2 is formed concavely with a radius of curvature smaller than the first surface S1, so that the incident light may be refracted in a direction close to the optical axis. Accordingly, the effective diameter of the second lens 132 may be prevented from increasing. The first surface S1 of the first lens 131 may have a critical point from the optical axis OA to the end of the effective area. The position of the critical point may be arranged at a distance of 32% or more, for example, 32% to 52% or 37% to 47%, of the distance from the optical axis OA of the first surface S1 to the end of the effective area. For example, the critical point is a point where the trend of the Sag value changes. That is, the point where the Sag value increases and then decreases, or the point where the Sag value decreases and then increases. The distance from the optical axis OA of the first surface S1 to the end of the effective area may be the effective radius of the first surface S1. Since the first surface S1 has a critical point, the first surface S1 can improve the incidence efficiency of light incident through various paths and refract it toward the second lens 132. The second surface S2 of the second lens 132 may be provided without a critical point from the optical axis OA to the end of the effective area.

The second lens 132 may be disposed between the first lens 131 and the third lens 133. The second lens 132 may have positive (+) or negative (−) power on the optical axis OA, for example, positive (+) power. The second lens 132 may include a plastic or glass material. For example, the second lens 132 may be provided as a glass material. The object-side third surface S3 of the second lens 132 on the optical axis OA may be convex, and the sensor-side fourth surface S4 may have a convex shape. The second lens 132 may have a shape in which both sides are convex on the optical axis. Alternatively, the third surface S3 may be convex, and the fourth surface S4 may be concave. Alternatively, the second lens 132 may have a concave shape on both sides. Alternatively, the third surface S3 may be concave and the fourth surface S4 may be convex. The second lens 132 may be provided as a spherical lens made of glass. The third surface S3 and the fourth surface S4 may be spherical. At least one or both of the third surface S3 and the fourth surface S4 may be provided without a critical point from the optical axis OA to the end of the effective area.

The third lens 133 may have positive (+) or negative (−) power on the optical axis OA. The third lens 133 may have positive (+) power. The third lens 133 may include a plastic or glass material. For example, the third lens 133 may be a spherical lens made of glass. The fifth surface S5 on the object side of the third lens 133 on the optical axis OA may have a convex shape, and the sixth surface S6 on the sensor side may have a convex shape. The third lens 133 may have a convex shape on both sides on the optical axis OA. Alternatively, the third lens 133 may have a meniscus shape that is convex toward the sensor side. Alternatively, the third lens 133 may have a meniscus shape that is convex toward the object side, or a concave shape on both sides. The fifth surface S5 and the sixth surface S6 of the third lens 133 may be spherical along the optical axis, and at least one or both of the fifth surface S5 and the sixth surface S6 may be provided without a critical point from the optical axis OA to the end of the effective area.

The aperture stop ST is a member that controls the amount of light and may be disposed around the sensor-side surface of the second lens 132. The aperture stop ST may be disposed around the area between the second lens 132 and the third lens 133. The difference in the hole diameter of the aperture stop ST and the effective diameter of the sensor-side fourth surface S4 of the second lens 132 may be less than 20%. Accordingly, the amount of light passing through the second lens 132 may be controlled. When the hole diameter of the aperture stop ST is CA_ST and the effective diameter of the fourth surface S4 is CA22, the following condition may be satisfied.

$$0.8 < CA\_ST / CA 22 < 1.2 \qquad Condition$$

Preferably, 0.8<CA_ST/CA22<1 may be satisfied. Specifically, 0.9<ST_CA/CA22<1 may be satisfied. For example, the hole diameter of the aperture stop ST may be smaller than the effective diameter of the sensor-side fourth surface S4 of the second lens 132, in which case, an increase in the effective diameter of the third lens 133 may be suppressed. Since the hole diameter of the aperture stop ST is provided within the above range, the amount of light passing through the second lens 132 may be controlled, and an increase in the effective diameter of the seventh surface S7 of the third lens 133 may be suppressed.

The effective diameter of the object-side fifth surface S5 of the third lens 133 may be larger than the hole diameter of the aperture stop ST, and the distance between the second and third lenses 132 and 133 may be adjusted by the hole diameter of the aperture stop ST. Since the aperture stop ST is arranged on the periphery between the second and third lenses 132 and 133, the difference in effective diameter between the second and third lenses 132 and 133 may be reduced. The second lens 132 and the third lens 133 on both sides of the aperture stop ST may have the same amount of power. The aperture stop ST may be disposed closer to the fourth surface S4 than to the fifth surface S5. The distance between the aperture stop ST and the fifth surface S5 may be at least 10 times the distance between the aperture stop ST and the fourth surface S4, for example, 10 to 100 times or 30 to 80 times. The effective diameter of the fifth surface S5 may be more than 1 time the effective diameter of the fourth surface S4, for example, more than 1 time and less than 3 times.

The fourth lens 134 may have positive (+) or negative (−) power on the optical axis OA. The fourth lens 134 may have positive (+) power. The fourth lens 133 may be made of plastic or glass. For example, the fourth lens 134 may be made of plastic. The object-side seventh surface S7 of the fourth lens 134 may have a convex shape on the optical axis OA, and the sensor-side eighth surface S8 may have a convex shape. The fourth lens 134 may have a biconvex shape on the optical axis OA. Alternatively, the fourth lens 134 may have a meniscus shape convex toward the sensor. Alternatively, the fourth lens 134 may have a meniscus shape convex toward the object, or may have a biconcave shape.

The seventh surface S7 and the eighth surface S8 of the fourth lens 134 may be aspherical on the optical axis, and the aspheric coefficients may be provided in FIG. 28. The seventh surface S7 may be provided without a critical point from the optical axis to the end of the effective area, and the eighth surface S8 may be provided without a critical point from the optical axis to the end of the effective area. Alternatively, at least one or both of the seventh surface S7 and the eighth surface S8 may have a critical point from the optical axis OA to the end of the effective area. The fourth lens 134 may have the thickest center thickness CT4 among the lenses. The fourth lens 134 may be an aspherical lens that is closest to the image sensor 300. By arranging the aspherical lens closest to the image sensor 300, it is possible to prevent a deterioration in optical performance, improve aberration characteristics, and control the influence on resolution. In addition, by arranging the aspherical lens as the lens closest to the image sensor 300, it may be insensitive to assembly tolerances compared to a spherical lens. In other words, being insensitive to assembly tolerances means that even if assembly is slightly different from the design, optical performance may not be significantly affected. Furthermore, the fourth lens 134 can improve assembly tolerances by providing a small difference between the center thickness CT4 and the edge thickness ET4.

The center thickness CT1 of the first lens 131 may be thinner than the edge thickness ET1. The edge thickness ET1 of the first lens 131 may be the thickest among the edge thicknesses of the lenses. Since the first lens 131 has a center thickness greater than the center thickness CT2 of the second lens 132 and has a shape in which both sides are concave on the optical axis, the effective diameter of the second surface S2 of the first lens 131 may be reduced, and the center distance CG1 between the first and second lenses 131 and 132 may be increased. Since the second lens 132 has a biconvex shape, the center distance CG2 between the second lens 132 and the third lens 133 may be increased, and also, in the area between the second lens 132 and the third lens 133, the convex fourth surface S4 and the convex fifth surface S5 may face each other. Since the third lens 133 has a biconvex shape and the fourth lens 134 has a biconvex shape, the center distance CG3 between the third and fourth lenses 133 and 134 may be reduced. The center distance CG3 between the third and fourth lenses 133 and 134 may be smaller than the edge distance. The effective diameter of the fourth lens 134 may be provided to be larger than the diagonal length of the image sensor 300.

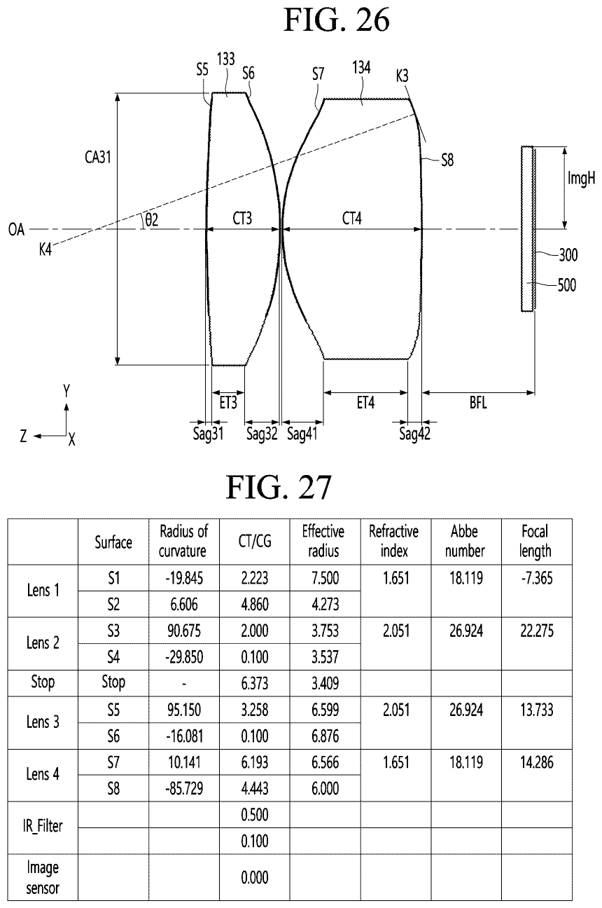

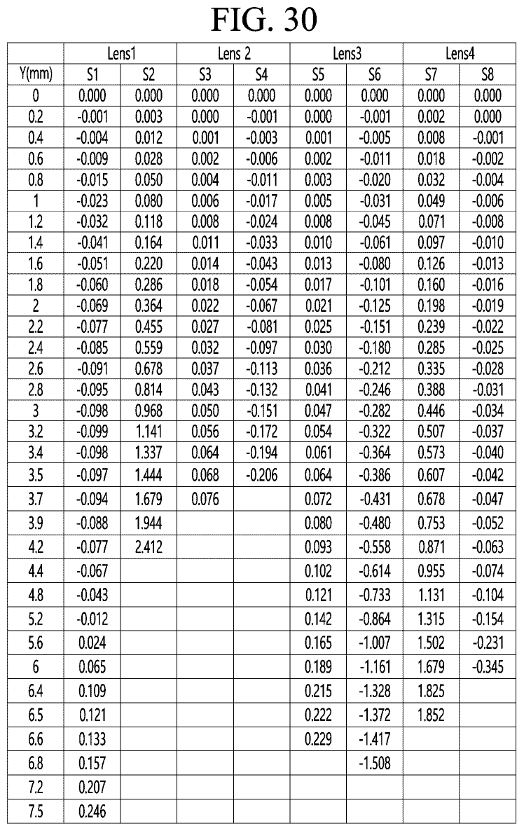

Referring to FIGS. 26 and 30, the distance in the direction of the optical axis from a straight line perpendicular to the optical axis from the center of the object-side fifth surface S5 of the third lens 133 to the fifth surface S5 is Sag31, and the value of Sag31 is the distance between the lens surface arranged on the sensor side based on the straight line and the straight line, and may have a positive value. The distance in the direction of the optical axis from a straight line perpendicular to the optical axis from the center of the sensor-side sixth surface S6 of the third lens 133 to the sixth surface S6 is Sag32, and the value of Sag32 may have a negative value.

The distance in the direction of the optical axis from a straight line perpendicular to the optical axis from the center of the object-side seventh surface S7 of the fourth lens 134 to the seventh surface S7 is Sag41, and the value of Sag41 may have a positive value. The distance in the direction of the optical axis from a straight line perpendicular to the optical axis from the center of the sensor-side eighth surface S8 of the fourth lens 134 to the eighth surface S8 is Sag42, and the value of Sag42 has a negative value. Here, the Max_Sag value is the maximum distance in the direction of the optical axis from a straight line perpendicular to the center of the object-side surface or the sensor-side surface of each lens to the lens surface, and the Sag value may have a negative value when located on the object-side surface rather than on the straight line perpendicular to the center, and may have a positive value when located on the sensor-side surface rather than on the straight line perpendicular to the center. The maximum Sag values of the third and fourth lenses 133 and 134 may satisfy the following conditions.

$$Max\_Sag 31 < \vert Max\_Sag32 \vert \qquad Condition 1$$

$$\vert Max\_Sag42 \vert < Max\_Sag41 \qquad Condition 2$$

$$\vert Max\_Sag32 \vert < Max\_Sag41 \qquad Condition 3$$

The Sag value of the object-side third surface S3 of the second lens 132 is Sag21 and has a positive value, and the Sag value of the fourth surface S4 is Sag22 and may have a negative value, satisfying the condition of Max_Sag21<|Max_Sag22|. Similarly, the Sag value of the object-side first surface S1 of the first lens 131 is Sag11 and has a negative value from the optical axis to the critical point and may have a positive value in the edge region at the critical point. The Sag value of the second surface S2 is Sag12 and may have a positive value. The condition of Max_Sag12>|Max_Sag11| may be satisfied. The value of Max_Sag12 may have the largest value among the Sag values of the object side and sensor side of the lenses.

As shown in FIG. 26, the BFL (Back focal length) is the optical axis distance from the image sensor 300 to the center of the sensor-side surface of the last lens 134. A tangent line K3 passing through an arbitrary point of the eighth surface S8 of the fourth lens 134 and a normal line K4 perpendicular to the tangent line K3 may have a predetermined tangent angle θ2 with the optical axis OA. The maximum tangent angle θ2 on the eighth surface S8 in the first direction X may be 35 degrees or less, for example, in the range of 5 to 35 degrees or 10 to 25 degrees, with respect to an axis parallel to the optical axis. The maximum tangent angle on the fifth surface S5 in the first direction X may be 45 degrees or less, for example, in the range of 1 to 25 degrees, with respect to an axis parallel to the optical axis. Here, the maximum tangential angle of the lens surfaces is 40 degrees or more, is the maximum tangential angle of the second surface S2, and may be in the range of 40 degrees to 85 degrees.

As shown in FIGS. 25 and 26, CT1, CT2, CT3, and CT4 are the center thicknesses or optical axis thicknesses of the first, second, third, and fourth lenses 131, 132, 133, and 134, and ET1, ET2, ET3, and ET4 are the thicknesses in the optical axis direction at the edges of the first, second, third, and fourth lenses 131, 132, 133, and 134. The center distance between the first and second lenses 131 and 132 is CG1, the center distance between the second and third lenses 132 and 133 is CG2, and the center distance between the third and fourth lenses 133 and 134 is CG3. The edge thickness of each lens is the distance along the optical axis between the object-side and sensor-side surfaces at the ends of the effective area of each lens. The center thickness and edge thickness of the lenses may satisfy the following conditions:

$$CT 1 - CT 4 \qquad Condition 1$$

$$CT 2 \leq CT 1 \qquad Condition 2$$

$$CT 2 < CT 3 < CT 4 \qquad Condition 3$$

$$ET 3 < ET 4 < ET 1 \qquad Condition 4$$

$$ET 2 < ET 4 < ET 1 \qquad Condition 5$$

The effective diameters of the first lens 131 to the fourth lens 134 are the average of the effective diameters of the object-side and sensor-side surfaces and are defined as CA1, CA2, CA3, and CA4. The effective diameters of the object-side and sensor-side surfaces of the first lens 131 to the fourth lens 134 may be defined as CA11, CA12, CA21, CA22, CA31, CA32, CA41, and CA42. When the aperture stop ST is disposed on the sensor side of the second lens 132, the following conditions may be satisfied.

$$CA 2 < CA 1 < CA 3 \qquad Condition 1$$

$$CA 2 < ( ImgH * 2 ) < CA 1 \qquad Condition 2$$

$$CA 1 < CA 4 < CA 3 \qquad Condition 3$$

$$CA 22 < CA 21 < CA 12 < CA 11 \qquad Condition 4$$

$$CA 12 < CA 31 < CA 32 < CA 11 \qquad Condition 5$$

$$CA 42 > CA 41 > CA 32 \qquad Condition 6$$

Since the second lens 132 disposed on the object side of the aperture stop ST has a positive power (F2>0) and a biconvex shape, the second lens 132 can refract incident light to the entire area of the third lens 133. Since the second lens 132 has a thin thickness and the average absolute value of the radius of curvature is 30 mm or more, the distance between the second lens 132 and the aperture stop ST may be reduced. The center distance CG2 between the second and third lenses 132 and 133 may be set to the distance between spherical lenses, preventing an increase in the effective diameter of the third lens 133 disposed on the sensor side of the aperture stop ST, and providing a slim camera module within the field of view range.

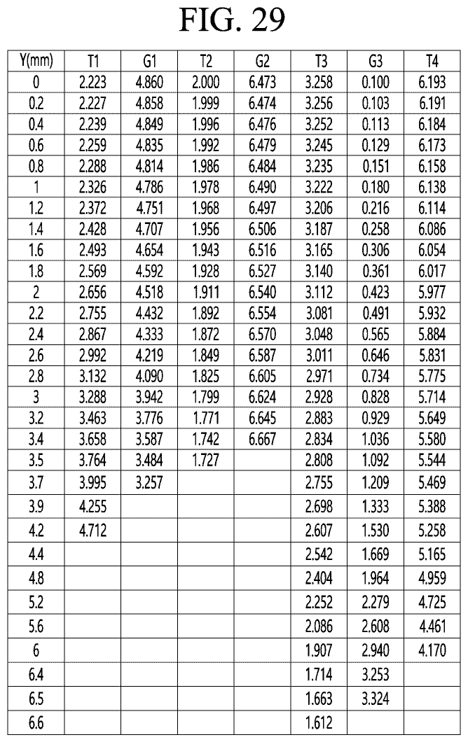

As shown in FIG. 29, the thicknesses Ti, T2, T3, and T4 of the first to fourth lenses 131, 132, 133, and 134 and the distance G1, G2, and G3 between adjacent two lenses may be set. The thickness T1, T2, T3, and T4 of each lens in the Y-axis direction from the optical axis toward the edge of each lens may be expressed at intervals of 0.1 mm or more, and the distances G1, G2, and G3 between adjacent lenses may be expressed at intervals of 0.1 mm or more. As shown in FIG. 29, the thickness T1 of the first lens 131 may gradually become thicker from the center to the edge. The thickness T2 of the second lens 132 may gradually become thinner from the center to the edge. The thickness T3 of the third lens 133 may gradually become thinner from the center to the edge. The thickness T1 of the first lens 131 may gradually become thinner from the center to the edge.

The distance G1 between the first and second lenses 131 and 132 may gradually decrease from the center to the edge, and the minimum distance may be greater than the center thickness of the first and second lenses 131 and 132.

The distance G2 between the first and second lenses 131 and 132 may have the largest center distance CG1 and the smallest edge distance. The distance G2 between the second lens 132 and the third lens 133 may gradually increase from the center to the edge. This distance G2 may gradually increase from the optical axis to the edge due to the convex shape of the sensor-side surface of the second lens 132 and the convex shape of the object-side surface of the third lens 133. That is, the distance G2 between the second lens 132 and the third lens 133 may have the smallest center distance CG2 and the largest edge distance. The center distance CG2 between the second and third lenses 132 and 133 may be greater than the edge thickness of the first lens 131 and the maximum gap between the first and second lenses 131 and 132. The distance G3 between the third lens 133 and the fourth lens 134 may gradually increase from the center to the edge. This distance G3 may gradually increase from the optical axis to the edge due to the convex shape of the sensor-side surface of the third lens 133 and the convex shape of the object-side surface of the fourth lens 134. That is, the distance G3 between the third lens 133 and the fourth lens 134 may have the smallest center distance CG3 and the largest edge distance. The center distance CG3 between the third and fourth lenses 133 and 134 may be smaller than the center thickness of the second lens 132, and the edge distance may be smaller than the center thickness of the second lens 132.

FIG. 27 is an example of lens data of the optical system of the embodiment of FIG. 25. As shown in FIG. 27, the radius of curvature of the optical axis OA of the first to fourth lenses 131, 132, 133, and 134, the center thickness CT of the lenses, the center distance CG between adjacent lenses, the refractive index (D-line), the Abbe number, the semi-aperture, and the focal length may be set. The radii of curvature of the first and second surfaces S1 and S2 of the first lens 131 are L1R1 and L1R2, the radii of curvature of the third and fourth surfaces S3 and S4 of the second lens 132 are L2R1 and L2R2, the radii of curvature of the fifth and sixth surfaces S5 and S6 of the third lens 133 are L3R1 and L3R2, and the radii of curvature of the seventh and eighth surfaces S7 and S8 of the fourth lens 134 may be expressed as L4R1 and L4R2. These radii of curvature are radii of curvature on the optical axis of each lens surface, and may satisfy at least one of the following conditions.

$$L 1 R 2 < \vert L 1 R 1 \vert \qquad Condition 1$$

$$L 1 R 2 < \vert L 2 R 2 \vert < L 2 R 1 \qquad Condition 2$$

$$L 1 R 2 < \vert L 3 R 2 \vert < L 3 R 1 \qquad Condition 3$$

$$L 4 R 1 < \vert L 3 R 2 \vert \qquad Condition 4$$

$$\vert L 1 R 1 \vert < \vert L 4 R 2 \vert < L 2 R 2 < L 3 R 1 \qquad Condition 5$$

$$\vert L 3 R 2 \vert * 3 < L 3 R 1 < \vert L 1 R 1 \vert * 8 \qquad Condition 6$$

If the fourth lens 134 is designed as an aspherical surface, thermal compensation may be satisfied and optical performance may be improved. However, assembly may be more difficult than with a spherical lens. Furthermore, the aspherical fourth lens 134 may affect the optical characteristics of lenses positioned closer to the object than the fourth lens 134. The invention facilitates assembly by adjusting the thickness and radius of curvature of the aspherical fourth lens 134. Furthermore, since the second lens 132 having a spherical surface is disposed on the object side of the aperture stop ST and is the lens most sensitive to optical characteristics, the effective diameter of the third lens 133 may be larger than that of the second lens 132, and the difference in curvature radius between the fourth surface S4 of the second lens 132 and the fifth surface S5 of the third lens 133 may be set to 10 mm or more. Furthermore, the difference in center thickness between the second lens 132 and the third lens 133 may be set to 2 mm or less. Accordingly, an optical system having a low chief ray angle (CRA) may be implemented by the aperture stop ST between the second and third lenses 132 and 133.

The sum of the center thicknesses of the first to fourth lenses 131-134 may be defined as ΣCT, and the sum of the edge thicknesses of the first to fourth lenses 131-134 may be defined as ΣET. Regarding the thicknesses of the lenses, the center thickness CT1 of the first lens 131 may be smaller than the center thicknesses CT3 and CT4 of the third and fourth lenses 133 and 134. Preferably, the maximum thickness among the lenses is the center thickness CT4 of the fourth lens 134. Since the center thickness CT1 of the first lens 131 is thin, 3 mm or less, and the radius of curvature of the sensor-side second surface S2 is provided to be minimal, light incident through the plastic lens may be refracted to the end of the effective area of the last lens. The ratio of the center thickness and the edge thickness of each lens may satisfy the following condition.

$$0 < CT 1 / ET 1 < 1 \qquad Condition 1$$

$$0.5 < C T 2 / ET 2 < 1.5 \qquad Condition 2$$

$$1 < CT 3 / ET 3 < 3 \qquad Condition 3$$

$$1 < CT 4 / ET 4 < 2.5 \qquad Condition 4$$

$$0.8 < \sum CT / \sum ET < 1.3 \qquad Condition 5$$

Here, the sum of the center thicknesses of the lenses is YCT, and the sum of the edge thicknesses is ΣET.

Furthermore, the thickness of each lens may satisfy the following conditions:

$$0.5 < CT 1 / CT 2 < 1.5 \qquad Condition 1$$

$$1 < CT 4 / CT 3 < 3 \qquad Condition 2$$

$$0.1 < CT 2 / CT 3 < 1 \qquad Condition 3$$

$$0 < CT 1 / \sum CT < 0.3 \qquad Condition 4$$

$$0.2 < CT 4 / \sum CT < 0.7 \qquad Condition 5$$

In the conditions, if CTi/ETi (i=1~4), it may be minimum when i is 1. The difference between the center thickness and the edge thickness of each lens may be set to be greater than 0.01 mm and less than 3 mm. This allows the aspherical lens to be disposed on the fourth lens 134 to refract the incident light to the periphery of the image sensor 300 without increasing the difference between the center thickness and the edge thickness of each lens. Furthermore, by setting the difference between the center thickness and the edge thickness of the fourth lens 134 to 1 mm or more, the difference in the radius of curvature between the object-side and sensor-side surfaces may be designed to be large, improving the assembling performance of the aspherical fourth lens 134 and reducing the impact on optical characteristics.

The difference between the maximum and minimum center thicknesses of the lenses may be 2 mm or more, for example, in the range of 2 mm to 6 mm or 3 mm to 5.5 mm. Furthermore, the edge thicknesses of the second and third lenses 132 and 133 made of glass material may be thinner than those made of plastic material. Furthermore, even if the difference between the center thickness and the edge thickness of the second lens 132 is designed to be small, optical performance may not be degraded, and the camera module may be slimmed down. Furthermore, since the difference between the center thickness and the edge thickness of each lens is not large, even if at least one lens is tilted, the impact on optical characteristics may be reduced. It can also reduce the influence on thermal characteristics between the center and edge of the lenses.

The center distance between the first to fourth lenses 131, 132, 133, and 134 is defined as CG1, CG2, and CG3, and the sum of the center distances between the first to fourth lenses 131, 132, 133, and 134 may be defined as YCG. The center distance CG2 between the second and third lenses 132 and 133 is the center distance between spherical lenses and may be greater than the center distance CG1 between the first and second lenses 131 and 132. The center distance CG3 between the third lens 133 and fourth lens 134 is the center distance between spherical lenses and aspherical lenses and may be less than 1 mm.

Regarding the refractive indices, the refractive indices of the first to fourth lenses 131-134 may be 1.5 or greater. The second and third lenses 132 and 133 may be made of glass and have a refractive index of 1.8 or greater. The second and third lenses 132 and 133 may be made of the same glass material and have the same refractive index. The second and third lenses 132 and 133 may have the same Abbe number. The first and fourth lenses 131 and 134 may be made of plastic and have a refractive index of less than 1.8. The refractive index of each of the second and third lenses 132 and 133 may be greater than the refractive index of each of the first and fourth lenses 131 and 134. The Abbe number of each of the second and third lenses 132 and 133 may be greater than the Abbe number of each of the first and fourth lenses 131 and 134.

The focal lengths F2, F3, and F4 of the second to fourth lenses 132, 133, and 134 have positive power, while the focal length F1 of the first lens 131 may have negative power. Accordingly, when each lens repeatedly contracts and expands as the temperature changes from low to high, chromatic aberration may be corrected by the heat-resistant glass lenses. The fourth lens 134 uses an aspherical lens to prevent resolution degradation due to temperature changes.

If the focal lengths are expressed as absolute values, the focal length of the second lens 132 is the largest among the lenses and may be 15 mm or greater. The focal length of the first lens 131 is the smallest among the lenses. The difference between the absolute values of the maximum and minimum focal lengths may be 20 mm or less. By making the absolute value difference in the focal lengths of the first and second lenses 131 and 132 greater than the difference in the focal lengths of the third and fourth lenses 133 and 134, the optical system may have improved MTF characteristics, aberration control characteristics, resolution characteristics, etc. in the set field of view range, and may have good optical performance in the periphery of the field of view.

As shown in FIG. 28, among the lenses of the lens unit 100C in the embodiment, the lens surface of the fourth lens 134 may include an aspherical surface having a 20th-order aspherical surface coefficient. For example, the fourth lens 134 may include a lens surface having a 20th-order aspherical surface coefficient. As described above, the aspherical surface having a 20th-order aspherical surface coefficient (a non-zero value) can significantly change the aspherical surface shape in the periphery, and thus can effectively correct the optical performance in the periphery of the FOV.

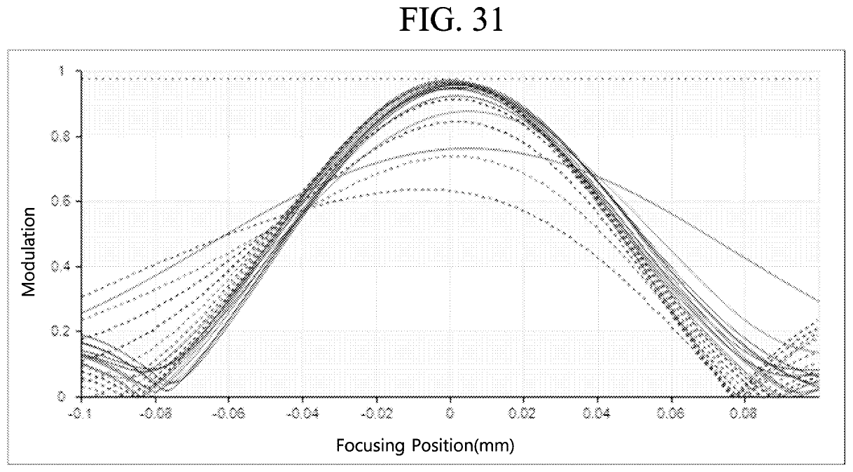

FIG. 31 is a graph showing the diffraction MTF at room temperature in the optical system of FIG. 25, and is a graph showing the modulation ratio according to spatial frequency. As in FIG. 31, the x-axis represents the defocusing position, and the y-axis represents the MTF. These graphs are measured from 0.000 mm to 4.000 mm in 0.400 mm increments from F1 to F23.

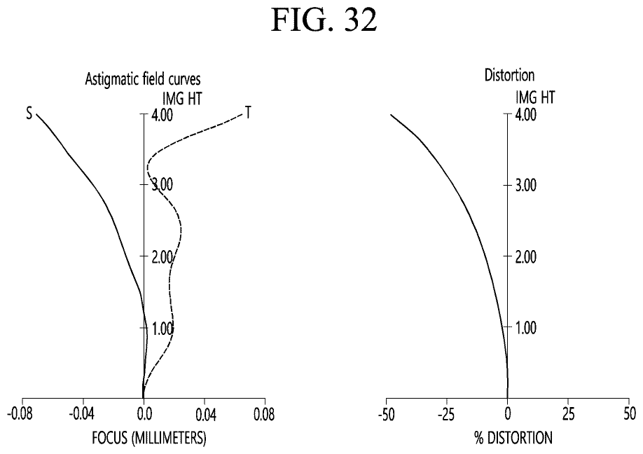

FIG. 32 is a graph showing the aberration characteristics of the optical system of FIG. 25. In the aberration graph of FIG. 32, astigmatic field curves and distortion are measured from left to right. In FIG. 32, the x-axis can represent the focal length (mm) and distortion (%), and the y-axis can represent the image height. In addition, the graphs for astigmatic and distortion aberrations are graphs for light in a wavelength band of approximately 940 nm. In the aberration diagram of FIG. 32, it may be interpreted that the aberration correction function is better as each curve approaches the Y-axis, and in the optical system 1000 according to the embodiment, it may be seen that measurement values are adjacent to the Y-axis in almost all areas. That is, the optical system 1000 according to the embodiment has improved resolution and may have good optical performance even in the center and periphery of the FOV. Here, the low temperature is −20 degrees or lower, for example, in the range of −20 to −40 degrees, the room temperature is in the range of 22 degrees+5 degrees or in the range of 18 degrees to 27 degrees, and the high temperature may be 80 degrees or higher, for example, in the range of 80 degrees to 105 degrees. Accordingly, it may be seen that the decrease in the luminance ratio (modulation) from low temperature to high temperature is less than 10%, for example, 5% or lower, or is almost unchanged.

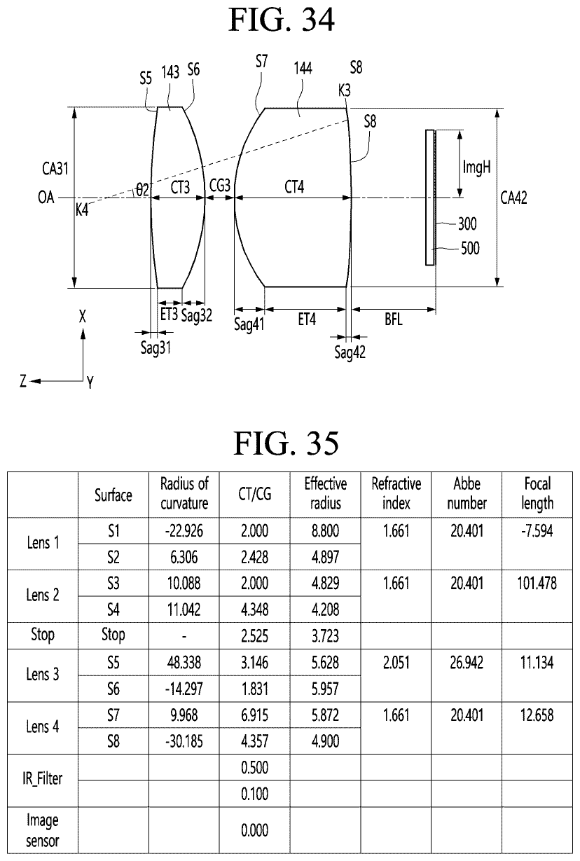

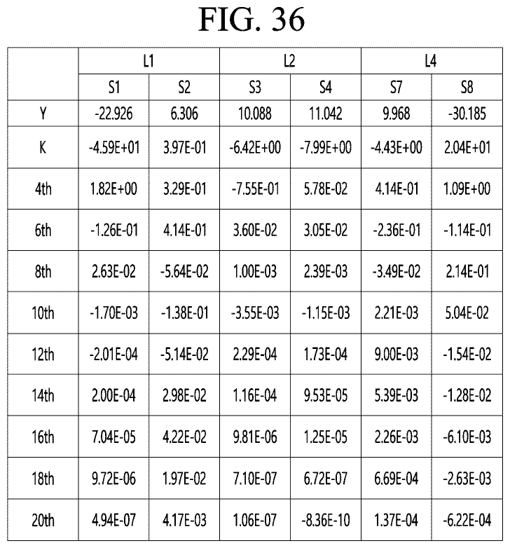

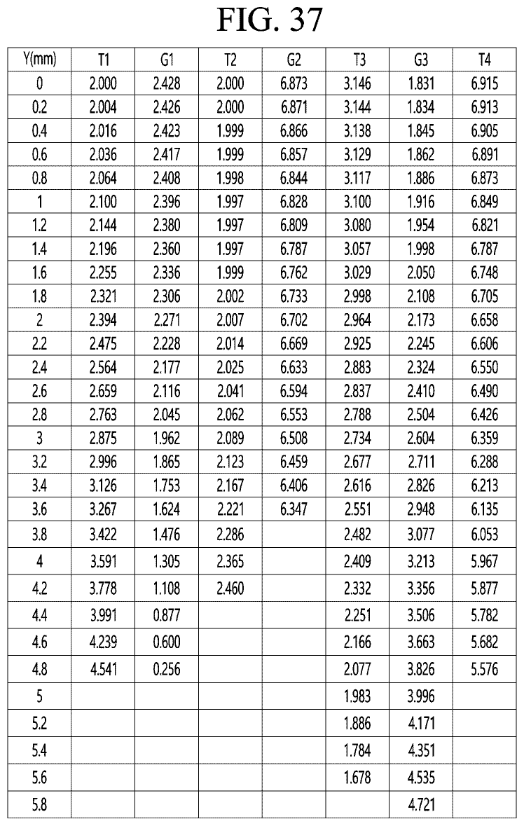

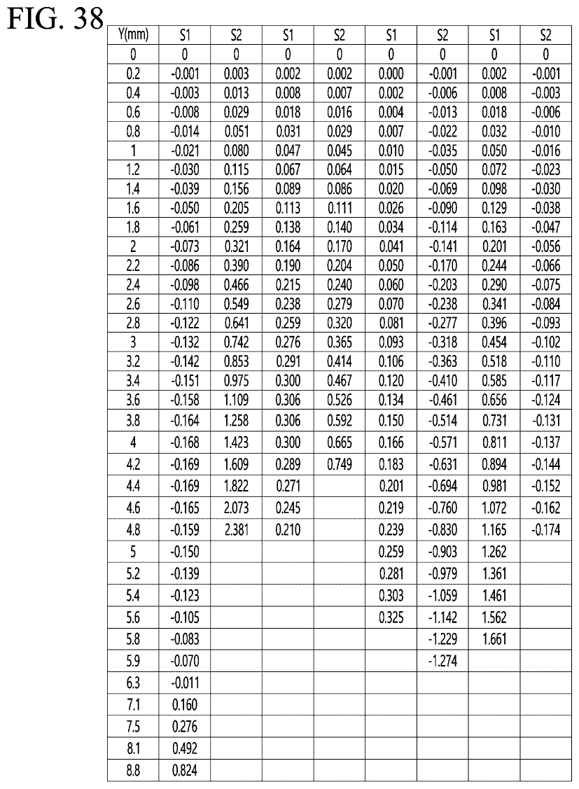

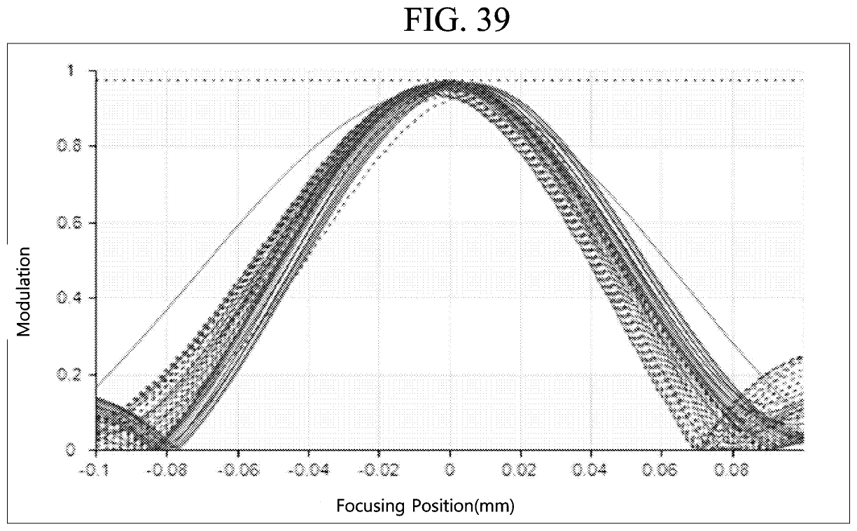

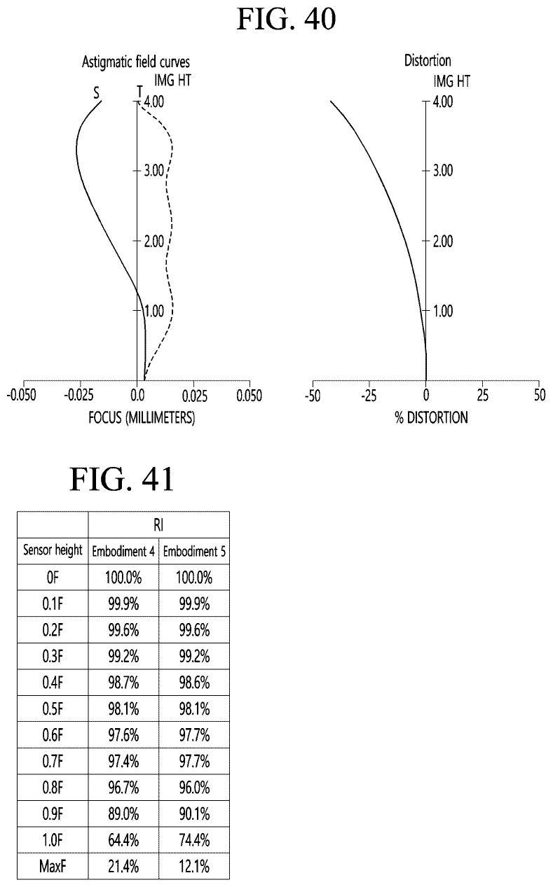

FIG. 33 is a side cross-sectional view of an optical system and a camera module having the same according to a fifth embodiment, FIG. 34 is a side cross-sectional view for explaining the relationship between the n-th and n−1th lenses according to FIG. 33, FIG. 35 is a table showing lens characteristics of the optical system of FIG. 33, FIG. 36 is a table showing aspherical coefficients of aspherical lenses in the optical system of FIG. 33, FIG. 37 is a table showing thicknesses from the center to the ends of each lens and distance between adjacent lenses in the optical system of FIG. 33, FIG. 38 is a table showing Sag values (Sagittal heights) from the center to the ends of the lenses of FIG. 33, FIG. 39 is a graph showing data on diffraction MTF at room temperature of the optical system of FIG. 33, and FIG. 40 is a graph showing data on aberration characteristics of the optical system of FIG. 33. The optical system and camera module of the fifth embodiment have the same configuration as the fourth embodiment, so refer to the fifth embodiment.

Referring to FIGS. 33 to 35, an optical system 1000 according to a fifth embodiment includes a lens unit 100D, wherein first to fourth lenses 141, 142, 143, and 144 may be sequentially aligned along an optical axis OA. The first and second lenses 141 and 142 belong to the first lens group LG1, and the third and fourth lenses 143 and 144 belong to the second lens group LG2.

The focal lengths of the first to fourth lenses 141, 142, 143, and 144, the composite focal lengths of the first and second lenses 141 and 142, and the composite focal lengths of the third and fourth lenses may be F34, and the overall focal length may satisfy the following conditions:

$$\vert F 1 \vert < F 3 < F 2 \qquad Condition 1$$

$$\vert F 1 \vert > \vert F 34 \vert \qquad Condition 2$$

$$( \vert F 12 \vert * F 3 ) < F 2 \qquad Condition 3$$

$$F 34 < \vert F 12 \vert < F 4 < F 2 \qquad Condition 4$$

$$F < \vert F 34 \vert < \vert F 1 \vert \qquad Condition 5$$

The first lens 141 may have a negative power on the optical axis OA. The first lens 141 may include a plastic material or a glass material, and may be, for example, a plastic material. The first lens 141 made of a plastic material can minimize distortion, correct aberrations, and reduce color dispersion. On the optical axis OA, the first surface S1 on the object side of the first lens 141 may be concave, and the second surface S2 on the sensor side may have a concave shape. The first lens 141 may have a concave shape on both sides on the optical axis. Alternatively, on the optical axis OA, the first surface S1 may have a convex shape, and the second surface S2 may have a concave shape. The first lens 141 may be an aspherical lens made of plastic, and the first surface S1 and the second surface S2 may be aspherical. FIG. 36 shows the radius of curvature (Y), the conic constant (K), and the aspherical coefficients from the 4th to the 20th order of the first and second surfaces S1 and S2.

The first lens 141 may have the thinnest center thickness CT1 among aspherical lenses. The first lens 141 is provided with a center thickness CT1 exceeding 1 mm, thereby preventing a decrease in rigidity due to external impact. In addition, since the first lens 141 is made of plastic and has an aspherical surface, even if the center thickness CT1 is designed to be thin, it can reduce the change in the refractive angle of light. The first lens 141 has a first surface S1 that is concave on the optical axis and has a radius of curvature of 10 mm or more, and the second surface S2 is formed concavely with a radius of curvature smaller than the first surface S1, so that the incident light may be refracted in a direction close to the optical axis. Accordingly, the effective diameter of the second lens 142 may be prevented from increasing. The first surface S1 of the first lens 141 may have a critical point from the optical axis OA to the end of the effective area. The position of the critical point may be arranged at a distance of 32% or more, for example, in a range of 32% to 57% or in a range of 37% to 52% of the distance from the optical axis OA of the first surface S1 to the end of the effective area. For example, the critical point is a point where the trend of the Sag value changes. That is, the point where the Sag value increases and then decreases, or the point where the Sag value decreases and then increases. The distance from the optical axis OA of the first surface S1 to the end of the effective area may be the effective radius of the first surface S1. Since the first surface S1 has a critical point, the first surface S1 can improve the incidence efficiency of light incident through various paths and refract it toward the second lens 142. The second surface S2 of the second lens 142 may be provided without a critical point from the optical axis OA to the end of the effective area.

The second lens 142 may have positive power on the optical axis OA. The second lens 142 may be made of plastic or glass material, for example, plastic material. The object-side third surface S3 of the second lens 142 on the optical axis OA may be convex, and the sensor-side fourth surface S4 may have a concave shape. The second lens 142 may have a meniscus shape convex toward the object side along the optical axis. Alternatively, the third surface S3 may be convex, and the fourth surface S4 may be convex. The second lens 142 may be provided as an aspherical lens made of plastic. The third surface S3 and the fourth surface S4 may be aspherical and may have aspherical coefficients as shown in FIG. 36.

The third lens 143 may have positive power on the optical axis OA. The third lens 143 may include a plastic or glass material, and may be, for example, a spherical lens made of glass. The fifth surface S5 of the third lens 143 on the object side along the optical axis OA may be convex, and the sixth surface S6 on the sensor side may be convex. The third lens 143 may have a biconvex shape on the optical axis OA. The fifth surface S5 and the sixth surface S6 of the third lens 143 may be spherical on the optical axis, and at least one or both of the fifth surface S5 and the sixth surface S6 may be provided without a critical point from the optical axis OA to the end of the effective area.

The aperture stop ST is a member that controls the amount of light and may be disposed around the sensor-side surface of the second lens 142. The aperture stop ST may be disposed around the area between the second lens 142 and the third lens 143. The difference in the hole diameter of the aperture stop ST and the effective diameter of the sensor-side fourth surface S4 of the second lens 142 may be less than 20%. In addition, the aperture stop ST may be disposed at a distance of 2 mm or more from the center of the fourth surface S4 of the second lens 142 and closer to the fifth surface S5 than to the fourth surface S4. Accordingly, light passing through the concave fourth surface S4 of the second lens 142 is condensed, so that even if the distance CG2 between the second and third lenses 132 and 133 increases, an increase in the effective diameter of the third lens 133 may be suppressed. When the hole diameter of the aperture stop ST is CA_ST and the effective diameter of the fourth surface S4 is CA22, the following condition may be satisfied.

$$0.8 < CA\_ST / CA 22 < 1.2 \qquad Condition$$

Preferably, 0.8<CA_ST/CA22<1 may be satisfied. For example, the hole diameter of the aperture stop ST may be smaller than the effective diameter of the sensor-side fourth surface S4 of the second lens 142, in which case the effective diameter of the third lens 143 may be suppressed from increasing. Since the hole diameter of the aperture stop ST is provided within the above range, the amount of light passing through the second lens 142 may be controlled, and the effective diameter of the seventh surface S7 of the third lens 143 may be suppressed from increasing. The effective diameter of the object-side fifth surface S5 of the third lens 143 may be larger than the hole diameter of the aperture stop ST, and the distance between the second and third lenses 142 and 143 may be controlled by the hole diameter of the aperture stop ST and the radius of curvature of the fourth surface S4.

The fourth lens 144 may have positive (+) power on the optical axis. The fourth lens 143 may include a plastic or glass material. For example, the fourth lens 144 may be made of a plastic material. On the optical axis OA, the object-side seventh surface S7 of the fourth lens 144 may have a convex shape, and the sensor-side eighth surface S8 may have a convex shape. The fourth lens 144 may have a shape in which both sides are convex on the optical axis OA. The seventh surface S7 and the eighth surface S8 of the fourth lens 144 may be aspherical on the optical axis, and the aspherical coefficient may be provided in FIG. 36. The seventh surface S7 may be provided without a critical point from the optical axis to the end of the effective area, and the eighth surface S8 may be provided without a critical point from the optical axis to the end of the effective area. Alternatively, at least one or both of the seventh surface S7 and the eighth surface S8 may have a critical point from the optical axis OA to the end of the effective area.

The fourth lens 144 may have the thickest center thickness CT4 among the lenses. The fourth lens 144 may be an aspherical lens closest to the image sensor 300. By positioning the aspherical lens closest to the image sensor 300, optical performance degradation may be prevented, aberration characteristics may be improved, and the impact on resolution may be controlled. Furthermore, by positioning the aspherical lens closest to the image sensor 300, it may be less sensitive to assembly tolerances compared to a spherical lens. In other words, being less sensitive to assembly tolerances means that even if the assembly is slightly different from the design during assembly, optical performance may not be significantly affected. In addition, the fourth lens 144 may improve assembly tolerance by providing a small difference between the center thickness CT4 and the edge thickness ET4.

The center thickness CT1 of the first lens 141 may be thinner than the edge thickness ET1. The edge thickness ET4 of the fourth lens 144 may be the thickest among the edge thicknesses of the lenses. Since the difference between the center thicknesses CT1 and CT2 of the first lens 141 and the second lens 142 is 1 mm or less, and the difference in the radius of curvature between the second surface S2 and the third surface S3 is 5 mm or less, the effective diameter of the second surface S2 of the first lens 141 may be reduced, and the center distance CG1 between the first and second lenses 141 and 142 may be reduced.

Since the second lens 142 has a convex meniscus shape toward the object, the center distance CG2 between the second lens 142 and the third lens 143 may be increased, and also, in the area between the second lens 142 and the third lens 143, the convex fourth surface S4 and the convex fifth surface S5 can face each other. Since the third lens 143 has a biconvex shape and the fourth lens 144 has a biconvex shape, the center distance CG3 between the third and fourth lenses 143 and 144 may be reduced. The center distance CG3 between the third and fourth lenses 143 and 144 may be smaller than the edge distance. The effective diameter of the fourth lens 144 may be provided to be larger than the diagonal length of the image sensor 300. Additionally, the effective diameter of each of the first, second, and third lenses 141, 142, and 143 may be provided to be larger than the diagonal length of the image sensor 300.

Referring to FIGS. 34 and 38, the value of Sag31 on the object-side fifth surface S5 of the third lens 143 may have a positive value, and the value of Sag32 on the sensor-side sixth surface S6 of the third lens 143 may have a negative value. The value of Sag41 on the object-side seventh surface S7 of the fourth lens 144 may have a positive value, and the value of Sag42 may have a negative value. The maximum Sag values of the third and fourth lenses 143 and 144 may satisfy the following conditions.

$$Max\_Sag 31 < \vert Max\_Sag32 \vert \qquad Condition 1$$

$$\vert Max\_Sag42 \vert < Max\_Sag41 \qquad Condition 2$$

$$\vert Max\_Sag32 \vert < Max\_Sag41 \qquad Condition 3$$

The Sag21 value of the object-side third surface S3 of the second lens 142 has a positive value, and the Sag22 value of the fourth surface S4 has a positive value, satisfying the condition of Max_Sag21<Max_Sag22. Similarly, the Sag value of the object-side first surface S1 of the first lens 141 is Sag11, which has a negative value from the optical axis to the critical point and a positive value in the edge region at the critical point. The Sag value of the second surface S2 is Sag12, which has a positive value, satisfying the condition of Max_Sag12>|Max_Sag11|. The value of Max_Sag12 may have the largest value among the Sag values of the object-side and sensor-side surfaces of the lenses.

As illustrated in FIG. 34, a tangent line K3 passing through an arbitrary point on the eighth surface S8 of the fourth lens 144 and a normal line K4 perpendicular to the tangent line K3 may have a predetermined tangent angle θ2 with the optical axis OA. On the eighth surface S8 in the first direction X, the maximum tangent angle θ2 may be 35 degrees or less, for example, in the range of 1 to 35 degrees or 1 to 15 degrees, relative to an axis parallel to the optical axis. On the fifth surface S5 in the first direction X, the maximum tangent angle may be 45 degrees or less, for example, in the range of 1 to 25 degrees, relative to an axis parallel to the optical axis. Here, the maximum tangential angle of the lens surfaces is 40 degrees or greater, and is the maximum tangential angle of the second surface S2, and may range from 40 degrees to 85 degrees.

As shown in FIGS. 33 and 34, the center thickness and edge thickness of the lens may satisfy the following conditions:

$$CT 1 < CT 4 \qquad Condition 1$$

$$CT 2 = CT 1 \qquad Condition 2$$

$$CT 2 < CT 3 < CT 4 \qquad Condition 2$$

$$ET 3 < ET 1 < ET 4 \qquad Condition 3$$

$$ET 3 < ET 2 < ET 1 \qquad Condition 4$$

When the aperture stop ST is disposed on the sensor-side surface of the second lens 142, the following conditions may be satisfied.

$$CA 2 < CA 3 < CA 1 \qquad Condition 1$$

$$( ImgH * 2 ) < CA 2 < CA 1 \qquad Condition 2$$

$$CA 4 < CA 3 < CA 1 \qquad Condition 3$$

$$CA 22 < CA 21 < CA 11 \qquad Condition 4$$

$$CA 22 < CA 31 < CA 32 < CA 11 \qquad Condition 5$$

$$CA 42 < CA 41 < CA 32 \qquad Condition 6$$

Since the second lens 142 disposed on the object side of the aperture stop ST has a positive power (F2>0) and a convex meniscus shape toward the object, the second lens 142 can refract incident light toward the effective area of the third lens 143. Since the second lens 142 is thin and the average absolute value of the radius of curvature is 20 mm or less, the distance between the second lens 142 and the aperture stop ST may be increased. The center distance CG2 between the second and third lenses 142 and 143 may be set to the distance between the aspherical lens and the spherical lens. This can prevent an increase in the effective diameter of the third lens 143 disposed on the sensor side of the aperture stop ST, and can provide a slim camera module within the field of view range.

As shown in FIG. 37, the thicknesses Ti, T2, T3, and T4 of the first to fourth lenses 141, 142, 143, and 144 and the distance G1, G2, and G3 between adjacent lenses may be set. The thicknesses T1, T2, T3, and T4 of each lens in the Y-axis direction from the optical axis toward the edge of each lens may be expressed at intervals of 0.1 mm or more, and the distances G1, G2, and G3 between adjacent lenses may be expressed at intervals of 0.1 mm or more. As shown in FIG. 37, the thickness T1 of the first lens 141 may gradually increase from the center to the edge. The thickness T2 of the second lens 142 may gradually increase from the center to the edge. The thickness T3 of the third lens 143 may gradually decrease from the center to the edge. The thickness T1 of the first lens 141 may gradually decrease from the center to the edge.

The distance G1 between the first and second lenses 141 and 142 may gradually decrease from the center to the edge, and the maximum distance may be greater than the center thickness of the first and second lenses 141 and 142. The distance G2 between the first and second lenses 141 and 142 may have the largest center distance CG1 and the smallest edge distance. The distance G2 between the second lens 142 and the third lens 143 may gradually increase from the center to the edge. This distance G2 may gradually decrease from the optical axis to the edge due to the difference in the radius of curvature between the concave sensor-side surface of the second lens 142 and the convex object-side surface of the third lens 143. That is, the distance G2 between the second lens 142 and the third lens 143 may have the largest center distance CG2 and the smallest edge distance. The center distance CG2 between the second and third lenses 142 and 143 may be larger than the edge thickness of the first and fourth lenses 141 and 144, and may be 80% or more of the center thickness of the fourth lens 144. The center distance CG2 between the second and third lenses 142 and 143 may be larger than the BFL. The distance G3 between the third lens 143 and the fourth lens 144 may gradually increase from the center to the edge. This distance G3 may gradually increase from the optical axis toward the edge due to the convex shape of the sensor-side surface of the third lens 143 and the convex shape of the object-side surface of the fourth lens 144. In other words, the distance G3 between the third lens 143 and the fourth lens 144 may have the smallest center distance CG3 and the largest edge distance. The center distance CG3 between the third and fourth lenses 143 and 144 may be smaller than the center thickness of the second lens 142, and the edge distance may be larger than the center thickness of the second lens 142.

FIG. 35 is an example of lens data of the optical system of the embodiment of FIG. 25. As shown in FIG. 35, the radius of curvature on the optical axis OA of the first to fourth lenses 1441, 142, 143, and 144, the center thickness CT of the lenses, the center distance CG between adjacent lenses, the refractive index on the d-line, the Abbe number, the effective radius, and the focal length may be set. The radius of curvature of each lens is the radius of curvature on the optical axis of each lens surface, and may satisfy at least one of the following conditions.

$$L 1 R 2 < \vert L 1 R 1 \vert \qquad Condition 1$$

$$\begin{matrix}L 1 R 2 < \vert L 2 R 2 \vert < L 2 R 1 & Condition 2\end{matrix}$$

$$L 1 R 2 < \vert L 3 R 2 \vert < L 3 R 1 \qquad Condition 3$$

$$L 4 R 1 < \vert L 3 R 2 \vert \qquad Condition 4$$

$$\vert L 1 R 1 \vert < \vert L 4 R 2 \vert < L 3 R 1 \qquad Condition 5$$

$$\vert L 3 R 2 \vert * 2 < L 3 R 1 < \vert L 1 R 1 \vert * 3 \qquad Condition 6$$

The difference in the radius of curvature between the fourth surface S4 of the second lens 142 and the fifth surface S5 of the third lens 143 may be set to 10 mm or more. The difference in the center thickness between the second lens 142 and the third lens 143 may be set to 2 mm or less. Accordingly, an optical system with a low Chief ray angle (CRA) may be implemented by the aperture stop ST between the second and third lenses 142 and 143. Since the center thickness CT1 of the first lens 141 is thin, 3 mm or less, and the radius of curvature of the sensor-side second surface S2 is minimal, light incident through the plastic lens may be refracted to the edge of the effective area of the last lens.

The ratio of the center thickness to the edge thickness of each lens may satisfy the following conditions:

$$0 < CT 1 / ET 1 < 1 \qquad Condition 1$$

$$0.5 < CT 2 / ET 2 < 1.5 \qquad Condition 2$$

$$1 < CT 3 / ET 3 < 3 \qquad Condition 3$$

$$1 < CT 4 / ET 4 < 2 \qquad Condition 4$$

$$0.8 < \sum CT / \sum ET < 1.3 \qquad Condition 5$$

Furthermore, the thickness of each lens may satisfy the following conditions:

$$0.8 < CT 1 / CT 2 < 1.2 \qquad Condition 1$$

$$1 < CT 4 / CT 3 < 3 \qquad Condition 2$$

$$0.1 < CT 2 / CT 3 < 1 \qquad Condition 3$$

$$0 < CT 1 / \sum CT < 0.3 \qquad Condition 4$$

$$0.2 < CT 4 / \sum CT < 0.7 \qquad Condition 5$$

In the above conditions, if CTi/ETi (i=1~4), it may be minimum when i is 1. The difference between the center thickness and the edge thickness of each lens may be set to be greater than 0.01 mm and less than 3 mm. This allows the aspherical lens to be arranged on the fourth lens 144 to refract the incident light to the periphery of the image sensor 300 without increasing the difference between the center thickness and the edge thickness of each lens. In addition, by setting the difference between the center thickness and the edge thickness of the fourth lens 144 to 1 mm or more, the difference in the radius of curvature between the object-side surface and the sensor-side surface may be designed to be large, and the assembling property of the aspherical fourth lens 144 may be improved and the influence on the optical characteristics may be reduced.

Additionally, the difference between the maximum and minimum center thicknesses of the lenses may be 2 mm or more, for example, 2 mm to 6 mm or 3 mm to 5.5 mm. Furthermore, the edge thickness of the third lens 143 made of glass may be thinner than the edge thickness of the plastic lens. Furthermore, even if the difference between the center and edge thicknesses of the second lens 142 is designed to be small, optical performance may not be degraded, and the camera module may be slim. Furthermore, since the difference between the center and edge thicknesses of each lens is not large, the influence on optical characteristics may be reduced even if at least one lens is tilted. Furthermore, the influence on thermal characteristics between the center and edge portions of the lenses may be reduced. The center distance CG3 between the third lens 143 and the fourth lens 144 is the center distance between a spherical lens and an aspherical lens, and may be 1 mm or more.

Regarding the refractive index, the refractive index of the first to fourth lenses 141-144 may be 1.5 or greater. The third lens 143 may be made of glass and have a refractive index of 1.8 or greater. The first, second, and fourth lenses 141, 142, and 144 may be made of the same plastic material. The first, second, and fourth lenses 141, 142, and 144 may be made of plastic and have a refractive index of less than 1.8. The refractive index of the third lens 143 may be greater than the refractive indices of the first, second, and fourth lenses 141, 142, and 144, respectively. The Abbe number of the third lens 143 may be greater than the Abbe numbers of the first, second, and fourth lenses 141, 142, and 144, respectively.

The focal lengths F2, F3, and F4 of the second to fourth lenses 142, 143, and 144 may have positive power, and the focal length F1 of the first lens 141 may have negative power. Accordingly, when each lens repeatedly contracts and expands as the temperature changes from low to high temperature, chromatic aberration may be corrected by the glass lenses having high heat resistance. The fourth lens 144 may use an aspherical lens to prevent resolution degradation due to temperature changes. When the focal lengths are expressed as absolute values, the focal length of the second lens 142 is the largest among the lenses and may be 30 mm or more. The focal length of the first lens 141 is the smallest among the lenses. The difference between the absolute values of the maximum focal length and the minimum focal length may be 25 mm or more. By making the absolute difference in the focal lengths of the first and second lenses 141 and 142 greater than the difference in the focal lengths of the third and fourth lenses 143 and 144, the optical system can achieve improved MTF characteristics, aberration control characteristics, and resolution characteristics within the set field of view range, and can achieve superior optical performance in the peripheral portion of the field of view.

As shown in FIG. 36, among the lenses of the lens unit 100D, the lens surface of the fourth lens 144 may include an aspherical surface having a 20th-order aspherical coefficient. For example, the fourth lens 144 may include a lens surface having a 20th-order aspherical coefficient. As described above, an aspherical surface having a 20th-order aspherical coefficient (a non-zero value) can significantly change the aspherical shape of the peripheral portion, thereby effectively compensating for optical performance in the peripheral portion of the FOV.

FIG. 39 is a graph showing the diffraction MTF at room temperature in the optical system of FIG. 25, and is a graph showing the modulation of the luminance according to the spatial frequency. As in FIG. 39, the x-axis represents the defocusing position, and the y-axis represents the MTF, and the graphs are measured from 0.000 mm to 4.000 mm in units of 0.200 mm from F1 to F23. FIG. 40 is a graph showing the aberration characteristics in the optical system of FIG. 33. In the aberration graph of FIG. 40, astigmatic field curves and distortion are graphs measured from left to right. In FIG. 40, the X-axis can represent the focal length (mm) and distortion (%), and the Y-axis can represent the height of the image. In addition, the graphs for astigmatic aberration and distortion aberration are graphs for light in a wavelength band of approximately 940 nm. In the aberration diagram of FIG. 40, it may be interpreted that the aberration correction function is better as each curve approaches the Y-axis, and in the optical system 1000 according to the embodiment, it may be seen that measurement values are adjacent to the Y-axis in almost all areas. That is, the optical system 1000 according to the embodiment has improved resolution and may have good optical performance even in the center and periphery of the FOV. Here, the low temperature is −20 degrees or lower, for example, in the range of −20 to −40 degrees, the room temperature is in the range of 22 degrees+5 degrees or in the range of 18 degrees to 27 degrees, and the high temperature may be 80 degrees or higher, for example, in the range of 80 degrees to 105 degrees. Accordingly, it may be seen that the decrease in the luminance ratio (modulation) from low temperature to high temperature is less than 10%, for example, 5% or lower, or is almost unchanged.

As shown in FIG. 41, in the optical system according to the 4th and 5th embodiments, a table showing the ambient light ratio or relative illumination (RI) from the center of the image sensor to the image height (i.e., 0 to the maximum height (MaxF=1.1F)) may be seen that the ambient light ratio from the center of the image sensor to the diagonal end (1.0F) is 60% or more, for example, 64% or more. That is, it may be seen that the difference in ambient illumination according to low temperature, room temperature, and high temperature is almost the same from the optical axis to the end of the effective area. Accordingly, since the minimum amount of light from the center to the end of the image sensor exceeds 60%, more accurate sensing values can be obtained in the entire area of the image sensor. Here, 60%<1.OF_RI<100% is satisfied, so the minimum amount of light for sensor accuracy may be secured in 1.0 field. 1.OF_RI represents the relative illumination value in 1.0 field. 0%<Max_RI<30% is satisfied, and the relative illuminance value in Max_RI, which is a 1.1 field, is set to be less than 30%, which may be set as the minimum condition to suppress measurement errors.

The optical system 1000 may be designed to enable temperature compensation for the aspherical lens even if at least one aspherical lens is used in the lens unit 100D, and can prevent a decrease in the reliability of the optical characteristics. In addition, it may be seen that the effective focal length, TD, BFL, F number (F #), diagonal FOV, etc. hardly change even when the temperature changes from room temperature to low or high temperature. Here, TD is the optical axis distance from the center of the object-side surface of the first lens 141 to the center of the sensor-side surface of the last lens 144. When the center wavelength of the infrared wavelength is 940 nm+20 nm and the distance from the first lens 141 of the camera module to the subject is 5000 mm, the optical system of the embodiment can effectively control various aberration characteristics and achieve excellent optical performance not only at the center but also at the periphery of the FOV.

The optical system 1000 according to the fourth and fifth embodiments disclosed above may satisfy at least one or more of the Mathematical Formulas described below. Accordingly, the optical system 1000 according to the embodiment may have improved optical characteristics. For example, when the optical system 1000 satisfies at least one Mathematical Formula, the optical system 1000 can effectively control aberration characteristics such as chromatic aberration and distortion aberration, and can achieve excellent optical performance not only at the center but also at the periphery of the FOV. Furthermore, the optical system 1000 may have improved resolution. In addition, the meaning of the thickness of the lens along the optical axis OA and the distance between adjacent lenses along the optical axis OA described in the mathematical formulas may be referred to the description of the embodiment disclosed above.

$$2 < C T 4 / C T 1 < 4 \qquad [ Mathematical Formula 1 ]$$

Mathematical Formula 1 can adjust the chromatic aberration of the optical system by setting the difference in the center thickness of the first and fourth lenses to be large. Preferably, 2.5<CT4/CT1<3.7 may be satisfied. Mathematical Formula 1 sets the thickness of the first plastic lens 131 and 141 and the fourth plastic lens 134 and 144, thereby improving the optical performance of the central and peripheral regions of the FOV by both lenses having aspherical surfaces.

$$1 < C G 1 / C T 1 < 3 \qquad [ Mathematical Formula 2 ]$$

Mathematical Formula 2 can establish the relationship between the center distance CG1 between the first lens 131 and 141 and the second lens 132 and 142 and the center thickness CT1 of the first lens 131 and 141. The center distance between the first and second lenses and the shape of the first lens can suppress an increase in the effective diameter of the second lens.

$$Po 1 < 0 \qquad [ Mathematical Formula 3 ]$$

In Mathematical Formula 3, Pol represents the power of the first lens 131 and may be set to have an effective focal length F smaller than the TTL for the performance of the optical system. Accordingly, the condition TTL>F may be satisfied. Furthermore, a wide field of view may be established by the focal length and effective focal length of the first lens 131 and 141. That is, the focal length of the first lens 131 and 141 is F1, and F1<0 may be satisfied.

$$Po 1 * Po 4 < 0 \qquad [ Mathematical Formula 4 ]$$

Mathematical Formula 4 optimizes resolution by setting the power Pol of the first lens 131 and 141 and the power Po4 of the fourth lens 134 and 144 to have opposite signs.

$$Po 2 * Po 3 * Po 4 > 0 \qquad [ Mathematical Formula 4 - 1 ]$$

Mathematical Formula 4-1 sets the power values of the second to fourth lenses, allowing the optical system to set resolution. Furthermore, the second to fourth lenses may have a laminated structure combining plastic and glass lenses and have the same sign.

$$1.75 < N d 3 < 2.2 \qquad [ Mathematical Formula 5 ]$$

Nd3 is the refractive index of the third lens 133 and 143 at the d-line. Since the third lens 133 and 143 is made of glass, its high refractive index allows for controlling the angle of refraction of light traveling through it.

$$L 1 R 1 < 0 \qquad [ Mathematical Formula 6 ]$$

L1R1 represents the radius of curvature of the first surface S1 of the first lens 131 and 141 on the optical axis, and may be set to be smaller than 0. If the radius of curvature of the first surface S1 of the first lens 131 and 141 satisfies Mathematical Formula 6, the shape of the optical system may be restricted. The object-side surface of the first lens 131 and 141 has a concave shape toward the object on the optical axis, and can increase the efficiency of light incident through various paths. In addition, since the condition of L1R1*L1R2<0 is satisfied, the incident light may be refracted in a direction closer to the optical axis. Accordingly, the fourth and fifth embodiments can reduce the concave radius of curvature of the second surface S2 of the first lens 131 and 141 and the effective diameter of the second lens 132 and 142 by using Mathematical Formula 6. That is, the effective diameter of the third surface S3 of the second lens 132 and 142 may be smaller than the effective diameter of the second surface S2 of the first lens 131, and the radius of curvature of the second surface S2 of the first lens 131 and 141 may be smaller than the absolute value of the radius of curvature of the first surface S1.

$$1 < C G 2 / B F L < 2 \qquad [ Mathematical Formula 7 ]$$

BFL is the optical axis distance from the center of the sensor-side surface of the last lens, i.e., the fourth lens 134, to the surface of the image sensor 300. When the optical system satisfies mathematical formula 7, the diagonal length of the image sensor 300 is set to be less than 50% of the TTL, for example, less than 40%, thereby setting the conditions for manufacturing a vehicle camera module. In addition, the BFL may set the space in which a configuration such as an optical filter 500 or an optical filter/cover glass, located between the image sensor 300 and the fourth lens 134, may be disposed. When the range of mathematical formula 7 is smaller than the lower limit, the space for placing circuit structures such as optical filters and image sensors becomes more restricted, which may make the process of assembling circuit structures such as filters and image sensors into the optical system difficult. When the range of mathematical formula 7 is larger than the upper limit, the process of assembling circuit structures such as filters and image sensors into the optical system is easy, but the TTL becomes longer, making it difficult to miniaturize the optical system. Preferably, 1<CG2/BFL<1.5 may be satisfied.

$$1 < CA 11 / CA 12 < 4 \qquad [ Mathematical Formula 8 ]$$

CA11 is the effective diameter of the object-side surface of the first lens 131 and 141, and CA12 is the effective diameter of the sensor-side surface of the first lens. By setting the effective diameter of the concave sensor-side surface of the first lens 131 and 141 to be smaller than the effective diameter of the concave object-side surface of the first lens, the distance between the first and second lenses and the effective diameter of the second lens may be adjusted. Preferably, 1.5<CA11/CA12<2 may be satisfied. The effective diameter of the object-side first surface S1 of the first lens 131 may be greater than 1.5 times the effective diameter of the second surface S2. The effective diameter of the object-side first surface S1 of the first lens 131 may be at least 1.5 times the effective diameter of the third surface S3 of the second lens 132. The effective diameter of the object-side first surface S1 of the first lens 131 may be at least 1.5 times the effective diameter of the fourth surface S4 of the second lens 132.

$$0.5 < ( CA 12 * CT 1 ) / ( CA 21 * CT 2 ) < 3 \qquad [ Mathematical Formula 9 ]$$

CA12 is the effective diameter of the sensor-side surface of the first lens 131. In Mathematical Formula 9, the difference between the values of (CA12*CT1) and (CA21*CT2) may be designed to be small, thereby improving aberration. Preferably, 1<(CA12*CT1)/(CA21*CT2)<1.5 may be satisfied.

$$0.5 < C T 4 / ( C T 2 + C T 3 ) < 2 \qquad [ Mathematical Formula 10 ]$$

Mathematical Formula 10 may be designed so that the difference between the sum of the center thickness CT4 of the fourth lens 134 and 144 and the center thicknesses CT2 and CT3 of the second and third lenses is not large. In this case, since the third lens 133 and 143 is a spherical lens, assembly performance may be improved, and since the last fourth lens 134 and 144 is an aspherical lens, spherical aberration caused by the spherical lens may be corrected. Furthermore, since the third lens is provided as a glass lens at the center of the optical system, thermal compensation may be satisfied and optical performance may be improved. Preferably, 1<CT4/(CT2+CT3)<1.5 may be satisfied.

$$1 < C T 4 / C T 3 < 3 \qquad [ Mathematical Formula 11 ]$$

Mathematical Formula 11 prevents assembly degradation, improves aberration characteristics, and suppresses the influence on optical characteristics by thinning the center thickness of the third lens 133 and 143, which is a spherical lens, and thickening the center thickness of the fourth lens 134 and 144, which is an aspherical lens. Preferably, 1.5<CT4/CT3<2.5 may be satisfied.

$$1 < CA 11 / CA 41 < 3 \qquad [ Mathematical Formula 12 ]$$

CA11 refers to the effective diameter of the first surface S1 of the first lens 131 and 141, and CA41 refers to the effective diameter of the seventh surface S7 of the fourth lens 134 and 144. When Mathematical formula 12 is satisfied, the size of the optical system 1000 may be set to control the incident light path and adjust factors affecting aberration. Preferably, Mathematical formula 12 satisfies: 1<CA11/CA41<1.7. Since the first and fourth lenses satisfy Mathematical formula 12, the difference in effective diameters between the first and fourth lenses is not significant, thereby reducing the influence of assembly and the optical influence of temperature changes.

$$1 < C A 2 / C T 2 < 5 \qquad [ Mathematical formula 13 ]$$

CA2 is the average of the effective diameters of the object-side and sensor-side surfaces of the second lens 132 and 142. When the optical system satisfies Mathematical formula 13, the center thickness of the second lens 132 and 142 having an effective diameter of 10 mm or less may be set. Preferably, 3<CA2/CT2<5 may be satisfied.

$$2 < C A 3 / C T 3 < 5 \qquad [ Mathematical Formula 13 - 1 ]$$

CA3 is the average of the effective diameters of the object-side and sensor-side surfaces of the third lens 133 and 143. If the optical system satisfies Mathematical Formula 13-1, the center thickness of the third lens 133 and 143 with an effective diameter of 8 mm or greater may be set. Preferably, 3<CA3/CT3<4.5 may be satisfied.

$$0 < CA 22 / CA 31 < 1 \qquad [ Mathematical Formula 14 ]$$

CA22 represents the effective diameter of the fourth surface S4 of the second lens 132 and 142, and CA31 represents the effective diameter of the fifth surface S5 of the third lens 133 and 143. When the optical system 1000 according to the embodiment satisfies Mathematical Formula 14, light traveling within the second lens group LG2 may be controlled, and factors affecting lens sensitivity may be set. Mathematical Formula 14 preferably satisfies: 0.4<CA22/CA31<1. Since the second and third lenses satisfy Mathematical Formula 14, the sizes for assembling the spherical lens and adjacent lenses may be set.

$$0 < CT 2 / CG 2 < 1 \qquad [ Mathematical Formula 15 ]$$

CG2 is the center distance between the second and third lenses. In Mathematical Formula 15, the TTL may be adjusted by setting the center thickness of the second lens 132 and 142 and the center distance between the second and third lenses. Here, 0<CT2/CG2<0.5 may be satisfied.

$$1 < CG 2 / CG 1 < 5 \qquad [ Mathematical Formula 16 ]$$

In Mathematical Formula 16, the TTL may be adjusted by setting the center distance between the first and second lenses to be smaller than the center distance between the second and third lenses. Here, 1<CG2/CG1<4 may be satisfied. CG2 may also be greater than 5 mm.

$$0 < \vert Max\_Sag11 \vert / Max\_Sag12 < 0.5 \qquad [ Mathematical Formula 17 ]$$

Max_Sag11 is the maximum optical axis distance from a straight line perpendicular to the optical axis OA at the center of the object-side first surface S1 of the first lens 131 and 141 to the first surface S1. Max_Sag12 is the maximum optical axis distance from a straight line perpendicular to the optical axis at the center of the sensor-side second surface S2 of the first lens 131 and 141 to the second surface S2. When the first lens 131 and 141 satisfies mathematical formula 17, the radius of curvature and the effective diameter of the object-side surface and the sensor-side surface of the first lens 131 may be set. Preferably, 0<|Max_Sag11|/Max_Sag12<0.4 may be satisfied.

$$2 < CG 2 / Max\_Sag12 < 4 \qquad [ Mathematical Formula 18 ]$$

If the optical system satisfies Mathematical Formula 18, the center distance CG1 between the first and second lenses may be set based on the maximum Sag value of the concave sensor-side surface of the first lens 131 and 141, i.e., the concave depth of the sensor-side surface. Preferably, 2.3<CG1/Max_Sag12<3.3 may be satisfied.

$$0 < \vert Max\_Sag42 \vert / Max\_Sag41 < 1 \qquad [ Mathematical Formula 19 ]$$

Mathematical Formula 19 may set the Max_Sag41 value of the object-side seventh surface S7 of the fourth lens 134 and 144 and the Max_Sag42 value of the sensor-side eighth surface S8. When the fourth lens 134 and 144 satisfies Mathematical Formula 19, the radius of curvature and effective diameter of the object-side and sensor-side surfaces of the fourth lens may be set. Furthermore, the object-side and sensor-side surfaces of the fourth lens may have a Sag value for refracting light to the entire area of the image sensor 300. Furthermore, the absolute difference between Max_Sag41 and Max_Sag42 of the fourth lens 134 and 144 of plastic material may be kept small, thereby improving assembly efficiency.

$$\vert Max\_Sag22 \vert < \vert Max\_Sag31 \vert \qquad [ Mathematical Formula 20 ]$$

Max_Sag22 is the maximum optical axis distance from a straight line perpendicular to the optical axis OA at the center of the sensor-side fourth surface S4 of the second lens 132 and 142 to the fourth surface S4. By setting the maximum Sag value of the sensor-side surface of the second lens 132 to be smaller than the maximum Sag value of the object-side surface of the third lens 133 and 143, distortion of light traveling between the second and third lenses may be reduced, and light refracted through the second lens may be uniformly incident on the entire area of the third lens.

$$1 < CA 4 / ( ImgH * 2 ) < 2 \qquad [ Mathematical Formula 21 ]$$

The Imgh value is half the diagonal length of the image sensor 300, and the average effective diameter of the fourth lens 134 and 144 may be set to be larger than the diagonal length of the image sensor 300. Furthermore, 1.2<CA4/(ImgH*2)<1.7 may be satisfied.

$$0.8 < CA 22 / ( ImgH * 2 ) < 1.2 \qquad [ Mathematical Formula 22 ]$$

Mathematical Formula 22 establishes a relationship between the effective diameter of the fourth surface S4 of the second lens 132 and 142 and the diagonal length of the image sensor 300, thereby preventing an increase in the size of the optical system.

$$0.3 < DLG 1 / DLG 2 < 1.5 \qquad [ Mathematical Formula 23 ]$$

DLG1 is the optical axis distance of the first lens group LG1, for example, the optical axis distance from the object-side surface of the first lens 131 to the sensor-side surface of the second lens 132. DLG2 is the optical axis distance of the second lens group LG2, for example, the optical axis distance from the object-side surface of the third lens 133 to the sensor-side surface of the fourth lens 134. When the optical system satisfies mathematical formula 23, the optical axis distances of five or fewer lenses may be set based on the position of the aperture stop ST. Preferably, 0.5<DLG1/DLG2<1 or DLG1<DLG2 may be satisfied. In mathematical formula 23, the optical axis distance of the second lens group DLG2 arranged on the object side of the aperture stop ST1 is provided to be greater than the optical axis distance of the first lens group LG1, thereby correcting distortion and chromatic aberration caused by the first lens 131 and 142. Since mathematical formula 23 is satisfied, aberration and distortion that may occur in an optical system having a TTL of 20 mm or more may be reduced.

$$0 < CG 1 / TTL < 0.3 \qquad [ Mathematical Formula 24 ]$$

In Mathematical Formula 24, by setting the center distance CG1 between the first and second lenses relative to the total length (TTL), the effective diameter, radius of curvature, refractive index, Abbe number, etc. of the first and second lenses may be set. Preferably, 0<CG1/TTL<0.2 may be satisfied.

$$0 < CT 3 / TTL < 0.3 \qquad [ Mathematical Formula 25 ]$$

In Mathematical Formula 25, by setting the center thickness of the third lens 133 and 143 within the above range based on TTL, light incident through the first and second lenses may be refracted to the entire area of the image sensor 300, thereby improving chromatic aberration of the optical system. Preferably, 0<CT3/TTL<0.2 may be satisfied.

$$0.5 < \vert L 2 R 1 / L 3 R 2 \vert < 3 \qquad [ Mathematical Formula 26 ]$$

L2R1 represents the radius of curvature of the third surface S3 of the second lens 132, and L3R2 represents the radius of curvature of the sixth surface S6 of the third lens 133. In Mathematical Formula 26, the power of the second and third lenses may be controlled by setting the radius of curvature of the object-side surface of the second lens and the sensor-side surface of the third lens. Accordingly, excellent optical performance may be achieved at the center and periphery of the field of view. Preferably, Mathematical Formula 26 satisfies: 0.5<|L2R1/L3R2|<2.

$$1 < L 4 R 1 / CT 4 < 10 \qquad [ Mathematical Formula 27 ]$$

L4R1 represents the radius of curvature of the seventh surface S7 of the fourth lens 134 and 144. When the optical system satisfies Mathematical Formula 27, the power of the aspherical fourth lens 134 and 144 may be controlled and assembly degradation may be prevented by setting the curvature radius and center thickness of the object-side surface of the fourth lens 134 and 144. Preferably, 1<L4R1/CT4<3 may be satisfied. The center thickness CT4 of the fourth lens 134 and 144 may be the thickest among the center thicknesses of the lenses.

$$1 < \vert L 1 R 1 \vert / L 1 R 2 < 10 \qquad [ Mathematical Formula 28 ]$$

L1R1 means the curvature radius of the object-side surface S1 of the first lens 131 and 141, and L1R2 means the curvature radius of the sensor-side surface S2 of the first lens 131 and 141. When the first lens 131 satisfies Mathematical Formula 28, the angle of refraction of light incident on the object-side surface of the first lens 131 and 141 may be adjusted. Preferably, 2<|L1R1|/L1R2<5 may be satisfied. Here, the object-side surface S1 of the first lens 131 and 141 is a concave curved surface on the optical axis and has a critical point between the center and the edge, so that the incident light may be transmitted to the second lens 132 and 142 through various paths.

$$0 < \vert L 2 R 2 / L 3 R 1 \vert < 1 \qquad [ Mathematical Formula 29 ]$$

L2R2 and L3R1 may have radii of curvature with opposite signs or the same signs on the optical axis. For example, the radius of curvature of the sensor-side surface of the second lens 132 may have a negative or positive value, and the radius of curvature of the object-side surface of the third lens 133 may have a positive value. Accordingly, by setting the radius of curvature of the two lens surfaces facing each other in the first and second lens groups, spherical aberration may be controlled. Preferably, 0.1<|L2R2/L3R1|<0.5 may be satisfied.

$$( Nd 1 * Vd 1 ) < ( Nd 3 * Vd 3 ) \qquad [ Mathematical Formula 30 ]$$

In the optical system, Nd1 and Nd3 are the refractive indices of the first and third lenses at the d-line, and Vd1 and Vd3 are the Abbe numbers of the first and third lenses. The relationship between the refractive index and Abbe number of the aspherical first lens 131 and the refractive index and Abbe number of the aspherical fourth lens 134 may be set. The first lens 131 and 141 may be made of plastic, and the fourth lens 134 and 144 may be made of plastic. By setting the refractive index and Abbe number of the first and fourth lenses, which are aspherical lenses, the light traveling through the entire area of the image sensor 300 may be guided.

$$0 < CT\_Max / CG\_Max < 1.5 \qquad [ Mathematical formula 31 ]$$

Mathematical formula 31 may set the relationship between the maximum center thickness CT_Max among the lenses and the maximum center distance CG_Max between adjacent lenses. When Mathematical formula 31 is satisfied, the optical system may have good optical performance at the focal length at the set field of view and can reduce the TTL. Preferably, 0.5<CT_Max/CG_Max<1.2 may be satisfied.

$$2 < CT\_Max / CT\_Min < 5 \qquad [ Mathematical Formula 32 ]$$

CT_Max is the maximum center thickness of the lenses, and CT_Min is the minimum center thickness of the lenses. Mathematical Formula 32 sets the difference in the center thickness of the lenses to 2 mm or more, thereby improving the assembly performance of the lenses. Preferably, 2.5<CT_Max/CT_Min<3.5 may be satisfied.

$$( CT\_Max / CT\_Min ) < ( CA\_Max / CA\_Min ) \qquad [ Mathematical Formula 33 ]$$

CA_Max is the maximum effective diameter of the lens surfaces, and CA_Min is the minimum effective diameter of the lens surfaces. Mathematical Formula 33 sets the difference in the effective diameter of the lens surfaces to be greater than the difference in the center thickness of the lenses, thereby reducing the influence of optical characteristics and preventing deterioration in assembly performance in optical systems with 5 or less or 4 or less lenses. Here, the difference in effective diameter between the object-side and sensor-side surfaces of the first lens 131 and 141 may be greater than the difference in effective diameter between the object-side and sensor-side surfaces of the second, third, and fourth lenses, respectively. Thus, by adjusting the effective diameter and radius of curvature of the object-side and sensor-side surfaces of each lens, the angle of refraction of light traveling through five or fewer or four or fewer lenses may be adjusted.

$$1 < \sum CT / \sum CG < 4 \qquad [ Mathematical Formula 34 ]$$

In Mathematical Formula 34, ΣCT is the sum of the center thicknesses of the lenses, and ΣCG is the sum of the center distances between adjacent lenses. When Mathematical Formula 34 is satisfied, the optical system can exhibit good optical performance at a focal length and a set field of view, and can reduce the TTL. Preferably, the embodiment satisfies 1<ΣCT/ΣCG<2.

$$1 < \sum Nd < 10 \qquad [ Mathematical Formula 35 ]$$

ΣNd represents the sum of the refractive indices at the d-line of each of the plurality of lenses. When mathematical formula 35 is satisfied, TTL may be controlled in an optical system 1000 comprising a mixture of aspherical and spherical lenses, and improved resolution may be achieved. In addition, the number of lenses may be reduced by arranging glass lenses with relatively high refractive indices and plastic lenses with relatively low refractive indices in the optical axis direction. Mathematical Formula 35 preferably satisfies: 5<ΣNd<8.

$$5 < \sum Vd / \sum Nd < 30 \qquad [ Mathematical Formula 36 ]$$

ΣVd represents the sum of the Abbe numbers of each of the plurality of lenses. When Mathematical formula 36 is satisfied, the optical system 1000 may have improved aberration characteristics and resolution. In Mathematical formula 36, optical characteristics may be controlled by setting the Abbes sum and the sum of the refractive indices of the lenses, and preferably, 10<ΣVd/ΣNd<15 may be satisfied.

$$1 < CA 11 / CA\_Min < 4 \qquad [ Mathematical formula 37 ]$$

CA11 represents the effective diameter of the object-side surface of the first lens 131, and CA_Min represents the minimum effective diameter between the object-side and sensor-side surfaces of the lenses. When Mathematical formula 37 is satisfied, the optical system can control incident light, maintain optical performance, and provide a slimmer module. Mathematical formula 37 preferably satisfies: 1.5<CA11/CA_Min<3.

$$0.8 < CA\_ST / CA 22 < 1.2 \qquad [ Mathematical Formula 38 ]$$

CA_ST is the hole diameter of the aperture stop ST positioned around the perimeter between the second and third lenses. By adjusting the hole diameter of the aperture stop ST and the effective diameter of the sensor-side surface of the second lens, unnecessary light may be blocked and the amount of internal light may be controlled. Preferably, 0.8<CA_ST/CA22<1 may be satisfied.

$$0 < CA\_ST / CA 31 < 1 \qquad [ Mathematical Formula 39 ]$$

Mathematical Formula 39 can establish the relationship between the hole diameter of the aperture stop ST and the effective diameter of the object-side surface of the third lens 133 and 143. Accordingly, the aperture stop ST can control the amount of light traveling to the object-side surface of the third lens 133 and 143 and block light that exceeds the 1.0 field of view of the image sensor 300. Preferably, 0.2<CA_ST/CA31<0.8 may be satisfied.

$$1.5 < CA 11 / CA\_ST < 3 \qquad [ Mathematical Formula 40 ]$$

Mathematical Formula 40 can establish a relationship between the hole diameter of the aperture stop ST and the effective diameter of the object-side surface of the first lens 131 and 141. Accordingly, the aperture stop ST can control the amount of light passing through the object-side surface of the first lens 131 and 141. Preferably, 2<CA11/CA_ST<2.5 may be satisfied.

$$1 < CA\_Max / ( 2 * ImgH ) < 3 \qquad [ Mathematical Formula 41 ]$$

Mathematical Formula 41 may be set to the maximum effective diameter CA_Max among the lens surfaces and the diagonal length of the image sensor. If this is satisfied, the optical system can maintain good optical performance and set a size for a slim and compact structure. Preferably, 1<CA_Max/(2*ImgH)<2 may be satisfied.

$$1 < TD / CA\_Max < 3 \qquad [ Mathematical formula 42 ]$$

TD is the optical axis distance from the center of the object-side surface of the first lens 131 to the center of the sensor-side surface of the fourth and last lens 134. Specifically, TD is the maximum optical axis distance of the lenses. When Mathematical formula 42 is satisfied, the total optical axis distance of the lenses and the maximum effective diameter of the lens surfaces may be set, thereby setting a size for good optical performance. Mathematical formula 42 preferably satisfies: 1.5<TD/CA_Max<2.5.

$$TD > SD \qquad [ Mathematical formula 42 - 1 ]$$

The SD is the optical axis distance from the position of the aperture stop ST to the center of the sensor-side surface of the last lens.

$$0 < CT\_Max / TD < 0.7 \qquad [ Mathematical Formula 43 ]$$

Mathematical Formula 43 sets the maximum center thickness and maximum optical axis distance (TD) of the lenses, improving optical performance. Preferably, 0<CT_Max/TD<0.5 may be satisfied.

$$0 < F / CA 41 < 0.5 \qquad [ Mathematical Formula 44 ]$$

F represents the effective focal length (EFL) of the optical system and may be less than 10 mm, for example, in the range of 1 mm to 10 mm. By setting the relationship between the effective focal length and the effective diameter of the object side of the last aspherical lens in Equation 44, the effect on the optical system reduction, such as TTL, can be adjusted. Mathematical Formula 44 preferably satisfies: 0<F/CA41<0.2 or 0<F/CA41<0.1.

$$0 < F / \vert L 1 R 1 \vert < 0.3 \qquad [ Mathematical Formula 45 ]$$

In Mathematical Formula 44, the effective focal length of the optical system and the radius of curvature of the object-side surface of the first lens are set, thereby controlling the influence on incident light and TTL. Mathematical Formula 45 preferably satisfies: 0<F/|L1R1|<0.2 or 0<F/|L1R1|<0.1.

$$1 < Max ( CT / ET ) < 3 \qquad [ Mathematical Formula 46 ]$$

Max(CT/ET) represents the maximum value of the ratio of the center thickness to the edge thickness of each lens. When Mathematical Formula 46 is satisfied, the optical system can control the influence on the effective focal length and improve assembly. Mathematical Formula 46 preferably satisfies: 1.5<Max(CT/ET)<2.5. The lens having the Max(CT/ET) value may be a glass lens adjacent to the third lens 133 and 143 or the last lens.

$$0 < EPD / \vert L 1 R 1 \vert < 1 \qquad [ Mathematical Formula 47 ]$$

EPD refers to the size (mm) of the entrance pupil diameter of the optical system 1000. When the optical system 1000 according to the embodiment satisfies Mathematical Formula 47, the optical system 1000 can control incident light. Mathematical Formula 47 preferably satisfies: 0<EPD/|L1R1|<0.5. It may also satisfy EPD<BFL.

$$0.1 < \vert F 1 / F 4 \vert < 1 \qquad [ Mathematical Formula 48 ]$$

F1 is the focal length of the first lens, and F4 is the focal length of the fourth lens. When mathematical formula 48 is satisfied, the resolution may be improved by controlling the power of the first and fourth lenses, and the TTL and effective focal length F may be affected. Preferably, 0.2<|F1/F4|<0.8 may be satisfied. Accordingly, the power of each lens may be controlled to effectively guide light to the aspherical lens. The aperture stop ST is arranged on the sensor-side surface of the second lens 132. The focal lengths of the lenses arranged on both sides of the aperture stop ST are greater than 0. The focal length F2 of the second and third lenses must be designed to be greater than 0. The composite focal length F34 of the third and fourth lenses 133 and 134 may have positive power. That is, the composite focal length F34 of the two lenses arranged on the sensor side relative to the aperture stop ST is designed to be greater than 0. In this case, the optical system may be miniaturized by reducing TTL when the horizontal field of view (FOV_H) is 90 degrees or more.

$$1 < F 2 / F 4 < 15 \qquad [ Mathematical Formula 49 ]$$

F2 is the focal length of the second lens, and F4 is the focal length of the fourth lens. That is, since the signs of the focal lengths of the first and second lenses are positive and have the above-mentioned difference, aberrations may be improved, and light may be effectively guided by the aspherical lens. Preferably, 1<F2/F4<1 may be satisfied.

$$3 < \vert Vd 3 - Vd 4 \vert < 15 \qquad [ Mathematical Formula 50 ]$$

In Mathematical Formula 50, Vd3 is the Abbe number of the third lens, and Vd4 is the Abbe number of the fourth lens. When Mathematical Formula 50 is satisfied, the difference in Abbe numbers between adjacent two lenses may be maintained above a certain value, thereby improving chromatic aberration. Mathematical Formula 50 preferably satisfies: Vd3>Vd4. That is, the Abbe number of the glass material may be set higher than that of the plastic lens.

$$F 12 * F 34 < 0 \qquad [ Mathematical Formula 51 ]$$

In Mathematical Formula 51, the composite focal lengths F12 of the first and second lenses and the focal lengths F34 of the third and fourth lenses are set with opposite signs, thereby controlling the power of the lenses to improve resolution and provide a slim and compact optical system.

$$20 mm < TTL < 40 mm \qquad [ Mathematical Formula 52 ]$$

TTL refers to the distance (mm) from the center of the first surface S1 of the first lens 131 to the surface of the image sensor 300 along the optical axis OA. By setting TTL to less than 40 mm in Mathematical Formula 52, a miniaturized vehicle optical system may be provided. Preferably, the relationship 23 mm<TTL<37 mm may be satisfied.

$$2 mm < ImgH \qquad [ Mathematical Formula 53 ]$$

Mathematical Formula 53 may set the diagonal length of the image sensor 300 to half, providing an optical system having a vehicle sensor size. Preferably, Mathematical Formula 53 satisfies the condition:

$$3 mm < ImgH < 5 mm .$$

$$3 mm < BFL < 8 mm \qquad [ Mathematical Formula 54 ]$$

In Mathematical Formula 54, the BFL is set to be greater than 3 mm and less than 8 mm. This secures installation space for the optical filter 500 or the optical filter and cover glass. Furthermore, the distance between the image sensor 300 and the last lens improves the assembling of components and enhances joint reliability. Mathematical Formula 54 preferably satisfies the condition: 4 mm<BFL<7.5 mm. If the BFL falls below the range of Mathematical Formula 54, some of the light traveling to the image sensor may not be transmitted to the image sensor, which may result in a decrease in resolution. If the BFL exceeds the range of Mathematical Formula 54, stray light may be introduced, degrading the aberration characteristics of the optical system.

$$0.5 < BFL / CG 2 < 1.5 \qquad [ Mathematical Formula 55 ]$$

In Mathematical Formula 55, by setting the center distance CG2 between the BFL and the second and third lenses, the joint reliability of the components may be improved depending on the installation space of the optical filter 500 or/and the cover glass and the distance between the glass lenses. In Mathematical Formula 55, 0.5<BFL/CG2<1 may be satisfied. The center distance CG2 between the second and third lenses may be the largest among the center distances between the lenses.

$$0 < CT 1 / BFL < 1 \qquad [ Mathematical Formula 56 ]$$

In Mathematical Formula 56, the BFL is set to be greater than the center thickness of the first lens 131, thereby securing installation space for the optical filter 500 and/or cover glass. Furthermore, the distance between the image sensor 300 and the last lens improves the assembling of components and enhances joint reliability. If the BFL does not satisfy Mathematical Formula 56, some of the emitted light may not be transmitted to the effective area of the image sensor, thereby degrading the resolution. Preferably, 0.3<CT1/BFL<0.9 may be satisfied.

$$2 mm < F < 8 mm \qquad [ Mathematical Formula 57 ]$$

Mathematical Formula 57 may set the overall effective focal length F to suit a vehicle optical system. Mathematical Formula 57 may satisfy the range of 2 mm<F<6 mm.

$$80 degrees < FOV < 150 degrees \qquad [ Mathematical Formula 58 ]$$

In Mathematical Formula 58, FOV (Field of View) refers to the diagonal field of view (Degree) of the optical system 1000, and a vehicle optical system having an angle exceeding 80 degrees may be provided. Preferably, 90 degrees<FOV<135 degrees may be satisfied. The FOV may be a minimum value for the reception performance range. Here, the horizontal field of view of the optical system 1000 may be smaller than the diagonal field of view and may be larger than 90 degrees, and the vertical field of view may be smaller than the horizontal field of view and may be larger than 70 degrees. The reception performance range may be improved by these horizontal and vertical angles of view.

$$1 < TTL / CA\_Max < 3 \qquad [ Mathematical Formula 59 ]$$

CA_Max refers to the largest effective diameter (mm) among the object-side and sensor-side surfaces of the plurality of lenses. Mathematical formula 59 establishes a relationship between the overall optical axis length of the optical system and the maximum effective diameter, thereby providing an improved vehicle optical system. Mathematical formula 59 preferably satisfies: 1.8<TTL/CA_Max<3. Here, CA_Max is the effective diameter of the object-side surface of the first lens.

$$5 < TTL / ImgH < 10 \qquad [ Mathematical formula 60 ]$$

Mathematical formula 60 can establish the overall optical axis length (TTL) of the optical system and the diagonal length (ImgH) from the optical axis of the image sensor 300. When the optical system 1000 according to the embodiment satisfies Mathematical formula 60, the optical system 1000 may have a TTL for application to the vehicle image sensor 300, thereby providing improved image quality. Mathematical formula 60 preferably satisfies: 6<TTL/ImgH<9.

$$1 < BFL / ImgH < 3 \qquad [ Mathematical Formula 61 ]$$

Mathematical Formula 61 may establish a relationship between the optical axis distance (BFL) between the image sensor 300 and the last lens and the diagonal length from the optical axis of the image sensor 300. When the optical system 1000 according to the embodiment satisfies mathematical formula 61, the optical system 1000 can secure a BFL suitable for the size of the vehicle image sensor 300, set the distance between the last lens and the image sensor 300, and achieve good optical characteristics at the center and periphery of the FOV. Mathematical Formula 61 preferably satisfies: 1<BFL/ImgH<2, and may satisfy the condition of BFL>ImgH.

$$1 < TTL / BFL < 10 \qquad [ Mathematical Formula 62 ]$$

Mathematical Formula 62 may set the total optical axis length (TTL) of the optical system and the optical axis distance (BFL) between the image sensor 300 and the last lens. If the optical system 1000 according to the embodiment satisfies Mathematical Formula 62, the optical system 1000 can secure BFL. That is, by setting the TTL to less than 40 mm, a sufficient BFL may be secured, thereby providing an optical system for a vehicle. Mathematical Formula 62 preferably satisfies: 3<TTL/BFL<8.

$$5 < TTL / F < 15 \qquad [ Mathematical Formula 63 ]$$

Mathematical Formula 63 may set the total focal length (F) and total optical axis length (TTL) of the optical system 1000. Accordingly, an optical system for a driver assistance system or driver monitoring may be provided. Mathematical formula 63 preferably satisfies 6<TTL/F<10. When the optical system 1000 according to the embodiment satisfies Mathematical formula 63, the optical system 1000 may have an appropriate focal length within a set TTL range, and can provide an optical system that can form an image while maintaining an appropriate focal length even when the temperature changes from low to high temperatures. If it is below the lower limit of Mathematical formula 63, the power of the lenses needs to be increased, making it difficult to correct spherical aberration or distortion aberration. If it is above the upper limit of Mathematical formula 63, the effective diameter or TTL of the lenses may become longer, which may cause a problem of the imaging lens system becoming larger.

$$0 < F / BFL < 2 \qquad [ Mathematical formula 64 ]$$

Mathematical formula 64 may set the overall effective focal length (F) of the optical system 1000 and the optical axis distance (BFL) between the image sensor 300 and the last lens. When the optical system 1000 according to the embodiment satisfies mathematical formula 64, the optical system 1000 may have a set field of view and an appropriate focal length, and can provide an optical system for a vehicle. In addition, the optical system 1000 can minimize the distance between the last lens and the image sensor 300, and thus may have good optical characteristics in the periphery of the FOV. Mathematical formula 64 can preferably satisfy: 0.4<F/BFL<1.

$$0 < F / ImgH < 2 \qquad [ Mathematical Formula 65 ]$$

Mathematical Formula 65 may set the overall effective focal length (F) of the optical system 1000 and a value (ImgH) equal to half the diagonal length of the image sensor 300. This optical system 1000 may have improved aberration characteristics in the size of the vehicle image sensor 300. Preferably, Mathematical Formula 65 satisfies 0.5<F/ImgH<1.

$$0 < F / EPD < 2 \qquad [ Mathematical Formula 66 ]$$

Mathematical Formula 66 may set the overall effective focal length (F) and the entrance pupil size of the optical system 1000. Accordingly, the overall brightness of the optical system may be controlled. Preferably, Mathematical Formula 66 may set 0.8<F/EPD<1.5.

$$0 < BFL / TD < 0.5 \qquad [ Mathematical formula 67 ]$$

Mathematical formula 67 may set the relationship between the optical axis distance (TD) and the back focal distance (BFL) of the lenses of the optical system 1000. Accordingly, the resolution of the optical system may be maintained while controlling the overall size. Mathematical formula 67 can preferably satisfy: 0<BFL/TD<0.4. If the conditional value of BFL/TD exceeds 0.5, the BFL is designed to be large compared to the TD, so the size of the entire optical system increases, making it difficult to miniaturize the optical system. In addition, the distance between the third lens and the image sensor increases, so that an unnecessary amount of light may increase between the fourth lens and the image sensor, resulting in a problem of lowering the resolution, such as deterioration of aberration characteristics.

$$0 < EPD / ImgH / FOV < 0.2 \qquad [ Mathematical Formula 68 ]$$

Mathematical Formula 68 may set the relationship between the EPD, the length of the image sensor's diagonal length (ImgH), and the diagonal field of view. Accordingly, the overall size and brightness of the optical system may be controlled. Mathematical Formula 68 preferably satisfies: 0<EPD/ImgH/FOV<0.05.

$$50 < FOV / F \# \qquad [ Mathematical Formula 69 ]$$

Mathematical Formula 69 may set the relationship between the diagonal field of view and the F number of the optical system. Mathematical Formula 69 preferably satisfies: 70<FOV/F #. Here, F # is provided to be 2.0 or less or 1.5 or less, thereby providing a bright image.

$$80 < TTL * nL < 150 \qquad [ Mathematical Formula 70 ]$$

Mathematical Formula 70 may set the number of lenses by multiplying the total length of the optical system by the total number of lenses (nL). Preferably, Mathematical Formula 70 satisfies: 100<TTL*nL<140. Color dispersion and refraction angles may be controlled by glass lenses in an optical system with a TTL of less than 40 mm.

$$50 < BFL * ImgH * nL < 100 \qquad [ Mathematical Formula 71 ]$$

Mathematical Formula 71 may set the length of the image sensor and the center distance between the image sensor and the lenses based on the number nL of lenses of the lenses by multiplying the BFL, which is half the diagonal length of the image sensor. Preferably, Mathematical Formula 71 satisfies: 60<BFL*ImgH*nL<90. In an optical system with an ImgH of less than 5 mm, chromatic dispersion and refraction angle may be controlled by glass lenses.

$$0.3 \leq Nss / Nass \leq 1 \qquad [ Mathematical Formula 72 ]$$

Mathematical Formula 72 may set a number Nss of spherical surfaces and a number Nass of aspherical surfaces among the lens surfaces. When Mathematical Formula 72 is satisfied, light may be guided to the entire area of the image sensor by adjusting the spherical and aspherical lens surfaces of the lenses.

The optical system 1000 according to the fourth and fifth embodiments may satisfy at least one or two of Mathematical Formulas 1 to 36. At least one or two of Mathematical Formulas 1 to 46 may satisfy at least one or two of Mathematical Formulas 37 to 72. In this case, the optical system 1000 may have improved optical characteristics. In detail, when the optical system 1000 satisfies at least one of mathematical formulas 1 to 36 and/or at least one of mathematical formulas 37 to 72, the optical system 1000 has improved resolution and can improve aberration and distortion characteristics. In addition, the optical system 1000 can secure BFL for applying a vehicle image sensor 300, can compensate for optical characteristic degradation due to temperature change, and can minimize the distance between the last lens and the image sensor 300, thereby providing good optical performance at the center and periphery of the field of view (FOV).

Table 4 shows the items of the mathematical formulas described above in the optical system 1000 of the embodiment, including the TTL, BFL, effective focal length (F) (mm), ImgH (mm), effective diameter (CA), thickness, TD which is the optical axis distance from the first surface S1 to the eighth surface S8, the focal lengths F1, F2, F3, and F4 of each of the first to third lenses, the sum of the refractive indices, the sum of the Abbe numbers, the sum of the center thicknesses of each lens, the sum of the distances between adjacent lenses, the diagonal FOV (Degree), the edge thickness (ET), the focal lengths of the first and second lens groups, and the F number, etc. of the optical system 1000.

TABLE 4

| | | | | Embodiment | Embodiment |
|---|---|---|---|---|---|
| Items | Embodiment 4 | Embodiment 5 | Items | 4 | 5 |
| F | 3.831 | 3.831 | ET1 | 4.498 | 3.609 |
| F1 | −7.365 | −7.594 | ET2 | 1.717 | 2.480 |
| F2 | 22.275 | 101.478 | ET3 | 1.488 | 1.543 |
| F3 | 13.733 | 11.134 | ET4 | 3.988 | 5.082 |
| F4 | 14.286 | 12.658 | F# | 1.100 | 1.100 |
| FLG1 | −18.287 | −7.837 | FOV | 127.482 | 121.627 |
| | | | (Diagonal) | | |
| FLG2 | 7.193 | 6.885 | EPD | 3.483 | 3.489 |
| ΣNd | 7.404 | 7.033 | BFL | 5.043 | 4.957 |
| ΣVd | 90.087 | 88.146 | TD | 25.107 | 25.193 |
| ΣCT | 13.674 | 14.061 | ImgH | 4.000 | 4.000 |
| ΣCG | 11.433 | 11.132 | SD | 15.924 | 14.417 |
| ΣET | 11.691 | 12.714 | TTL | 30.150 | 30.150 |

Table 5 shows the results for the mathematical formulas 1 to 36 described above in the optical system 1000 of the embodiment. Referring to Table 5, it may be seen that the optical system 1000 satisfies at least one, two, or three or more of the mathematical formulas 1 to 36. Accordingly, the optical system 1000 may have good optical performance and superior optical characteristics at the center and periphery of the FOV.

TABLE 5

| Mathematical formulas | | Embodiment 4 | Embodiment 5 |
|---|---|---|---|
| 1 | 2 < CT4/CT1 < 4 | 2.786 | 3.458 |
| 2 | 1 < CG1/CT1 < 3 | 2.187 | 1.214 |
| 3 | Po1 < 0 | Satisfaction | Satisfaction |
| 4 | Po1 * Po4 < 0 | Satisfaction | Satisfaction |
| 5 | 1.75 < Nd3 < 2.2 | 2.051 | 2.051 |
| 6 | L1R1 < 0 | −19.845 | −22.926 |
| 7 | 1 < CG2/BFL < 2 | 1.284 | 1.386 |
| 8 | 1 < CA11/CA12 < 4 | 1.755 | 1.797 |
| 9 | 0.5 < (CA12*CT1)/(CA21*CT2) < 3 | 1.265 | 1.014 |
| 10 | 0.5 < CT4/(CT2 + CT3) < 2 | 1.178 | 1.344 |
| 11 | 1 < CT4/CT3 < 3 | 1.901 | 2.198 |
| 12 | 1 < CA11/CA41 < 3 | 1.142 | 1.499 |
| 13 | 1 < CA2/CT2 < 5 | 3.645 | 4.518 |
| 14 | 0 < CA22/CA31 < 1 | 0.536 | 0.748 |
| 15 | 0 < CT2/CG2 < 1 | 0.309 | 0.291 |
| 16 | 1 < CG2/CG1 < 5 | 1.332 | 2.831 |
| 17 | 0 < \|Max_Sag11\|/Max_Sag12 < 0.5 | 0.102 | 0.346 |
| 18 | 2 < CG2/Max_Sag12 < 4 | 2.684 | 2.886 |
| 19 | 0 < \|Max_Sag42\|/Max_Sag41 < 1 | 0.186 | 0.110 |
| 20 | \|Max_Sag22\| < \|Max_Sag31\| | Satisfaction | Satisfaction |
| 21 | 1 < CA4/(ImgH*2) < 2 | 1.571 | 1.346 |
| 22 | 0.8 < CA22/(ImgH*2) < 1.2 | 0.884 | 1.052 |
| 23 | 0.3 < DLG1/DLG2 < 1.5 | 0.951 | 0.541 |
| 24 | 0 < CG1/TTL < 0.3 | 0.161 | 0.081 |
| 25 | 0 < CT3/TTL < 0.3 | 0.108 | 0.104 |
| 26 | 0.5 < \|L2R1/L3R2\| < 3 | 1.856 | 0.772 |
| 27 | 1 < L4R1/CT4 < 10 | 1.637 | 1.441 |
| 28 | 1 < \|L1R1\|/L1R2 < 10 | 3.004 | 3.636 |
| 29 | 0 < \|L2R2/L3R1\| < 1 | 0.314 | 0.228 |
| 30 | (Nd1*Vd1) < (Nd3*Vd3) | Satisfaction | Satisfaction |
| 31 | 0 < CT_Max/CG_Max < 1.5 | 0.957 | 1.006 |
| 32 | 2 < CT_Max/CT_Min < 5 | 3.097 | 3.458 |
| 33 | (CT_Max/CT_Min) < (CA_Max/CA_Min) | Satisfaction | Satisfaction |
| 34 | 1 < ΣCT/ΣCG < 4 | 1.196 | 1.263 |
| 35 | 1 < ΣNd < 10 | 7.404 | 7.033 |
| 36 | 5 < ΣVd/ΣNd < 30 | 12.167 | 12.534 |

Table 6 shows the results for the mathematical formulas 37 to 72 described above in the optical system 1000 of the embodiment. Referring to Table 3, it may be seen that the optical system 1000 satisfies at least one, two, or three of the mathematical formulas 37 to 72. Accordingly, the optical system 1000 may have good optical performance and superior optical characteristics at the center and periphery of the FOV.

TABLE 6

| Mathematical formulas | | Embodiment 1 | Embodiment 2 |
|---|---|---|---|
| 37 | 1 < CA11/CA_Min < 4 | 2.200 | 2.364 |
| 38 | 0.8 < CA_ST/CA22 < 1.2 | 0.964 | 0.885 |
| 39 | 0 < CA_ST/CA31 < 1 | 0.517 | 0.661 |
| 40 | 1.5 < CA11/CA_ST < 3 | 2.200 | 2.364 |
| 41 | 1 < CA_Max/(2*ImgH) < 3 | 1.719 | 1.489 |
| 42 | 1 < TD/CA_Max < 3 | 1.826 | 2.114 |
| 43 | 0 < CT_Max/TD < 0.7 | 0.247 | 0.274 |
| 44 | 0 < F/CA41 < 0.5 | 0.084 | 0.094 |
| 45 | 0 < F/\|L1R1\| < 0.3 | 0.055 | 0.048 |
| 46 | 1 < Max (CT/ET) < 3 | 2.189 | 2.039 |
| 47 | 0 < EPD/\|L1R1\| < 1 | 0.175 | 0.152 |
| 48 | 0.1 < \|F1/F4\| < 1 | 0.516 | 0.600 |
| 49 | 1 < F2/F4 < 15 | 1.559 | 8.017 |
| 50 | 3 < \|Vd3 − Vd4\| < 15 | 8.805 | 6.541 |
| 51 | F12* F34 < 0 | Satisfaction | Satisfaction |
| 52 | 20 < TTL < 40 | 30.150 | 30.150 |
| 53 | 2 < ImgH | 4.000 | 4.000 |
| 54 | 3 < BFL < 8 | 5.043 | 4.957 |
| 55 | 0.5 < BFL/CG2 < 1.5 | 0.779 | 0.721 |
| 56 | 0 < CT1/BFL < 1 | 0.441 | 0.403 |
| 57 | 2 < F < 8 | 3.831 | 3.831 |
| 58 | 80 < FOV < 150 | 127.48 | 121.63 |
| 59 | 1 < TTL/CA_Max < 3 | 2.192 | 2.531 |
| 60 | 5 < TTL/ImgH < 10 | 7.538 | 7.538 |
| 61 | 1 < BFL/ImgH < 3 | 1.261 | 1.239 |
| 62 | 1 < TTL/BFL < 10 | 5.979 | 6.082 |
| 63 | 5 < TTL/F < 15 | 7.870 | 7.870 |
| 64 | 0 < F/BFL < 2 | 0.760 | 0.773 |
| 65 | 0 < F/ImgH < 2 | 0.958 | 0.958 |
| 66 | 0 < F/EPD < 2 | 1.100 | 1.098 |
| 67 | 0 < BFL/TD < 0.5 | 0.201 | 0.197 |
| 68 | 0 < EPD/Imgh/FOV < 0.2 | 0.009 | 0.009 |
| 69 | 50 < FOV/F# | 115.892 | 110.570 |
| 70 | 80 < TTL*nL < 150 | 120.600 | 120.600 |
| 71 | 50 < BFL*ImgH*nL < 100 | 80.682 | 79.319 |
| 72 | 0.3 ≤ Nss/Nass ≤ 1 | Satisfaction | Satisfaction |

Table 7 compares the changes in optical characteristics such as EFL, BFL, F-number, TTL, and diagonal FOV at room temperature, low temperature, and high temperature in the optical system according to the fourth and fifth embodiments. It may be seen that the change rate of optical characteristics at low temperature is 5% or less, for example, 3% or less, based on room temperature, and it may be seen that the change rate of optical characteristics at low temperature is 5% or less, for example, 3% or less, based on room temperature.

TABLE 7

| | | | | Low temperature/ | High temperature/ |
|---|---|---|---|---|---|
| | Room | Low | High | Room temperature | Room temperature |
| | temperature | temperature | temperature | (%) | (%) |
| Embodiment | | | | | |
| 4 | | | | | |
| EFL | 3.83 | 3.78 | 3.89 | 98.80% | 101.64% |
| BFL | 5.04 | 5.04 | 5.05 | 99.91% | 100.12% |
| F# | 1.10 | 1.09 | 1.11 | 99.33% | 100.91% |
| TTL | 30.15 | 30.11 | 30.21 | 99.86% | 100.19% |
| FOV | 127.48 | 129.41 | 124.97 | 101.52% | 98.03% |
| Embodiment | | | | | |
| 5 | | | | | |
| EFL | 3.83 | 3.79 | 3.89 | 98.87% | 101.53% |
| BFL | 4.96 | 4.95 | 4.96 | 99.90% | 100.14% |
| F# | 1.10 | 1.09 | 1.11 | 99.45% | 100.74% |
| TTL | 30.15 | 30.10 | 30.22 | 99.84% | 100.22% |
| FOV | 121.84 | 123.28 | 119.93 | 101.19% | 98.43% |

Therefore, as shown in Table 7, the changes in optical characteristics due to temperature changes from low to high temperatures, such as the change rate of the effective focal length (EFL), TTL, BFL, F number (F #), and diagonal FOV, are less than 10%, i.e., less than 5%, for example, in the range of 0 to 5%. This design allows temperature compensation for aspherical lenses, even when using at least one or two aspherical lenses, thereby preventing a decrease in the reliability of optical characteristics. Furthermore, it may be seen that the effective focal length, TTL, BFL, F number (F #), and diagonal FOV show little change even when the temperature changes from room temperature to low or high. The optical system of the disclosed embodiment can effectively control aberration characteristics such as chromatic aberration and distortion aberration, and can achieve excellent optical performance not only at the center but also at the periphery of the FOV.

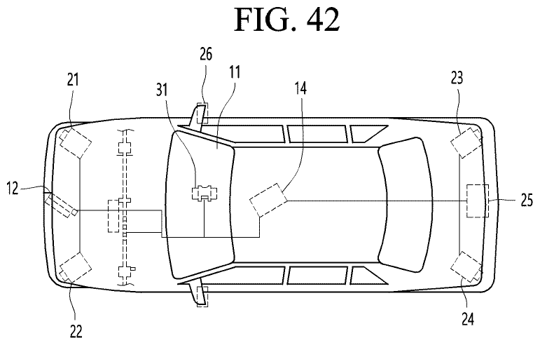

FIG. 42 is an example of a plan view of a vehicle, which is a mobile or electronic device, to which a camera module or optical system according to an embodiment of the present invention is applied.

Referring to FIG. 42, a vehicle camera system according to an embodiment of the present invention includes an image generation unit 11, a first information generation unit 12, a second information generation unit 21, 22, 23, 24, 25, and 26, and a control unit 14. The image generation unit 11 may include at least one camera module 31 positioned in the vehicle and may capture images of the front of the vehicle and/or the driver to generate a front image or an interior image of the vehicle. The image generation unit 11 may use the camera module 31 to capture images of the vehicle's surroundings in one or more directions, as well as the front of the vehicle, to generate an image of the vehicle's surroundings. Here, the front image and surrounding images may be digital images and may include color images, black-and-white images, infrared images, and the like. Furthermore, the front image and surrounding images may include still images and moving images. The image generation unit 11 provides driver images, forward images, and surrounding images to the control unit 14. Next, the first information generation unit 12, which may include at least one radar and/or camera installed in the vehicle, detects the area ahead of the vehicle and generates first detection information. Specifically, the first information generation unit 12 is installed in the vehicle and detects the location and speed of vehicles located in front of the vehicle, the presence and location of pedestrians, and other factors to generate first detection information.

Using the first detection information generated by the first information generation unit 12, the vehicle may be controlled to maintain a constant distance between the vehicle and the preceding vehicle. This can enhance vehicle operation stability in specific, preset situations, such as when the driver changes lanes or when backing up. The first information generation unit 12 provides the first detection information to the control unit 14. The second information generation unit 21, 22, 23, 24, 25, and 26 detects each side of the own vehicle based on the front image generated by the image generating unit 11 and the first detection information generated by the first information generation unit 12 to generate second detection information. Specifically, the second information generation unit 21, 22, 23, 24, 25, and 26 may include at least one radar and/or camera disposed in the own vehicle, and may detect the position and speed of vehicles located on the side of the own vehicle or capture images. Here, the second information generation units 21, 22, 23, 24, 25, and 26 may be disposed at each of the front corners, side mirrors, and the rear center and rear corners of the own vehicle.

At least one information generating unit of these vehicle camera systems may include the optical system and the camera module having the same as described in the above-described embodiments, and may provide or process information acquired through the front, rear, each side, or corner area of the vehicle to a user to enable autonomous driving or to protect the vehicle and objects from surrounding safety. The optical system of the camera module according to the embodiment of the invention may be applied to a camera or sensing device for LiDAR to recognize the surrounding environment of a moving object such as a vehicle in real time. In addition, the camera module according to the embodiment of the invention may be installed in multiple units in a vehicle to enhance safety regulations, autonomous driving functions, and increase convenience by using an Advanced driving assistance system (ADAS). In addition, the optical system of the camera module is applied in a vehicle as a component for control such as a lane keeping assistance system (LKAS), a lane departure warning system (LDWS), and a driver monitoring system (DMS). The optical system and camera module including the optical system disclosed in the embodiments of the invention can achieve stable optical performance even under ambient temperature changes and provide a cost-competitive module, thereby ensuring the reliability of vehicle components.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention. Although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1-16. (canceled)

17. An optical system comprising:
first to third lenses aligned along an optical axis from an object toward an image sensor and having powers; and
an aperture stop disposed between the first lens and the second lens,
wherein the power of the first lens is negative,
wherein the power of the second lens is positive,
wherein the first lens is a spherical lens made of glass material,
wherein the second and third lenses are aspherical lenses,
wherein the second lens includes a meniscus shape convex on the optical axis toward the image sensor,
wherein the third lens has a shape in which both sides are convex on the optical axis, and
wherein the first lens has a refractive index greater than 1.6 and less than 1.9.

18. The optical system of claim 17, wherein a maximum effective length of the third lens is greater than a maximum effective length of the second lens and less than a maximum effective length of the first lens.

19. The optical system of claim 17, wherein an effective diameter of an object-side surface of the third lens is larger than an effective diameter of an object-side surface of the second lens and smaller than an effective diameter of an object-side surface of the first lens.

20. The optical system of claim 17, wherein refractive indices of the second and third lenses are greater than 1.6 and smaller than 1.9.

21. The optical system of claim 17, wherein a distance from a sensor-side surface of the first lens to the aperture stop in the optical axis direction is larger than a distance from an object-side surface of the second lens to the aperture stop in the optical axis direction.

22. The optical system of claim 17, wherein an effective diameter of the aperture stop is smaller than an effective diameter of a sensor-side surface of the first lens and an effective diameter of an object-side surface of the second lens.

23. The optical system of claim 17, wherein a sensor-side surface of the third lens has a radius of curvature smaller than a radius of curvature of an object-side surface of the third lens.

24. The optical system of claim 17, wherein a center thickness of the third lens is greater than a center thickness of the second lens.

25. The optical system of claim 17, wherein an object-side surface of the first lens is convex on the optical axis, and
wherein an effective diameter of an object-side surface of the first lens is more than twice an effective diameter of a sensor-side surface of the first lens.

26. The optical system of claim 17, wherein a distance in the optical axis direction between a sensor-side surface of the first lens and an object-side surface of the second lens is greater than a distance in the optical axis direction between a sensor-side surface of the second lens and an object-side surface of the third lens.

27. The optical system of claim 17, wherein the second lens and the third lens are made of glass material,
wherein an optical axis distance from a center of an object-side surface of the first lens to a surface of the image sensor is TTL,
wherein an optical axis distance from a center of a sensor-side surface of the third lens to a surface of the image sensor is BFL, and
wherein the following Mathematical Formula satisfies: 3<TTL/BL<8.

28. The optical system of claim 17, wherein an optical axis distance from a center of an object-side surface of the first lens to a surface of the image sensor is TTL,
wherein ½ of a diagonal length of the image sensor is ImgH, and
wherein the following Mathematical Formula satisfies: 6<TTL/ImgH<9.

29. An optical system comprising:
first to fourth lenses aligned along an optical axis from an object toward an image sensor; and
an aperture stop disposed between the second lens and the third lens,
wherein a power of the first lens has a negative value,
wherein a first and fourth lenses are aspherical lenses,
wherein the third lens is a spherical lens,
wherein a distance between the first and second lenses is such that a center distance is greater than an edge distance, and
wherein the fourth lens includes a convex object-side surface and a convex sensor-side surface on the optical axis.

30. The optical system of claim 29, wherein the third lens includes a convex object-side surface and a convex sensor-side surface on the optical axis,
wherein the first lens includes a concave object-side surface and a concave sensor-side surface on the optical axis, and
wherein the object-side surface of the first lens has a critical point between a center and an edge.

31. The optical system of claim 29, wherein a power of each of the second to fourth lenses has a positive value, and
wherein a center thickness of the fourth lens is greater than a center thickness of each of the first to third lenses.

32. The optical system of claim 29, wherein the second and third lenses are made of glass material,
wherein the first and fourth lenses are made of plastic material, and
wherein the aperture stop is disposed closer to the second lens than to the third lens.

33. The optical system of claim 17, wherein a center thickness of the first lens is the thickest among center thicknesses of the first to third lenses.

34. The optical system of claim 33, wherein the center thickness of the first lens is greater than a center distance between the first lens and the second lens.

35. The optical system of claim 17, wherein an edge thickness of the first lens is the thickest among edge thicknesses of the first to third lenses.

36. The optical system of claim 17, wherein the third lens is a lens closest to the image sensor and has positive power.
